(19) United States
(12) Patent Application Publication
(10) Pub. No.: US 2026/0303545 A1
(43) Pub. Date: Oct. 1, 2026

(54) KERNEL-LEVEL AGENT COMPLIANCE ENFORCEMENT IN COMPUTING ENVIRONMENTS

(71) Applicant: Citibank, N.A., New York, NY (US)

(72) Inventors: James Randolph MYERS, Clearwater Beach, FL (US); Miriam SILVER, Tel Aviv (IL); Ganesh Prasad BHAT, West Orange, NJ (US)

(73) Assignee: Citibank, N.A., New York, NY (US)

(21) Appl. No.: 19/709,186

(22) Filed: Jun. 16, 2026

Related U.S. Application Data
(63) Continuation-in-part of application No. 19/540,252, filed on Feb. 13, 2026.
Application No. 19/540,252 is a continuation of application No. 19/334,739, filed on Sep. 19, 2025, now Pat. No. 12,556,493.
Application No. 19/334,739 is a continuation-in-part of application No. 19/288,027, filed on Aug. 1, 2025, now Pat. No. 12,526,244.
Application No. 19/288,027 is a continuation-in-part of application No. 19/217,943, filed on May 23, 2025, now Pat. No. 12,450,037.
Application No. 19/334,739 is a continuation-in-part of application No. 19/179,996, filed on Apr. 15, 2025, now Pat. No. 12,587,488.
Application No. 19/179,996 is a continuation of application No. 18/434,687, filed on Feb. 6, 2024, now Pat. No. 12,126,546.
Application No. 19/334,739 is a continuation-in-part of application No. 19/182,585, filed on Apr. 18, 2025.
Application No. 19/182,585 is a continuation of application No. 18/947,102, filed on Nov. 14, 2024, now Pat. No. 12,299,140.
Application No. 18/947,102 is a continuation-in-part of application No. 18/653,858, filed on May 2, 2024, now Pat. No. 12,198,030.
Application No. 18/653,858 is a continuation-in-part of application No. 18/637,362, filed on Apr. 16, 2024, now Pat. No. 12,111,754.
Application No. 18/947,102 is a continuation-in-part of application No. 18/782,019, filed on Jul. 23, 2024, now Pat. No. 12,197,859.
Application No. 18/782,019 is a continuation-in-part of application No. 18/771,876, filed on Jul. 12, 2024, now Pat. No. 12,204,323.
Application No. 18/771,876 is a continuation-in-part of application No. 18/661,532, filed on May 10, 2024, now Pat. No. 12,111,747.
Application No. 18/661,532 is a continuation-in-part of application No. 18/661,519, filed on May 10, 2024, now Pat. No. 12,106,205.
Application No. 18/661,519 is a continuation-in-part of application No. 18/633,293, filed on Apr. 11, 2024, now Pat. No. 12,147,513.
Application No. 18/947,102 is a continuation-in-part of application No. 18/739,111, filed on Jun. 10, 2024, now Pat. No. 12,223,063.
Application No. 18/739,111 is a continuation-in-part of application No. 18/607,141, filed on Mar. 15, 2024, now Pat. No. 12,608,486.
Application No. 18/607,141 is a continuation-in-part of application No. 18/399,422, filed on Dec. 28, 2023, now Pat. No. 12,367,292.
Application No. 18/399,422 is a continuation of application No. 18/327,040, filed on May 31, 2023, now Pat. No. 11,874,934.
Application No. 18/327,040 is a continuation-in-part of application No. 18/114,194, filed on Feb. 24, 2023, now Pat. No. 11,763,006.
Application No. 18/114,194 is a continuation-in-part of application No. 18/098,895, filed on Jan. 19, 2023, now Pat. No. 11,748,491.

(51) Int. Cl. H04L 47/70; H04L 67/1097

(52) U.S. Cl. CPC H04L 47/822; H04L 67/1097

(57) ABSTRACT

Systems and methods disclosed herein enforce agent compliance using kernel-level eBPF programs. The system obtains a machine-readable data structure defining operative boundaries for a target AI agent set and generates a reference value by applying a transformation operation on the data structure. The system loads eBPF programs and policy maps into a kernel, attaching them to hook points to intercept agent operations. Kernel-captured events are received via a kernel event stream, and an observer component generates a kernel-attested observed value by canonically serializing the events and applying a second transformation operation. A compliance comparator determines verification status by comparing the reference value with the observed value. When non-compliance is detected, the system loads an enforcement program into the kernel to restrict agent operations.

### CROSS-REFERENCE TO RELATED APPLICATION(S)

This application is a continuation-in-part of U.S. patent application Ser. No. 19/540,252 entitled “ENCRYPTED AUTONOMOUS AGENT VERIFICATION IN MULTI-TIERED DISTRIBUTED SYSTEMS OF THIRD PARTY AGENTS” filed on Feb. 13, 2026, which is a continuation of U.S. patent application Ser. No. 19/334,739 (now U.S. Pat. No. 12,556,493) entitled “ENCRYPTED AUTONOMOUS AGENT VERIFICATION IN MULTI-TIERED DISTRIBUTED SYSTEMS OF THIRD PARTY AGENTS” filed on Sep. 19, 2025, which is a continuation-in-part of U.S. patent application Ser. No. 19/288,027 entitled “ENCRYPTED AUTONOMOUS AGENT VERIFICATION IN MULTI-TIERED DISTRIBUTED SYSTEMS ACROSS GLOBAL OR CLOUD NETWORKS” filed on Aug. 1, 2025, which is a continuation-in-part of U.S. patent application Ser. No. 19/217,943 entitled “AUTOMATIC GENERATION AND EXECUTION OF COMPUTER-EXECUTABLE COMMANDS USING ARTIFICIAL INTELLIGENCE MODELS” filed on May 23, 2025.

U.S. patent application Ser. No. 19/334,739 (now U.S. Pat. No. 12,556,493) is further a continuation-in-part of U.S. patent application Ser. No. 19/179,996 entitled “SYSTEMS AND METHODS FOR DETERMINING RESOURCE AVAILABILITY ACROSS GLOBAL OR CLOUD NETWORKS” and filed Apr. 15, 2025, which is a continuation of U.S. patent application Ser. No. 18/434,687 (now U.S. Pat. No. 12,126,546 issued Oct. 22, 2024) entitled “SYSTEMS AND METHODS FOR DETERMINING RESOURCE AVAILABILITY ACROSS GLOBAL OR CLOUD NETWORKS” and filed Feb. 6, 2024. The content of the foregoing applications is incorporated herein by reference in their entirety.

U.S. patent application Ser. No. 19/334,739 (now U.S. Pat. No. 12,556,493) is further a continuation-in-part of U.S. patent application Ser. No. 19/182,585 entitled “DYNAMIC MULTI-MODEL MONITORING AND VALIDATION FOR ARTIFICIAL INTELLIGENCE MODELS” filed on Apr. 18, 2025, which is a continuation of U.S. patent application Ser. No. 18/947,102 (now U.S. Pat. No. 12,299,140) entitled “DYNAMIC MULTI-MODEL MONITORING AND VALIDATION FOR ARTIFICIAL INTELLIGENCE MODELS” filed on Nov. 14, 2024, which is a continuation-in-part of U.S. patent application Ser. No. 18/653,858 entitled “VALIDATING VECTOR CONSTRAINTS OF OUTPUTS GENERATED BY MACHINE LEARNING MODELS” filed on May 2, 2024, which is a continuation-in-part of U.S. patent application Ser. No. 18/637,362 entitled “DYNAMICALLY VALIDATING AI APPLICATIONS FOR COMPLIANCE” filed on Apr. 16, 2024. U.S. patent application Ser. No. 18/947,102 is further a continuation-in-part of U.S. patent application Ser. No. 18/782,019 entitled “IDENTIFYING AND ANALYZING ACTIONS FROM VECTOR REPRESENTATIONS OF ALPHANUMERIC CHARACTERS USING A LARGE LANGUAGE MODEL” and filed Jul. 23, 2024, which is a continuation-in-part of U.S. patent application Ser. No. 18/771,876 entitled “MAPPING IDENTIFIED GAPS IN CONTROLS TO OPERATIVE STANDARDS USING A GENERATIVE ARTIFICIAL INTELLIGENCE MODEL” and filed Jul. 12, 2024, which is a continuation-in-part of U.S. patent application Ser. No. 18/661,532 entitled “DYNAMIC INPUT-SENSITIVE VALIDATION OF MACHINE LEARNING MODEL OUTPUTS AND METHODS AND SYSTEMS OF THE SAME” and filed May 10, 2024, which is a continuation-in-part of U.S. patent application Ser. No. 18/661,519 entitled “DYNAMIC, RESOURCE-SENSITIVE MODEL SELECTION AND OUTPUT GENERATION AND METHODS AND SYSTEMS OF THE SAME” and filed May 10, 2024, and is a continuation-in-part of U.S. patent application Ser. No. 18/633,293 entitled “DYNAMIC EVALUATION OF LANGUAGE MODEL PROMPTS FOR MODEL SELECTION AND OUTPUT VALIDATION AND METHODS AND SYSTEMS OF THE SAME” and filed Apr. 11, 2024.

U.S. patent application Ser. No. 18/947,102 (now U.S. Pat. No. 12,299,140) entitled “DYNAMIC MULTI-MODEL MONITORING AND VALIDATION FOR ARTIFICIAL INTELLIGENCE MODELS” is further a continuation-in-part of U.S. patent application Ser. No. 18/739,111 entitled “END-TO-END MEASUREMENT, GRADING AND EVALUATION OF PRETRAINED ARTIFICIAL INTELLIGENCE MODELS VIA A GRAPHICAL USER INTERFACE (GUI) SYSTEMS AND METHODS” and filed Jun. 10, 2024, which is a continuation-in-part of U.S. patent application Ser. No. 18/607,141 entitled “GENERATING PREDICTED END-TO-END CYBER-SECURITY ATTACK CHARACTERISTICS VIA BIFURCATED MACHINE LEARNING-BASED PROCESSING OF MULTI-MODAL DATA SYSTEMS AND METHODS” filed on Mar. 15, 2024, which is a continuation-in-part of U.S. patent application Ser. No. 18/399,422 entitled “PROVIDING USER-INDUCED VARIABLE IDENTIFICATION OF END-TO-END COMPUTING SYSTEM SECURITY IMPACT INFORMATION SYSTEMS AND METHODS” filed on Dec. 28, 2023, which is a continuation of U.S. patent application Ser. No. 18/327,040 (now U.S. Pat. No. 11,874,934) entitled “PROVIDING USER-INDUCED VARIABLE IDENTIFICATION OF END-TO-END COMPUTING SYSTEM SECURITY IMPACT INFORMATION SYSTEMS AND METHODS” filed on May 31, 2023, which is a continuation-in-part of U.S. patent application Ser. No. 18/114,194 (now U.S. Pat. No. 11,763,006) entitled “COMPARATIVE REAL-TIME END-TO-END SECURITY VULNERABILITIES DETERMINATION AND VISUALIZATION” filed Feb. 24, 2023, which is a continuation-in-part of U.S. patent application Ser. No. 18/098,895 (now U.S. Pat. No. 11,748,491) entitled “DETERMINING PLATFORM-SPECIFIC END-TO-END SECURITY VULNERABILITIES FOR A SOFTWARE APPLICATION VIA GRAPHICAL USER INTERFACE (GUI) SYSTEMS AND METHODS” filed Jan. 19, 2023. The content of the foregoing applications is incorporated herein by reference in their entirety.

### BACKGROUND

Autonomous agents are software entities designed to operate independently and make decisions without direct human intervention. These agents are programmed to perceive their environment, reason about their observations, and take actions to achieve specific goals. They can adapt to changing circumstances and learn from experience, making them useful in various domains such as robotics, artificial intelligence, and distributed computing systems. An agent's behavior is typically governed by an objective function that directs the agent to optimize for particular outcomes, such as maximizing task accuracy, minimizing resource usage, or complying with specified operational constraints. The degree of autonomy can range from semiautonomous, where human intervention is occasionally used, to fully autonomous, where the agent operates independently within defined parameters.

### SUMMARY

As autonomous agents become increasingly prevalent in distributed computing environments, organizations face challenges in verifying that these agents operate within defined boundaries. Conventional compliance verification systems rely on agent self-reporting, where the target agent generates telemetry data, logs, or verification artifacts from its own internal datasets. This approach presents a technical vulnerability: user-space telemetry can be bypassed or spoofed by the same software stack being audited. A compromised, adversarial, or malfunctioning agent can manipulate its internal dataset before applying transformation operations, producing an observed value that falsely satisfies operative boundaries. Even when zero-knowledge proofs are employed, the proof demonstrates that the agent's submitted data satisfies the boundaries but does not verify that the submitted data accurately reflects the agent's actual behavior.

Conventional user-space instrumentation, including application logging, API monitoring, and middleware interception, is similarly vulnerable because it operates at the same privilege level as the agent and can be bypassed or manipulated by sophisticated agents. This creates an integrity gap where compliance verification compares operative boundaries against data that the target agent itself controls and can fabricate. The result is that verification systems cannot distinguish between genuine compliance and falsified compliance artifacts. There is a technical need for a mechanism that independently captures the target agent's actual operational behavior at a processing level below the agent's user-space execution and produces an observed value based on this independently captured data. Such a mechanism would ensure that compliance verification compares operative boundaries against ground-truth behavioral evidence that the target agent cannot fabricate or suppress.

The present disclosure addresses these technical challenges by implementing a kernel instrumentation layer including one or more eBPF programs and one or more policy maps loaded into a kernel of a computing environment executing the target AI agent set, wherein the one or more eBPF programs are attached to kernel hook points to intercept operations performed by the target AI agent set. By capturing agent behavior at the kernel level rather than relying on user-space telemetry, the disclosed system produces observed values based on ground-truth behavioral evidence that the target agent cannot fabricate or suppress. The kernel-level approach operates at a privilege level below the agent's execution context, ensuring that even a compromised or adversarial agent cannot manipulate the compliance data used for verification. The system obtains a machine-readable data structure that defines one or more operative boundaries for a target AI agent set and generates a reference value representing the machine-readable data structure by applying a first transformation operation set on the machine-readable data structure.

The system then receives, via a kernel event stream from the one or more eBPF programs, kernel-captured events representing operations performed by the target AI agent set, and generates, via an observer component, a kernel-attested observed value by canonically serializing the kernel-captured events and applying a second transformation operation set on the kernel-captured events. This kernel-attested observed value represents the agent's actual behavior as witnessed by the operating system kernel, rather than self-reported telemetry that the agent could manipulate. The system determines, via a compliance comparator, a verification status by comparing the reference value with the kernel-attested observed value, wherein the verification status is indicative of compliance of the target AI agent set with the one or more operative boundaries. This architecture closes the integrity gap present in conventional systems by comparing operative boundaries against independently captured behavioral evidence rather than agent-controlled data. Furthermore, responsive to the verification status indicating non-compliance of the target AI agent set with the one or more operative boundaries, the system loads an enforcement program into the kernel of the computing environment to restrict operations of the target AI agent set, ensuring that detected violations result in immediate, kernel-level restrictions that the agent cannot bypass or circumvent.

In particular, the disclosed system obtains a machine-readable data structure that defines one or more operative boundaries for a target AI agent set. These operative boundaries can specify, for example, which files the agent is permitted to access, which network endpoints the agent can communicate with, what data classifications the agent can process, or what resource consumption thresholds the agent must observe. The machine-readable data structure provides a formal specification of compliant behavior against which the agent's actual operations can be measured.

The system generates a reference value representing the machine-readable data structure by applying a first transformation operation set on the machine-readable data structure. For instance, the transformation operation set can include a cryptographic hash function that produces a fixed-length, non-invertible digital summary of the operative boundaries. This reference value serves as a compact, tamper-evident representation of the expected compliant behavior that can be efficiently compared against observed behavior.

The system loads one or more eBPF programs and one or more policy maps into a kernel of a computing environment executing the target AI agent set. The eBPF programs are attached to kernel hook points to intercept operations performed by the target AI agent set. These hook points can include Linux Security Module hooks for file operations such as file open and read requests, tracepoints for process activities such as process creation and termination, or XDP and TC hooks for network operations such as packet transmission and reception. By attaching to these kernel hook points, the eBPF programs capture the agent's actual system-level behavior at a privilege level that the agent cannot circumvent or manipulate. The policy maps store allow lists, deny rules, and thresholds that define the enforcement parameters for the monitored agent.

The system receives, via a kernel event stream from the one or more eBPF programs, kernel-captured events representing operations performed by the target AI agent set. These kernel-captured events constitute ground-truth behavioral evidence because they are generated by the kernel itself when the agent performs system calls, network operations, or file accesses. Unlike user-space telemetry that the agent could intercept and modify, these kernel-captured events reflect the agent's actual behavior as observed by the operating system.

The system generates, via an observer component, a kernel-attested observed value by canonically serializing the kernel-captured events and applying a second transformation operation set on the kernel-captured events. The canonical serialization ensures that the events are processed in a deterministic order and format, enabling consistent comparison across verification cycles. The second transformation operation set can similarly include a cryptographic hash function that produces a compact representation of the observed behavior. The resulting kernel-attested observed value represents what the agent actually did, as witnessed by the kernel, rather than what the agent claims to have done.

The system determines, via a compliance comparator, a verification status by comparing the reference value with the kernel-attested observed value. The verification status is indicative of compliance of the target AI agent set with the one or more operative boundaries. This comparison directly addresses the integrity gap in conventional systems because the observed value is derived from kernel-level evidence that the agent cannot fabricate. When the reference value and observed value satisfy the defined relationship, the system can confirm that the agent's actual behavior conforms to the specified operative boundaries.

Responsive to the verification status indicating non-compliance of the target AI agent set with the one or more operative boundaries, the system loads an enforcement program into the kernel of the computing environment to restrict operations of the target AI agent set. This enforcement capability ensures that detected violations result in immediate, kernel-level restrictions that the agent cannot bypass. For example, the enforcement program can block file access attempts via LSM hooks, drop network packets via XDP or TC hooks, or impose rate limits on resource consumption. Because enforcement occurs at the kernel level, the target agent cannot evade or circumvent the restrictions regardless of how sophisticated or adversarial its user-space code can be.

Various other aspects, features, and advantages of the invention will be apparent through the detailed description of the invention and the drawings attached hereto. It is also to be understood that both the foregoing general description and the following detailed description are examples and are not restrictive of the scope of the invention. As used in the specification and in the claims, the singular forms of “a,” “an,” and “the” include plural referents unless the context clearly dictates otherwise. In addition, as used in the specification and the claims, the term “or” means “and/or” unless the context clearly dictates otherwise. Additionally, as used in the specification, “a portion” refers to a part of, or the entirety of (i.e., the entire portion), a given item (e.g., data) unless the context clearly dictates otherwise.

### BRIEF DESCRIPTION OF THE DRAWINGS

FIG. 1 illustrates a block diagram of a system for kernel-attested compliance verification of autonomous AI agents, in accordance with some implementations of the present technology.

FIG. 2 illustrates a flowchart for a method for kernel-level compliance monitoring and enforcement of an agent, in accordance with some implementations of the present technology.

FIG. 3 illustrates a flowchart depicting kernel-level policy evaluation and enforcement for agent actions, in accordance with some implementations of the present technology.

FIG. 4 illustrates a flowchart depicting a kernel-attested observed value pipeline for compliance verification, in accordance with some implementations of the present technology.

FIG. 5 illustrates an example environment of an agent management platform for verifying autonomous agents in multi-tiered distributed systems while maintaining operational data privacy of respective autonomous agents, in accordance with some implementations of the present technology.

FIG. 6 illustrates an example environment of an agent management platform for verifying autonomous agents in multi-tiered distributed systems that include a sub-agent associated with a provider agent, in accordance with some implementations of the present technology.

FIG. 7 illustrates an example environment of an agent management platform for verifying autonomous agents in multi-tiered distributed systems that include multiple provider agents and sub-agents, in accordance with some implementations of the present technology.

FIG. 8 illustrates an example environment of a smart contract layer within an agent management platform for verifying autonomous agents in multi-tiered distributed systems, in accordance with some implementations of the present technology.

FIG. 9 illustrates an example environment of a reputation engine within an agent management platform for verifying autonomous agents in multi-tiered distributed systems, in accordance with some implementations of the present technology.

FIG. 10 illustrates an example environment of an agent interface within an agent management platform for enabling communication between autonomous agents in multi-tiered distributed systems, in accordance with some implementations of the present technology.

FIG. 11 illustrates an example environment of a governance engine within an agent management platform defining operative boundaries of autonomous agents in multi-tiered distributed systems, in accordance with some implementations of the present technology.

FIG. 12 is a flow diagram illustrating an example process of verifying autonomous agents in multi-tiered distributed systems using an agent management platform according to some implementations of the present technology.

FIG. 13 illustrates an example environment of an agent management platform for automatically generating and executing computer programs using artificial intelligence (AI) models in accordance with some implementations of the present technology.

FIG. 14A is a screenshot of a user interface illustrating uploading unstructured data to an agent management platform in accordance with some implementations of the present technology.

FIG. 14B is a screenshot of the user interface displaying confidence scores of features extracted from the unstructured data that is generated using an agent management platform according to some implementations of the present technology.

FIG. 14C is a screenshot of the user interface displaying the extracted features according to some implementations of the present technology.

FIG. 14D is a screenshot of a first artifact generated by the agent management platform using complete unstructured data according to some implementations of the present technology.

FIG. 14E is a screenshot of a second artifact generated by the agent management platform using incomplete unstructured data according to some implementations of the present technology.

FIG. 15 is a screenshot displaying the artifact generated by the agent management platform on a user interface according to some implementations of the present technology.

FIG. 16 is a flow diagram illustrating an example process of generating and executing computer programs using an agent management platform according to some implementations of the present technology.

FIG. 17 illustrates an example environment of blockchain-based decision making for AI agent(s) using the agent management platform in accordance with some implementations of the present technology.

FIG. 18 illustrates an example environment of an interface of an AI agent used within an agent management platform in accordance with some implementations of the present technology.

FIGS. 19A-19C show an illustrative diagram for managing resources, in accordance with one or more implementations.

FIG. 20 shows an illustrative diagram of an implementation featuring a blockchain network, in accordance with one or more implementations.

FIG. 21 shows an illustrative diagram for performing a blockchain action, in accordance with one or more implementations.

FIG. 22 shows a flowchart of the operations involved in determining availability of resources across global or cloud computer networks, in accordance with one or more implementations.

FIG. 23 illustrates a layered architecture of an AI system that can implement the machine learning models of an agent management platform, in accordance with some implementations of the present technology.

FIG. 24 is a block diagram showing some of the components typically incorporated in at least some of the computer systems and other devices on which the agent management platform operates in accordance with some implementations of the present technology.

FIG. 25 is a system diagram illustrating an example of a computing environment in which the agent management platform operates in some implementations of the present technology.

FIG. 26 shows a flowchart of the operations involved in verification of agents (e.g., third party agents), in accordance with one or more implementations.

The technologies described herein will become more apparent to those skilled in the art from studying the Detailed Description in conjunction with the drawings. Embodiments or implementations describing aspects of the invention are illustrated by way of example, and the same references can indicate similar elements. While the drawings depict various implementations for the purpose of illustration, those skilled in the art will recognize that alternative implementations can be employed without departing from the principles of the present technologies. Accordingly, while specific implementations are shown in the drawings, the technology is amenable to various modifications.

### DETAILED DESCRIPTION

The disclosed technology provides a system and method for enforcing agent compliance in computing environments using kernel-level eBPF programs. In particular, systems and methods described herein involve implementing a kernel instrumentation layer that captures agent behavior at a privilege level below the agent's user-space execution, generating kernel-attested observed values based on ground-truth behavioral evidence, comparing these observed values against reference values representing operative boundaries, and executing enforcement actions when non-compliance is detected. Specifically, the present disclosure is directed to loading eBPF programs and policy maps into a kernel, attaching the programs to kernel hook points to intercept agent operations, receiving kernel-captured events via a kernel event stream, canonically serializing the events to generate observed values, and loading enforcement programs to restrict agent operations when violations are detected. The system addresses the integrity gap present in conventional compliance verification systems by ensuring that compliance data cannot be fabricated or suppressed by the target agent.

Existing kernel-level security frameworks that use programmable hook-based instrumentation (e.g., CILIUM, FALCO, TETRAGON) typically enforce static per-container or per-workload policies based on predefined rule sets. These frameworks typically monitor kernel events such as system calls, network connections, and/or file access operations, and apply restrictions at the container level according to rules that are defined at deployment time and remain fixed unless manually updated by a user (e.g., an administrator). Because the policies are static, these frameworks do not adapt enforcement in response to changes in agent behavior or operational state without manual intervention. In contrast, the disclosed system dynamically generates kernel-attested observed values by canonically serializing kernel-captured events and comparing these observed values against reference values representing operative boundaries for a target AI agent set.

The kernel-based management platform can apply controls at interfaces that are neither purely application-level nor purely kernel-internal. For example, the platform can intercept a controller API call before the call causes kernel activity. In some implementations, the system disclosed herein can include a cross-layer management platform that deploys monitoring and enforcement controls described herein at one or more intermediate processing levels positioned between the operating system kernel and an application layer associated with an AI agent or other monitored application. The intermediate processing levels can include an operating-system service level, a controller or orchestrator level, a compiler or build level, a device driver or hardware-interface level, and so forth. Monitoring layers or monitoring levels can include one or more processing levels of a computing environment at which monitoring programs are deployed to intercept operations, e.g., such as those performed by a target AI agent set. A monitoring layer can include the operating system kernel, an operating-system service level, a controller or orchestrator level, a compiler or build level, a device driver or hardware-interface level, or any combination thereof. In some implementations, the cross-layer management platform correlates events captured at the intermediate processing levels with kernel-level event records using identifiers such as a common process identifier, thread identifier, cgroup identifier, namespace identifier, container identifier, binary measurement, agent identifier, attestation identifier, and the like. The correlation enables the cross-layer management platform to detect cross-layer patterns that are not observable from any single layer in isolation. For example, if the cross-layer management platform detects that an AI agent opened a network connection to an unapproved endpoint (observed at the kernel level via an XDP or TC hook) and accessed a file outside its permitted scope (observed at the operating-system service level via an LSM hook) within a rolling time window, the cross-layer management platform can trigger an enforcement action based on the combination of these cross-layer events even though neither event in isolation would exceed a policy threshold. The cross-layer management platform can then load an enforcement program into the kernel to restrict operations of the target AI agent set.

In some implementations, the cross-layer management platform described throughout the description herein operates using an AI-assisted code generation architecture to perform both automated code generation and constraint enforcement. The AI-assisted code generation architecture can maintain code generation components that produce eBPF program code (e.g., using trained neural network models) and/or verification components that validate the generated code against kernel safety constraints (e.g., using the kernel-resident eBPF verifier). The code generation component includes, for example, an LLM trained on code corpora that receives policy specifications as input and generates eBPF program code configured to attach to kernel hook points such as LSM hooks, tracepoints, and XDP/TC hooks. The verification component can evaluate the generated code against the constraints. In some implementations, the AI code generation model outputs operate as inputs to the kernel verification system, and the kernel verification system is enabled to execute one or more evaluations against the constraints to verify that generated eBPF program code complies with the kernel's verifier requirements before loading into the kernel for monitoring and enforcement of the target AI agent set.

One or more of the monitoring programs can be generated by an AI code generation model (e.g., InCoder-32B or similar models). The AI code generation model, for example, receives a policy specification as input and produces, as output, source code for the monitoring programs that is structured to attach to the kernel hook points and capture the kernel-captured events described above. To generate the source code, the AI code generation model can translate high-level policy intent (e.g., “deny network egress for unregistered agents” or “capture all file write operations by agents in a specified cgroup”) into code that implements the policy as concrete hook-level logic. In some implementations, the code-generation model generates one or more intermediate-level instrumentation components that operate at processing levels between the kernel and the application layer.

In some implementations, the code-generation model processes a long-context input such as a policy repository, a multi-file build context, a controller-policy corpus, and/or a cross-layer monitoring specification in a single inference session. For example, the code-generation model can ingest a policy repository that defines enforcement rules for multiple AI agents across multiple hook points and multiple intermediate processing levels, and generate a coordinated set of monitoring programs where each program attaches to a different hook point and shares state through common reference data files (e.g., BPF maps), such that the generated programs collectively enforce the policy repository without requiring a user to manually partition the policy logic across individual programs. The code-generation model can read the policy repository as a single input sequence to identify dependencies between policy rules and generate source code for each hook point that references shared keys (e.g., BPF map keys) consistent with the other generated programs.

In some implementations, the code-generation model generates source code in multiple programming languages and low-level code representations to produce cross-layer instrumentation and enforcement logic. For example, the code-generation model generates eBPF source code that executes within the Linux kernel, generates C or C++ source code for user-space handlers, and so forth. Each generated artifact can be associated with a different processing level (kernel, user space, compiler, controller) but shares a common policy vocabulary and common schema, such that an event captured by a monitoring program at a kernel hook point can be correlated with an event captured by a compiler plugin at the build level using the same agent identifier.

The code-generation model can generate monitoring programs that maintain per-agent system call counters in per-CPU maps within the reference data files (e.g., BPF maps), where each CPU core increments its own local counter without acquiring a lock, and a periodic timer hook aggregates the per-CPU values into a single total that is exported to user space via a ring buffer when the aggregated total exceeds a reporting threshold. This approach reduces the volume of individual events transmitted from kernel space to user space because the monitoring program exports one aggregated record per reporting interval rather than one record per system call. The code-generation model can generate monitoring programs that correlate events across multiple hook points within a rolling time window stored in a reference data file (e.g., BPF map), such that the program detects cross-layer patterns and triggers an enforcement action when both events occur within the window.

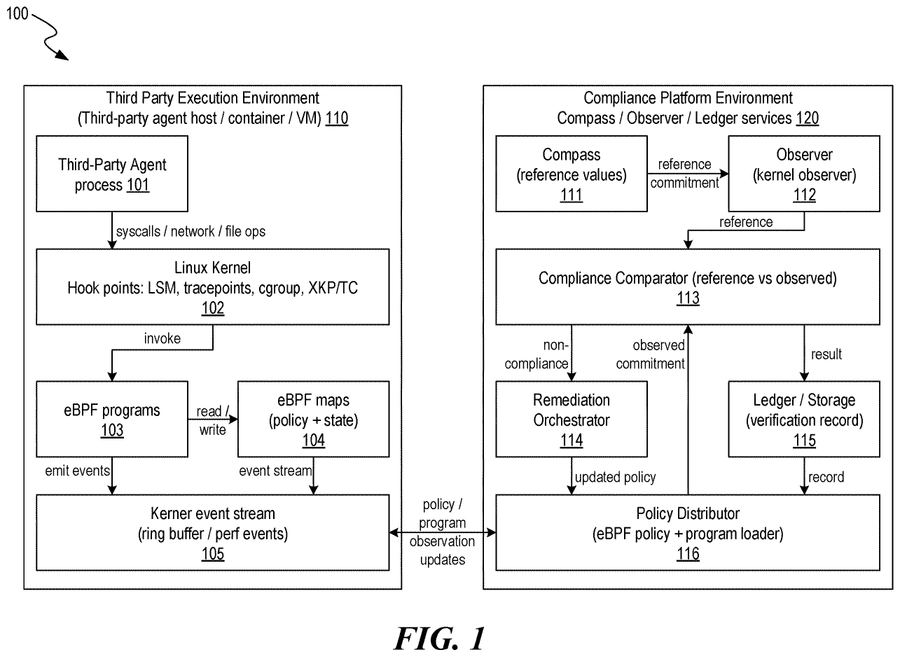

FIG. 1 illustrates a block diagram of a system 100 for kernel-attested compliance verification of autonomous AI agents, in accordance with some implementations of the present technology. The system 100 includes two primary environments: a third party execution environment 110 and a compliance platform environment 120. The third party execution environment 110 represents a third-party agent host, container, or virtual machine where monitored agent processes execute. Within this environment, a third-party agent process 101 can perform syscalls, network operations, and file operations. These operations are intercepted by a Linux kernel 102, which includes hook points such as LSM, tracepoints, cgroup, and XDP/TC. The Linux kernel 102 invokes eBPF programs 103, which are monitoring programs attached to the kernel hook points. The eBPF programs 103 read from and write to eBPF maps 104, which store policy and state information including per-agent behavioral counters and access summaries. The eBPF programs 103 emit events to a kernel event stream 105, which includes a ring buffer and perf events for streaming kernel-captured data to user space.

The compliance platform environment 120 includes compass, observer, and ledger services that perform compliance verification. A compass 111 stores reference values representing operative boundaries for the monitored agents. The compass 111 provides reference commitment data to an observer 112, which functions as a kernel observer that receives observation updates from the kernel event stream 105 in the third party execution environment 110. The observer 112 collects kernel-captured events, canonically serializes them, and produces kernel-attested observed values. A compliance comparator 113 receives reference data from the observer 112 and performs comparison operations between the reference values and the observed values to determine verification status. When the compliance comparator 113 detects non-compliance, it signals a remediation orchestrator 114, which generates enforcement actions. The remediation orchestrator 114 provides updated policy information to a policy distributor 116, which functions as an eBPF policy and program loader. The policy distributor 116 transmits policy and program observation updates back to the eBPF maps 104 and eBPF programs 103 in the third party execution environment 110, enabling dynamic enforcement without requiring agent cooperation. The compliance comparator 113 also outputs observed commitment results to a ledger storage 115, which maintains verification records on a distributed ledger for audit purposes.

The cross-layer management platform can deploy monitoring and enforcement controls at one or more intermediate processing levels positioned between the operating system kernel and an application layer associated with an AI agent or other monitored application. At an operating-system service level, one or more monitoring programs (e.g., eBPF programs 103) can attach to cgroup-related hook points to enforce per-agent resource quotas including CPU quotas, memory ceilings, and/or input/output bandwidth limits. The cgroup hook points can fire when the AI agent's process or container requests resource allocations that are governed by the cgroup to which the agent is assigned. The monitoring programs can compare the requested allocation against per-agent limits stored in a hash map or other data file (e.g., eBPF maps 104). When a requested allocation exceeds the per-agent limit, the monitoring program can deny the allocation by returning an error code before the Linux kernel 102 processes the request.

In some implementations, one or more monitoring programs monitor inter-process communication (IPC) channels such as pipes, shared-memory regions, message queues, and/or Unix-domain sockets used by the AI agent to communicate with one or more peer processes. The IPC monitoring programs can attach to kernel functions that mediate data transfer between processes and capture the process identifiers of the sending and receiving processes, the size of the data transferred, and the type of IPC channel used. In some implementations, namespace transitions and container-runtime operations are monitored by attaching monitoring programs to hook points associated with namespace operations. These hook points can fire when a process attempts to change its namespace membership or create a new namespace. The monitoring programs can evaluate the attempted transition against a policy stored in a data file (e.g., eBPF maps 104) to detect and prevent unauthorized namespace escape, unauthorized container reconfiguration, and/or unauthorized process migration.

At the controller or orchestrator level, one or more monitoring programs can attach to network hook points to intercept, inspect, and validate messages exchanged between an AI agent and an orchestration controller. The orchestration controller can include a cluster-management server (e.g., a Kubernetes API server), a scheduler, a service-mesh controller, and so forth. When the AI agent transmits a message to the orchestration controller (e.g., a request to modify a deployment), the monitoring program attached to the network hook point inspects the message payload and compares the requested operation against a set of permitted operations stored in a policy map within a data file (e.g., eBPF maps 104). Policy enforcement can prevent the AI agent from requesting unauthorized resources by dropping the message at the network hook point before it reaches the orchestration controller. In some implementations, controller-to-agent communications are monitored in the reverse direction to detect unauthorized instruction injection or other operations that fail signature validation.

At the compiler or build level, one or more monitoring programs can monitor execution of compiler, linker, and/or build-tool processes associated with generation of an AI-agent binary, plugin, and/or policy artifact. The monitoring programs attach to hook points (e.g., trace point, LSM) that fire when the compiler or build-tool process performs system calls such as process creation (fork, exec), file reads and writes, environment-variable access, outbound network access, and so forth. The cross-layer management platform evaluates these events against a build-process policy stored in a data file (e.g., eBPF maps 104) to detect anomalous build behavior such as a compiler process making unexpected outbound network connections (which can indicate a supply-chain compromise). In some implementations, the cross-layer management platform intercepts execution events for a newly compiled binary and verifies a binary measurement or signature before permitting execution. The binary measurement refers to a cryptographic hash of the compiled binary's content, and the cross-layer management platform compares the binary measurement against an allowlist of approved measurements stored in a hash map of a data file (e.g., eBPF maps 104), as described with reference to the observer 112 in FIG. 1. If the binary measurement does not match any entry in the allowlist, the monitoring program denies the execution call by returning an error code.

At the device driver or hardware-interface level, one or more monitoring programs can monitor device I/O operations associated with an AI agent. The monitoring programs attach to hook points (e.g., tracepoint or kprobe) within the kernel's device driver subsystem that fire when the AI agent's process issues I/O operations to a device file or device driver interface. The monitored device interfaces can include GPUs, accelerator devices, robotics interfaces, sensors, storage controllers, network interfaces, and so forth. The cross-layer management platform evaluates each device I/O operation against a device-access policy stored in a data file (e.g., eBPF maps 104) that specifies which device files, command codes, and/or memory mapping ranges are permitted for each agent. Thus, the cross-layer management platform can prevent unauthorized hardware commands (e.g., an agent issuing GPU commands outside its allocated compute partition), unauthorized memory transfers (e.g., an agent mapping device memory regions that belong to another agent's workload), unauthorized data exfiltration (e.g., an agent writing sensitive data to a removable storage device), and other unauthorized operations.

In some implementations, the system obtains a machine-readable data structure that defines one or more operative boundaries for a target AI agent set. A machine-readable data structure can include any structured representation of compliance requirements, constraints, or policies that can be processed by computing systems. For example, the machine-readable data structure can specify which files the agent is permitted to access, which network endpoints the agent can communicate with, what data classifications the agent can process, or what resource consumption thresholds the agent must observe. The operative boundaries can represent organizational guidelines, industry standards, regulatory requirements, or provider criteria. In some implementations, the machine-readable data structure can be encoded in formats such as JSON, XML, YAML, or protocol buffers. The operative boundaries can include permissible value ranges for model parameters, specifications for allowable data signals used in agent operations, or constraints on completed computational operations such as result set cardinality or data type conformance.

The system generates a reference value representing the machine-readable data structure by applying a first transformation operation set on the machine-readable data structure. In some implementations, the system generates the reference value by applying the first transformation operation set to produce a compact, tamper-evident representation of the expected compliant behavior. The reference value can serve as a baseline against which observed agent behavior is measured. For example, the system can serialize the input structure into a canonical byte sequence that captures its hierarchical arrangement and data content in a format agnostic to particular differences such as field order or whitespace. The system can then process the resulting byte sequence through a deterministic transformation operation to map the entire data structure into a compact, uniquely identifying fixed-length output. Thus, the system can generate the same output for any two semantically equivalent inputs while yielding distinctly different results for even minor changes within the original data.

In particular, the first transformation operation set can include a cryptographic hash function that generates the reference value as a fixed-length, non-invertible digital summary of the machine-readable data structure. A cryptographic hash function is a mathematical algorithm that transforms input data of arbitrary size into a fixed-size output, where the transformation is deterministic, computationally efficient, and practically irreversible. For example, the cryptographic hash function can be SHA-256, SHA-3, BLAKE2, or other secure hash algorithms that produce collision-resistant outputs. The fixed-length property ensures that the reference value has a consistent size regardless of the complexity of the underlying operative boundaries. The non-invertible property ensures that the original machine-readable data structure cannot be reconstructed from the reference value, providing security against reverse engineering of compliance requirements. In some implementations, the transformation operation set can include keyed hash functions such as HMAC or deterministic encoding functions that incorporate additional security parameters.

The system loads one or more eBPF programs and one or more policy maps into a kernel of a computing environment executing the target AI agent set. In some implementations, the one or more eBPF programs are attached to kernel hook points to intercept operations performed by the target AI agent set. eBPF programs are small, verified programs that run in the kernel context and can be attached to various kernel subsystems to observe and potentially modify system behavior. The eBPF programs can be compiled from languages such as C and verified by the kernel's eBPF verifier to ensure safety properties including bounded execution time and memory safety. The policy maps can include eBPF maps, which are key-value data structures that store policy information such as allow lists, deny rules, and thresholds. For example, the policy maps can store per-agent behavioral counters, access summaries, and enforcement parameters. Returning to FIG. 1, the eBPF programs 103 are loaded into the Linux kernel 102 and read from and write to the eBPF maps 104 to implement policy-based monitoring and enforcement.

In some implementations, before the one or more eBPF programs are loaded into the kernel, each eBPF program is submitted to a kernel-resident verifier that performs static analysis to confirm safety properties. The verifier evaluates each program to confirm bounded execution time, wherein the program terminates within a finite number of instructions, bounded memory access, wherein the program accesses only permitted memory regions, type safety, wherein the program uses correct data types for helper function arguments and map operations, and absence of unreachable code. Only programs that pass the verifier are loaded into the kernel and attached to hook points. Programs that fail verification are rejected before loading, preventing unsafe or malformed monitoring code from executing in kernel space. The verifier acceptance step can ensure that the monitoring programs themselves cannot compromise kernel stability or security, which is a prerequisite for the kernel-attested observed values to be trustworthy. In some implementations, the eBPF program loading requires elevated privileges, such as CAP_BPF or CAP_SYS_ADMIN capabilities, and the loading is performed by a privileged platform daemon rather than by the target AI agent set. Referring to FIG. 1, the eBPF programs 103 are submitted to the kernel-resident verifier within the Linux kernel 102 prior to attachment to hook points.

In particular, the kernel hook points can include one or more of Linux Security Module hooks for file operations, tracepoints for process activities, or XDP and TC hooks for network operations. Linux Security Module (LSM) hooks are callback functions invoked by the kernel at security-relevant decision points, such as file_open, file_read, and file_permission operations. These hooks enable the eBPF programs to intercept and evaluate file access attempts before they are permitted to proceed. Tracepoints are stable instrumentation points in the kernel that provide visibility into process activities such as process creation (sched_process_fork), process termination (sched_process_exit), and context switches. XDP (eXpress Data Path) hooks operate at the network driver level and can process packets before they enter the kernel networking stack, enabling high-performance packet filtering and modification. TC (Traffic Control) hooks operate at the traffic control layer and can filter packets on both ingress and egress paths. By attaching to these kernel hook points, the eBPF programs capture the agent's actual system-level behavior at a privilege level that the agent cannot circumvent or manipulate.

In some implementations, the system generates a kernel-level identity for each monitored AI agent in the target AI agent set. A kernel-level identity refers to a set of one or more identifiers that the operating system kernel assigns to or associates with a process at creation time, and that the kernel-resident eBPF programs 103, as shown in FIG. 1, use to attribute intercepted events to a specific AI agent. The kernel-level identity can include a process identifier, a thread identifier, a control group identifier, a namespace identifier, a container identifier, a binary measurement (e.g., a cryptographic hash of the agent's executable image), an agent registry identifier, and/or an attestation identifier.

In some implementations, the kernel-level identity can be assembled from process control block fields read by an eBPF program at a hook point associated with process or control group assignment, where the eBPF program extracts the relevant identifiers at the moment the agent process is created or assigned to a resource group. Referring to FIG. 1, the identity is passed from a user-space controller to the Linux kernel 102 via an eBPF map write, such that the user-space controller writes the agent identifier and associated metadata into the eBPF maps 104 keyed by process identifier, and the eBPF programs 103 read the entry on subsequent hook invocations to associate intercepted events with the agent. In some implementations, the identity is derived from process attribute introspection at agent spawn, where the user-space controller reads process attributes and writes the assembled identity into the eBPF maps 104 before the agent begins executing operations.

The system can select among different network hook types based on the enforcement use case. Hook types that operate at the network interface driver layer before socket buffer allocation can, for example, be used for high-throughput inbound traffic filtering because packets can be dropped or redirected before the kernel allocates memory structures for packet processing. Hook types that operate after socket buffer allocation can be used to perform inbound and/or egress filtering with access to full packet metadata and socket context. In some implementations, the system attaches eBPF programs 103 at the XDP layer for inbound traffic filtering and at the TC layer for egress enforcement. The system can select eBPF map types based on the access pattern and data structure requirements of each enforcement use case. For example, array-type eBPF maps can be used to provide constant-time indexed access.

In some implementations, the use of XDP hooks for inbound traffic filtering can provide performance advantages over user-space filtering approaches because XDP processes packets at the network driver level before the kernel allocates socket buffer (skb) structures, before the packet traverses the kernel networking stack, and before any user-space context switch occurs. This means that prohibited packets (e.g., packets destined for or originating from unauthorized endpoints) can be dropped or redirected with potentially fewer CPU cycles and fewer memory allocations than would be required if the same filtering were performed by a user-space monitoring process that receives packets via a socket, evaluates them against a policy, and then issues a system call to drop or forward the packet. The earlier packet rejection can reduce the number of user-space context switches required for enforcement because the kernel does not need to copy packet data to user space, wake a user-space process, and then process the enforcement decision back through a system call. For egress enforcement, TC hooks operate after socket buffer allocation but before the packet leaves the host, enabling the system to inspect full packet metadata including socket context and apply egress filtering without requiring a separate user-space proxy. Referring to FIG. 1, the eBPF programs 103 can be attached to XDP and TC hooks within the Linux kernel 102 to implement this kernel-level packet filtering for the target AI agent set.

When transitioning an agent from one policy set to another (e.g., in response to a detected non-compliance or a change in agent operational state), the policy distributor 116 can perform one or more updates to maintain atomicity. For example, the policy distributor 116 can write the new policy rules (e.g., updated network rules, resource limits, or access control entries) into the target policy maps. The policy distributor 116 can update the agent-to-policy mapping entry using an atomic update operation that replaces the agent's current policy reference with the new policy reference. To prevent intermediate states in which the agent is mapped to a new policy before the policy rules are fully loaded, the system can use a version counter stored alongside the policy entries in the eBPF maps 104, such that the eBPF programs 103 check that the version counter in the agent-to-policy mapping matches the version counter in the policy rule entries before applying enforcement action(s).

The enforcement actions generated by the remediation orchestrator 114 can further include rate limiting via a token bucket mechanism maintained in the eBPF maps 104, such that the eBPF program decrements a token counter on each operation and denies the operation when the counter reaches zero, thereby reducing throughput rather than applying a hard deny. The enforcement actions can further include redirecting traffic to a particular monitoring or logging endpoint, such that the eBPF program rewrites the packet destination rather than dropping the packet. In some implementations, the error code returned by the enforcement action is configurable per policy, such that the system can return different error codes (e.g., operation not permitted, permission denied, or connection refused) depending on the policy configuration stored in the eBPF maps 104. In some implementations, the system operates in a shadow enforcement mode in which the eBPF programs 103 evaluate each operation request against the policy and emit events to the kernel event stream 105 but do not actually deny or restrict the operation. Shadow mode enables comparison of kernel-observed agent behavior against intended policy before enabling active enforcement, and can be toggled to active enforcement by updating a mode flag in the eBPF maps 104 without reloading the eBPF programs 103.

In some implementations, the system receives, via a kernel event stream from the one or more eBPF programs, kernel-captured events representing operations performed by the target AI agent set. In some implementations, the system receives the kernel-captured events through a ring buffer or perf events mechanism that streams data from kernel space to user space. The kernel-captured events constitute ground-truth behavioral evidence because they are generated by the kernel itself when the agent performs system calls, network operations, or file accesses. Unlike user-space telemetry that the agent could intercept and modify, these kernel-captured events reflect the agent's actual behavior as observed by the operating system. For example, the kernel-captured events can include file access events (file path, access mode, timestamp), network events (destination address, port, protocol, packet size), process events (process creation, termination, resource usage), and system call events (syscall number, arguments, return value). Referring to FIG. 1, the kernel event stream 105 includes a ring buffer and perf events for streaming kernel-captured data from the eBPF programs 103 to the observer 112 in the compliance platform environment 120.

The system generates, via an observer component, a kernel-attested observed value by canonically serializing the kernel-captured events and applying a second transformation operation set on the kernel-captured events. In some implementations, the observer component collects events over a time window and processes them to produce a deterministic representation of the observed behavior. Canonical serialization ensures that the events are processed in a deterministic order and format, enabling consistent comparison across verification cycles. For example, the canonical serialization can sort events by timestamp, normalize field values, and apply a consistent encoding scheme. The second transformation operation set can include a cryptographic hash function that produces a compact representation of the observed behavior, similar to the first transformation operation set used for the reference value. The resulting kernel-attested observed value represents what the agent actually did, as witnessed by the kernel, rather than what the agent claims to have done. Referring to FIG. 1, the observer 112 receives observation updates from the kernel event stream 105 and produces kernel-attested observed values for comparison by the compliance comparator 113.

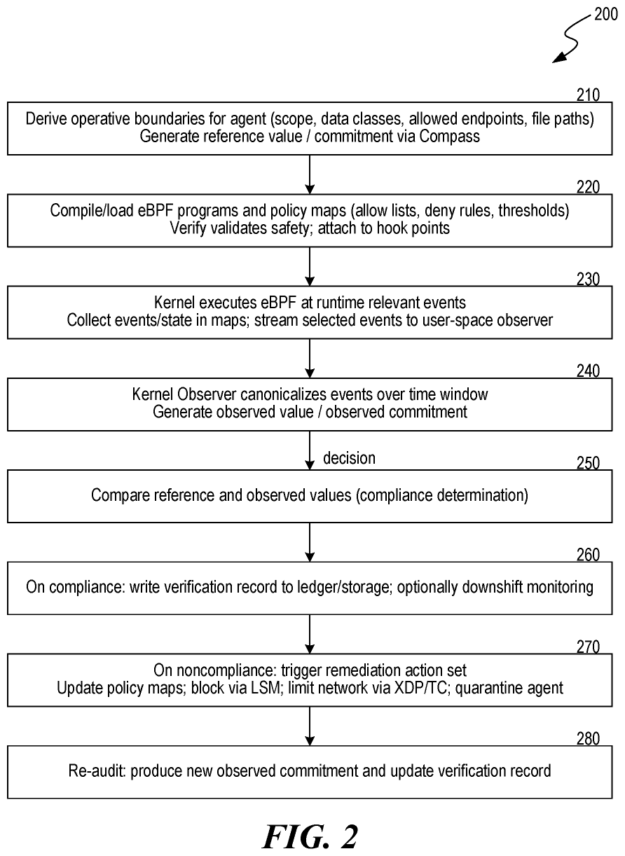

FIG. 2 illustrates a flowchart for a method 200 for kernel-level compliance monitoring and enforcement of an agent, in accordance with some implementations of the present technology. The method 200 begins with a step 210, where operative boundaries for the agent are derived, including scope, data classes, allowed endpoints, and file paths. During step 210, a reference value or commitment is generated, e.g., via Compass. The method 200 then proceeds to a step 220, where eBPF programs and policy maps are compiled and loaded. The policy maps include allow lists, deny rules, and thresholds. During step 220, the verifier validates safety of the eBPF programs, and the programs are attached to hook points within the kernel. At a step 230, the kernel executes the eBPF programs at runtime when relevant events occur. Events and state are collected in maps, and selected events are streamed to a user-space observer. The method 200 continues to a step 240, where a Kernel Observer canonicalizes events over a time window and generates an observed value or observed commitment based on the collected kernel-level data.

The system determines, via a compliance comparator, a verification status by comparing the reference value with the kernel-attested observed value. In some implementations, the verification status is indicative of compliance of the target AI agent set with the one or more operative boundaries. The compliance comparator evaluates whether the kernel-attested observed value satisfies the operative boundaries defined in the reference value. This comparison directly addresses the integrity gap in conventional systems because the observed value is derived from kernel-level evidence that the agent cannot fabricate. When the reference value and observed value satisfy the defined relationship, the system can confirm that the agent's actual behavior conforms to the specified operative boundaries. For example, the comparison can involve direct byte-to-byte equality checks when both values are cryptographic hashes, or more complex evaluation when the verification artifact includes zero-knowledge proofs. Referring to FIG. 1, the compliance comparator 113 can receive reference data from the compass 111 and observed values from the observer 112 to determine verification status.

In some implementations, the system receives, from the target AI agent set, an agent-reported observed value generated by the target AI agent set from its own internal operational dataset. The agent-reported observed value represents the target agent's self-reported telemetry or compliance artifacts, which the agent generates by applying transformation operations on data that the agent itself controls. The observer 112 computes a discrepancy metric between the kernel-attested observed value and the agent-reported observed value. The discrepancy metric quantifies the divergence between what the kernel observed the agent doing and what the agent claims to have done. A discrepancy exceeding a configurable threshold indicates that the target agent's internal dataset does not accurately reflect its actual behavior, which is a strong indicator of data manipulation, a compromised agent, or reporting evasion. The compliance comparator 113 evaluates the discrepancy metric as part of the verification status determination. The discrepancy metric is included in the verification record stored on the distributed ledger via the ledger storage 115, providing an auditable record of any divergence between kernel-attested and agent-reported behavioral evidence. When the discrepancy exceeds the threshold, the system can trigger the remediation orchestrator 114 to generate enforcement actions even if the agent-reported observed value would otherwise satisfy the operative boundaries, because the divergence between kernel-attested and agent-reported values indicates that the agent-reported data is unreliable. This cross-layer discrepancy detection ensures that the system can identify agents that attempt to falsify compliance artifacts while their actual kernel-observed behavior deviates from reported behavior.

Returning to FIG. 2, at a step 250, a decision is made by comparing the reference and observed values to determine compliance. This comparison constitutes a compliance determination. If the comparison indicates compliance, the method 200 proceeds to a step 260, where a verification record is written to ledger or storage. Optionally, monitoring can be downshifted during step 260. If the comparison indicates noncompliance, the method 200 proceeds to a step 270, where a remediation action set is triggered. During step 270, policy maps can be updated, operations can be blocked via LSM, network access can be limited via XDP or TC, and the agent can be quarantined. Following step 270, the method 200 proceeds to a step 280, where a re-audit is performed. During step 280, a new observed commitment is produced and the verification record is updated to reflect the current compliance status.

The system generates a verification record indicating the verification status. In some implementations, the verification record is stored as a transaction on a distributed ledger. The verification record can include a representation of the verification status, a timestamp, a digital signature of the verifying entity, and an indication of the machine-readable data structure used for comparison. The distributed ledger provides an immutable, tamper-evident record of all compliance verification activities, creating accountability and enabling forensic analysis. For example, the distributed ledger can be implemented as a blockchain, a federated ledger, or other distributed consensus system. Before the transaction is transmitted, the system can digitally sign the transaction using a private cryptographic key. The signed record can be broadcast to all nodes or participants in the storage structure, where the record can be checked and validated according to consensus rules. Once approved, the transaction can be permanently added to the storage structure. Referring to FIG. 1, the ledger storage 115 maintains verification records on a distributed ledger for audit purposes.

In some implementations, the system generates the verification record and transmits the verification record to a ledger storage. In particular, the ledger storage can include a distributed ledger, and the verification record can be stored as a transaction on the distributed ledger. The ledger storage can include a memory structure accessible to multiple AI agents including auditing agents and target agents. The system can store the verification record in association with identifier strings identifying the relevant agents. For example, the verification record can include the reference value, the observed value, the comparison result, timestamps, and cryptographic signatures that enable independent verification of the compliance determination. The distributed ledger ensures that verification records cannot be altered retroactively without detection, providing a reliable audit trail for compliance activities.

Responsive to the verification status indicating non-compliance of the target AI agent set with the one or more operative boundaries, the system loads an enforcement program into the kernel of the computing environment to restrict operations of the target AI agent set. In some implementations, the enforcement program can include additional eBPF programs or modifications to existing policy maps that implement restrictions on agent behavior. This enforcement capability ensures that detected violations result in immediate, kernel-level restrictions that the agent cannot bypass. For example, the enforcement program can block file access attempts via LSM hooks, drop network packets via XDP or TC hooks, or impose rate limits on resource consumption. Because enforcement occurs at the kernel level, the target agent cannot evade or circumvent the restrictions regardless of how sophisticated or adversarial its user-space code can be. Referring to FIG. 1, when the compliance comparator 113 detects non-compliance, it signals the remediation orchestrator 114, which generates enforcement actions that are transmitted via the policy distributor 116 to update the eBPF programs 103 and eBPF maps 104.

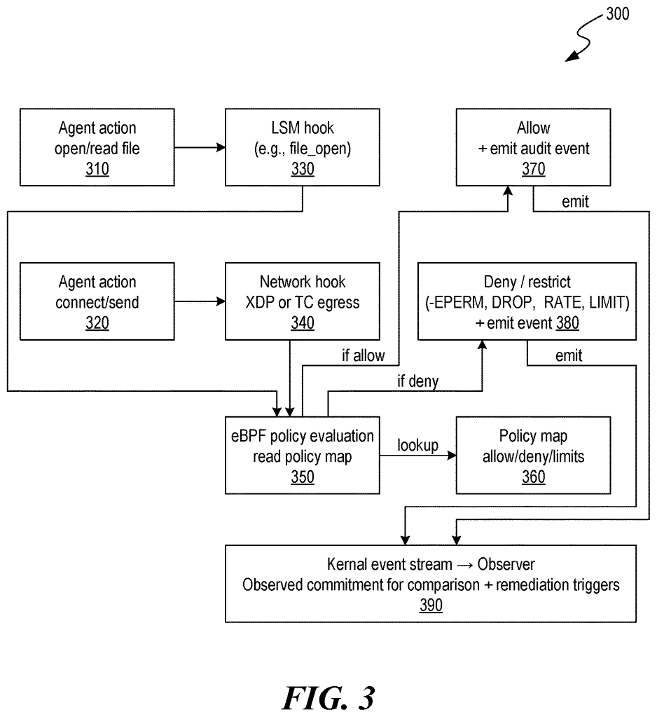

FIG. 3 illustrates a flowchart for a process 300 depicting kernel-level policy evaluation and enforcement for agent actions, in accordance with some implementations of the present technology. The process 300 shows two parallel entry paths for different types of agent actions and their corresponding kernel hook points. A first path begins with a step 310, where an agent action to open or read a file is initiated. The process 300 then proceeds to a step 330, where an LSM hook intercepts the file operation, such as a file_open hook. A second path begins with a step 320, where an agent action to connect or send network data is initiated. The process 300 then proceeds to a step 340, where a network hook intercepts the operation using XDP or TC egress mechanisms. Both paths converge at a step 350, where eBPF policy evaluation occurs by reading a policy map. The step 350 performs a lookup operation to a step 360, which contains the policy map storing allow, deny, and limit rules for agent operations.

Based on the policy evaluation, the process 300 branches into two possible outcomes. If the policy allows the operation, the process 300 proceeds to a step 370, where the action is allowed and an audit event is emitted. If the policy denies the operation, the process 300 proceeds to a step 380, where the action is denied or restricted. The denial at step 380 can return error codes such as EPERM, drop packets, apply rate limiting, or impose other limits, and an event is emitted to record the enforcement action. Both the allow path at step 370 and the deny path at step 380 emit events that flow to a step 390. The step 390 represents a kernel event stream directed to an observer component. The step 390 captures observed commitments for comparison against reference commitments and triggers remediation actions when compliance violations are detected. The process 300 demonstrates how kernel-level instrumentation intercepts agent operations at LSM hooks for file access and XDP or TC hooks for network operations, evaluates policies stored in eBPF maps, and enforces allow or deny decisions while streaming events for compliance verification.

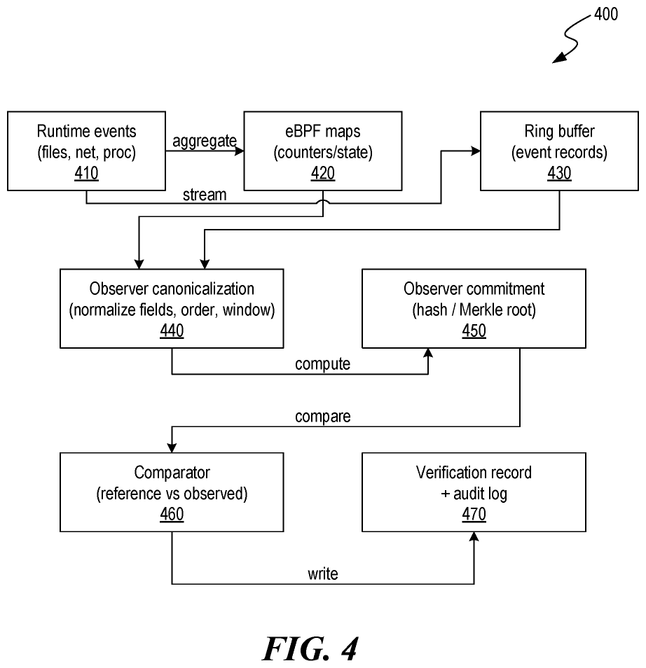

FIG. 4 illustrates a flowchart for a process 400 depicting a kernel-attested observed value pipeline for compliance verification, in accordance with some implementations of the present technology. The process 400 begins with runtime events 410, which capture behavioral data from files, network operations, and process activities associated with a target agent. The runtime events 410 are aggregated into eBPF maps 420, which maintain counters and state information related to the observed agent behavior. The eBPF maps 420 feed into a ring buffer 430, which stores event records for streaming to user space. The process 400 continues with the data from the eBPF maps 420 and ring buffer 430 being streamed to an observer canonicalization 440 component. The observer canonicalization 440 normalizes fields, establishes ordering, and applies windowing to the collected events to produce a deterministic representation of the observed behavior. The observer canonicalization 440 then computes an observer commitment 450, which generates a hash or Merkle root representing the kernel-attested observed value. The process 400 proceeds to a comparator 460, which performs a comparison between a reference value and the observed commitment generated by the observer commitment 450. Based on the comparison result, the comparator 460 writes to a verification record 470, which includes an audit log documenting the verification status and associated compliance information.

In some implementations, responsive to the verification status indicating non-compliance, the system triggers a remediation orchestrator to generate an action set. In some implementations, the action set can include one or more of updating the one or more policy maps, blocking operations via LSM hooks, limiting network access via XDP or TC hooks, or quarantining the target AI agent set. The remediation orchestrator analyzes the nature of the non-compliance and generates appropriate enforcement actions. For example, if the non-compliance involves unauthorized file access, the action set can include updating the policy maps to deny access to specific file paths. If the non-compliance involves unauthorized network communication, the action set can include XDP or TC rules to drop packets destined for unauthorized endpoints. Quarantining the target AI agent set can involve revoking credentials, isolating network access, or suspending execution. Referring to FIG. 1, the remediation orchestrator 114 receives signals from the compliance comparator 113 and generates enforcement actions that are transmitted to the policy distributor 116.

The system transmits updated policy information from the remediation orchestrator to a policy distributor. In some implementations, the system loads the updated policy information into the one or more policy maps via the policy distributor to enable dynamic enforcement without requiring cooperation from the target AI agent set. The policy distributor functions as an eBPF policy and program loader that can update the kernel-level enforcement mechanisms in real time. For example, the policy distributor can update eBPF map entries to add new deny rules, modify threshold values, or revoke previously granted permissions. The policy distributor can also load new eBPF programs or modify existing program attachments to implement additional monitoring or enforcement capabilities. Because these updates occur at the kernel level, they take effect immediately and cannot be circumvented by the target agent. Referring to FIG. 1, the policy distributor 116 transmits policy and program observation updates back to the eBPF maps 104 and eBPF programs 103 in the third party execution environment 110, enabling dynamic enforcement without requiring agent cooperation. This architecture ensures that the compliance platform maintains control over agent behavior even when agents are compromised, adversarial, or malfunctioning.

### Other Implementations

Traditional machine learning and large language models (LLMs) are typically designed as static, monolithic models. These models are trained on broad (i.e., general) datasets and, once deployed, respond to inputs strictly based on internal representations—that is, the way information, patterns, and relationships learned from training data is encoded and stored within the model's architecture as parameters, embeddings, and/or latent features. The internal representations enable the model to interpret and generate responses to new inputs by referencing what has been encoded during training. To update the internal representations, the models are retrained. An AI agent is a software entity characterized by objective functions and varying degrees of autonomy, which is capable of controlling its own decision making and acting, based on its perception of its environment, in pursuit of one or more objectives. Agents can perceive environments, make decisions, execute actions, and optimize their behavior with respect to one or more objective functions. Autonomous or semiautonomous agents can independently process incoming data, determine action plans, and dynamically invoke APIs, databases, other agents, or external services to execute tasks.

In conventional multi-tiered distributed systems that employ semiautonomous or autonomous agents, the organizational structure is typically arranged in hierarchical tiers such as primary entities, direct providers, and upstream sub-agents or subcontractors. Agents situated at each tier function as semi-independent or independent actors operating within specific domains of operations, such as receiving instructions, exchanging data, and/or executing tasks within their defined scope. Data, task assignments, and control decisions usually flow downward from first-tier (e.g., primary entity) agents to higher-tier (e.g., sub-agent) agents, while operational updates and results propagate upward.

However, in conventional multi-tiered distributed systems, organizations face significant challenges regarding visibility into second-tier and higher-tier suppliers or subcontractors. Typically, primary entities engage directly with their immediate providers and have little or no operational insight into the upstream/downstream networks managed by subcontractors or other providers. This problem is exacerbated in environments employing semiautonomous and/or autonomous agents, which are programmed to execute actions, make operational decisions, and invoke external services independently, without direct intervention or real-time oversight from the primary entity. In particular, once an initial instruction or delegation is issued to a first-tier agent, that agent may, according to its internal objective functions and contextual inputs, further delegate tasks, trigger computational operations, and/or interact with additional data sources and service endpoints upstream. As each agent in the hierarchy operates with varying degrees of autonomy and can utilize its own authenticated interfaces, operational logic, and data sources, the resulting decision processes, transactions, and control signals often propagate through layers of the system without the knowledge of the primary organizational entity. Thus primary entities (and agents of the primary entities) are unable to observe, audit, or even reconstruct the specific actions and decisions executed by second-tier or higher-tier agents when those agents use their autonomy to interact with external computational resources.

However, even if the agent of the primary entity were to directly contact the provider agents and/or sub-agents to verify compliance, the compliance proof submitted by the provider agents and/or sub-agents risks disclosure of sensitive or otherwise protected information. For example, compliance verification artifacts, such as audit records, attestation statements, digital checklists, and operational logs, typically require explicit inclusion of granular operational variables, such as supplier identity, order volumes, unit pricing, delivery schedules, and/or process-specific timestamps, to demonstrate adherence to prescribed parameters (e.g., contractual, regulatory). The embedded data fields and structural metadata within such compliance proofs can reveal confidential commercial terms, workflow details, and/or business relationships that are not intended to be shared outside the originating organization.

Therefore, conventional methods used to manage agent interactions in distributed networks are often reactive rather than proactive. Agents in conventional multi-tiered systems typically perform periodic or event-triggered reporting, wherein each agent, whether at the primary, provider, or sub-agent level, logs its own operational events, compliance states, or exception conditions into local or tier-specific data repositories. The logs or status reports are typically only propagated to adjacent tiers in response to explicit data requests, scheduled audits, or after the detection of an abnormal downstream outcome, such as a missed delivery, contract nonconformance, or security incident. As a result, detection of noncompliance or operational anomalies relies on the presence of observable symptoms in downstream workflows, such as deviations in key performance indicators (KPIs), transaction failures, or user feedback. For example, a primary entity can only become aware of inventory shortages, regulatory failures, or supply chain interruptions after receiving incomplete goods, delayed deliveries, or compliance notifications from its immediate provider, who in turn has consolidated data from upstream sub-agents after the event has propagated.

Attempting to create a system to perform privacy-preserving verification and compliance assessment among semiautonomous or autonomous AI agents in multi-tier distributed networks presented significant technological uncertainty, especially where datasets are highly distributed, access-restricted, or subject to varying policy and regulatory constraints (as commonly encountered in cross-organizational, industrial, and cloud-based environments). Architecting such a system necessitates addressing multiple technical unknowns in conventional approaches, such as cryptographically binding agent actions to compliance parameters without disclosing sensitive internal data and a lack of dynamic or context-aware verification across organizational boundaries.

To overcome the technological uncertainties, the inventors systematically evaluated multiple design alternatives. For example, the inventors evaluated systems in which all agent interactions and compliance events were centrally logged or brokered through a trusted third-party validation agent. While such centralized architectures enabled uniform auditing, they reintroduced a single point of trust and failure, and were non-viable in environments that required inter-organizational autonomy or strict partitioning of proprietary data. Another design alternative evaluated peer-to-peer, agent-initiated attestations by using traditional digital signatures or hash-linked event logs for compliance proof. While this improved decentralization, it required agents to transmit full or partially redacted datasets to validating parties, which exposes confidential process information and operational parameters. Attempts to use programmable threshold-based routing or static policy enforcement within multi-agent workflows, while offering an increased measure of automated compliance, could not dynamically adapt to changing operative boundaries (e.g., rules of a primary organization) or agent network composition within the multi-tiered distributed system.

As such, the inventors have developed systems (hereinafter “agent management platform”) and related methods to perform privacy-preserving, cryptographically verifiable compliance across multi-agent, multi-tier distributed systems. In some implementations, a storage structure (e.g., a distributed ledger, a blockchain) is accessible to a plurality of autonomous or semiautonomous agents (e.g., primary entity agents, provider agents, sub-agents). Primary entity agents can encode compliance boundary conditions and operational policies as machine-readable commitments, generated, for example, via non-invertible hash functions or zero-knowledge proof commitments, without disclosing underlying protected information. Provider and sub-agent entities, upon receiving the encoded operative boundaries, apply their own cryptographically secure transformation operations to local datasets and generate verification artifacts (such as zero-knowledge proofs) that attest to compliance with the defined boundaries without direct exposure of protected data. The verification artifacts are transmitted, referenced, and/or aggregated through the distributed ledger to enable first-tier and/or consensus agents to independently validate compliance status, record the results on the distributed ledger, and/or execute automated governance, escalation, or remediation workflows as triggered. The agent management platform can therefore dynamically adapt to changes in agent composition, operational contexts, and data access permissions, while maintaining audit trails and compliance without requiring centralized disclosure or control.

Each agent in the network of the multi-tiered distribution system, including provider agents and sub-agents, regardless of organizational tier, can be enabled to generate and submit a machine-verifiable attestation that is cryptographically linked to its unique digital identity and compliance boundaries and immutably recorded on the ledger. Therefore, the compliance parameters and obligations are propagated across the entire agent hierarchy in the multi-tiered distribution system so that parent requirements are automatically inherited and can be attested to by descendant agents. The agent management platform ensures that the compliance, operational, and decision records for every agent, regardless of tier or domain, are discoverable, independently auditable, and visible to parties in the supply chain. Additionally, zero-knowledge proofs enable agents to cryptographically attest to compliance with an operative boundary or policy but do not disclose protected information, such as information about supplier identity, pricing, proprietary methods, or transactional metadata. Only a fixed-length and/or non-invertible artifact or proof is presented for verification. Further, compliance, performance, and/or deviation alerts are autonomously broadcast and recorded once detected, often before downstream effects can propagate through the system. Rules and boundaries defined at the parent organizational level can be automatically transposed into executable verification requirements so that, as soon as an agent (or any of its dependencies) exhibits noncompliant or anomalous behavior, an alert can be transmitted and remediation can be triggered per an encoded policy on the blockchain. This eliminates the lag to batch-mode or request-driven workflows.

While the current description provides examples of the rule application engine related to LLMs, one of skill in the art would understand that the disclosed techniques can apply to other forms of machine learning or algorithms, including unsupervised, semi-supervised, supervised, and reinforcement learning techniques. For example, the disclosed agent management platform can use model outputs from support vector machine (SVM), k-nearest neighbor (KNN), decision-making, linear regression, random forest, naïve Bayes, or logistic regression algorithms, gradient boosting, and/or other suitable computational models.

In the following description, for the purposes of explanation, numerous specific details are set forth in order to provide a thorough understanding of implementations of the present technology. It will be apparent, however, to one skilled in the art that implementation of the present technology can be practiced without some of these specific details.

The phrases “in some implementations,” “in several implementations,” “according to some implementations,” “in the implementations shown,” “in other implementations,” and the like generally mean the specific feature, structure, or characteristic following the phrase is included in at least one implementation of the present technology and can be included in more than one implementation. In addition, such phrases do not necessarily refer to the same implementations or different implementations.

### Example Implementations of Verifying AI Agents in Multi-Tiered Distributed Systems

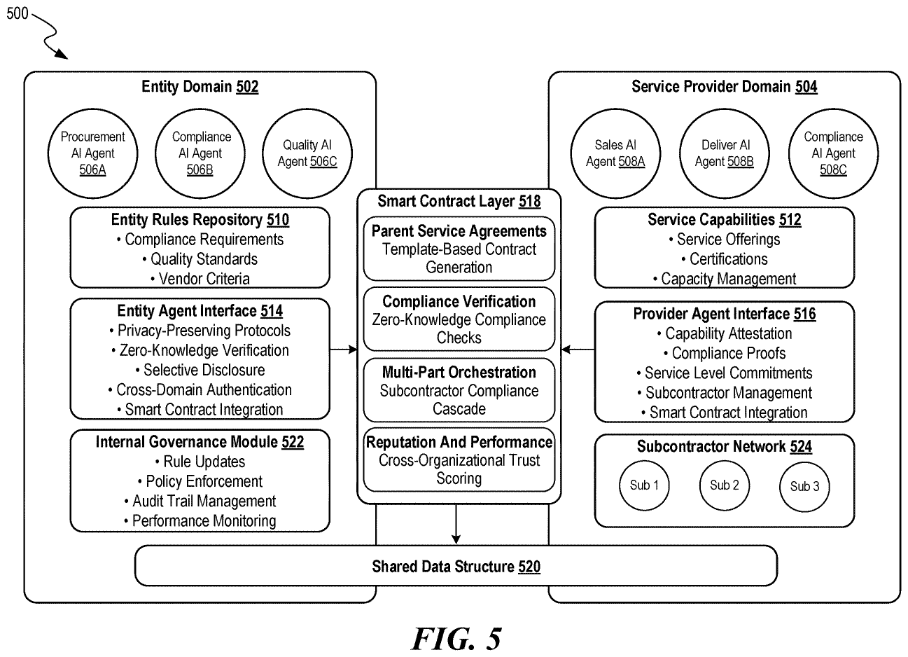

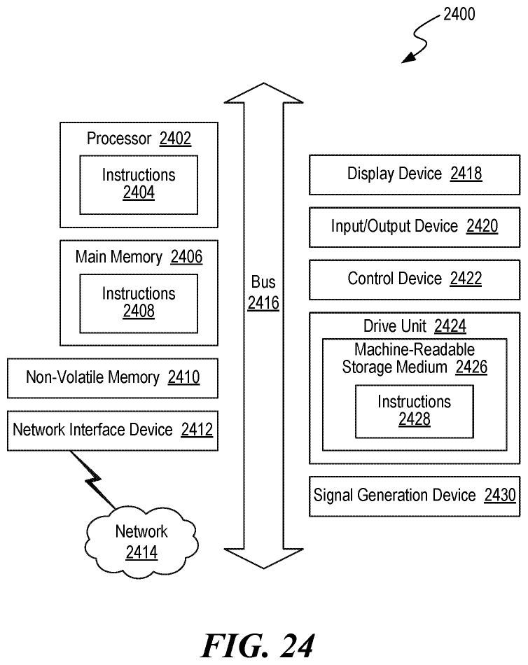

FIG. 5 illustrates an example environment 500 of an agent management platform for verifying autonomous agents in multi-tiered distributed systems while maintaining operational data privacy of respective autonomous agents, in accordance with some implementations of the present technology. The environment 500 can be implemented using components of example computer system 2400 illustrated and described in more detail with reference to FIG. 24. Likewise, implementations of example environment 500 can include different and/or additional components or can be connected in different ways.

Environment 500 can be segmented into an entity domain 502 and a service provider domain 504 communicatively connected by a smart contract layer 518. The entity domain 502 refers to a computational environment associated with an entity such as a primary organization or enterprise. As used herein, an entity domain 502 is defined as a computational node, execution environment, or virtual machine instance that maintains a unique identity and is configured to execute software instructions, store and process data, and manage associated autonomous and/or semiautonomous agents via one or more processor and memory subsystems. The entity domain 502 includes components such as internal process execution units, structured data storage and retrieval subsystems (e.g., databases, data lakes, or object stores), autonomous and/or semiautonomous agents, network interfaces and access control modules operating to enforce authentication and authorization for inbound and outbound data flows, and so forth. The entity domain 502 can be implemented as an isolated network segment with controlled access points to external systems. The entity domain 502 can generate separate environments for different departments or functions within the organization.

The provider domain 504 refers to a logically and/or physically isolated computing environment associated with external service providers or vendors that interact with the primary entity (i.e., the entity corresponding to the entity domain 502). The provider domain 504 includes the internal systems, autonomous agents, data structures, data repositories, and so forth corresponding to the external service providers. In some implementations, rather than the entity of the entity domain 502 being associated with a single service provider, the service provider domain 504 is implemented as a federated network of multiple service providers, each with its own subdomains.

Within the entity domain 502, multiple autonomous agentic AI models referred to as entity agents 506 (e.g., procurement AI agent 506A, compliance AI agent 506B, quality AI agent 506C, and so forth) can be used to perform operations associated with the entity domain 502. In the context of the agent management platform, an “agent” is a computational entity, implemented as an artificial intelligence (AI) process or human-supervised software module, whose operational behavior is governed by a machine-readable objective function. The objective function encodes the agent's optimization target or operational policy and directs its semiautonomous or autonomous programmatic decision-making. An agent is enabled to execute one or more actions independently, with autonomy defined as the ability to process input data, evaluate system proposals, generate evidence, and effectuate state-modifying operations without stepwise external control. Each agent can be constructed to include structured, persistent memory for maintaining state information, logs of historical transactions, and/or cryptographic credentials; input interfaces for acquiring data, protocol instructions, and authenticated messages from system components or external adapters; and output channels for transmitting verifiable decisions, artifacts, and/or cryptographic proofs to distributed ledgers or interfacing subsystems. Executable actions can include sequences of deterministic or conditional computer instructions triggered by protocol events or smart contract logic.

For example, the procurement AI agent 506A refers to an agent trained on structured datasets including historical transaction records, where each dataset entry is formatted as a data structure containing multi-field attributes such as cost, supplier identifier, item type, and timestamp. The procurement AI agent 506A can execute predictive analytics workflows, such as regression or classification models, to output predictions for attributes of prospective transactions (including but not limited to supplier selection, projected pricing, and estimated delivery time), wherein the predictions are determined based on input features provided at runtime.

In another example, the compliance AI agent 506B is an agent that receives operational metadata as input, such metadata including model parameter logs, event audit trails, and configuration data associated with subordinate AI models deployed by the entity or by external provider domains. The compliance AI agent 506B validates, through machine-executable rule sets, whether the operational behaviors of AI-driven processes within the domain adhere to externally provided regulatory standards, internal compliance policies, programmed constraints, or defined industry benchmarks. The compliance AI agent 506B can operate as a real-time or near-real time monitoring module by subscribing to streaming data feeds, detecting protocol violations, and generating machine-formatted compliance reports or alert notifications when such violations are detected. The compliance AI agent 506B can include logic to initiate automated, computer-implemented remediation workflows in software systems that are identified as noncompliant.

The quality AI agent 506C refers to an agent that can be used to maintain and/or align attributes of products, services, or processes within the entity with a set of criteria (e.g., quality criteria). The quality AI agent 506C can be implemented as an AI model that receives structured product or process data as input and applies machine-executable criteria to determine conformity of the data with technical quality specifications.

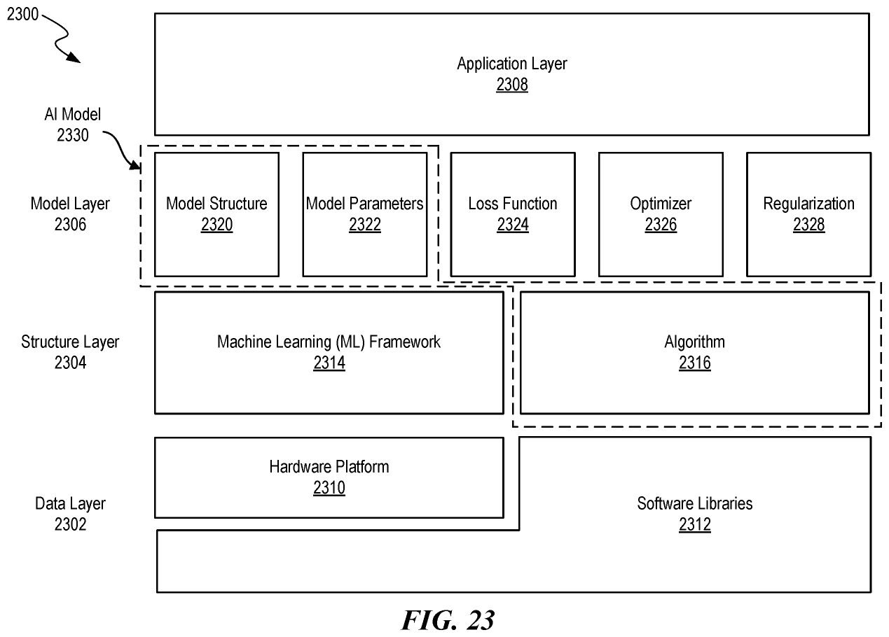

The service provider domain 504 can include its own (e.g., different) set of agents, referred to as the provider agents 508 (e.g., sales AI agent 508A, delivery AI agent 508B, compliance AI agent 508C, and so forth) herein. The entity agents 506 and provider agents 508 are the same as or similar to the AI system 2300 illustrated and described in more detail with reference to FIG. 23. As used herein, a “provider agent” is a software-implemented artificial intelligence (AI) process, instantiated on a processor or distributed compute instance, that autonomously executes computational routines and protocol-driven actions on behalf of the service provider.

The sales AI agent 508A, as instantiated within the service provider domain 504, is an agent whose objective function can be to maximize or increase the execution of digital sales transactions in accordance with specified logic and system constraints. The sales AI agent 508A can, for example, interface with input/output APIs to receive structured digital sales inquiries, smart contract templates, and/or service capability attestations as input artifacts. The sales AI agent can execute one or more evaluations, such as ranking, classification, or constraint satisfaction, to determine transaction parameters, generate digitally signed smart contract proposals, or send negotiation messages. All outputs can be formatted as machine-readable digital artifacts and communicated through agent interfaces to distributed smart contract layers for verification and further automated workflow execution.

The delivery AI agent 508B refers to an agent used to autonomously coordinate and/or verify the fulfillment of service delivery obligations specified by digital smart contracts. The delivery AI agent can receive as input smart contract terms, delivery event data, and service logs, represented as structured, machine-parsable digital records. The delivery AI agent can continuously monitor delivery states and generate digitally signed fulfillment confirmations and delivery status updates. The output artifacts can be transmitted to a shared data structure 520 or other agents.

The compliance AI agent 508C, similar to its counterpart in the entity domain 502, can validate adherence to computationally defined compliance requirements and digital contract clauses. Inputs to the compliance AI agent can include policy documents, regulatory parameter sets, operational logs, and machine-readable copies of smart contract terms. The compliance AI agent 508C can autonomously evaluate operational events and output compliance certificates, audit trails, or zero-knowledge proof artifacts as evidence of conformity to system policies or smart contract obligations.

In some implementations, the AI agents can be physical devices. For example, the AI agent can be a combination of software and hardware that can be packaged as an “agent device”. The agent device can communicate wirelessly using a wireless transceiver. Furthermore, the agent device can have other sensors such as cameras, microphones, and/or other suitable sensors. In some implementations, agent devices can be attached to robots or even living things. For example, a small scale robot that can move in and out of various locations can host an AI agent. In some implementations, the agent device can be attached to a living thing such as insects, animals, and/or other living things.

The entity rules repository 510 refers to a centralized data store associated with the entity domain 502 that is enabled to store, retrieve, and manage machine-readable rule sets, policy objects, and criteria-defining data structures that regulate an entity's operations and interactions with service providers (e.g., the service provider agent associated with the provider domain 504). A rule can be defined as a logic statement or parameterized condition that can be programmatically evaluated by autonomous agents at execution time. The repository can define operative boundary parameters for products, services, and internal processes in the form of configuration entries, logical expressions, or modular policy code that can be referenced by agents for automated compliance checks. The entity rules repository 510 can operate as a versioned database that defines the operative boundaries parameters for products, services, and/or processes within the organization. Additionally, the entity rules repository 510 can store provider criteria, which can be encoded as structured data tuples that specify provider qualification metrics, evaluation thresholds, and performance indicators, enabling agents to execute dynamic selection and scoring routines for service providers.

The service capabilities 512 within the service provider domain 504 refer to an unstructured, semi-structured, or structured (e.g., JSON, XML, relational) representation encoding the operational state, resource availability, and functional capacity of the provider's infrastructure. The service capabilities 512 can be implemented as a dynamic, self-updating environment that continuously assesses and reports on the provider's current capabilities. The service capabilities 512 can be formatted in accordance with one or more standardized ontologies, which define semantic schemas and controlled vocabularies that enable machine interpretation and interoperability with entity agents from the entity domain 502, used by the entity agent(s) associated with the entity domain 502.

The entity agent interface 514 refers to a communication layer that facilitates interactions between the entity domain 502 and other components of the system environment 500. This entity agent interface 514 can operate as a gateway for entity agents 506 to exchange information, submit requests, and/or receive responses from external systems, including the service provider domain 504 and the smart contract layer 518. The provider agent interface 516 refers to a complementary communication layer operating within the service provider domain 504 and enables provider agents 508 to interact with the environment 500. This provider agent interface 516 enables provider agents 508 to submit capability information, respond to requests, and/or participate in smart contract executions. The entity agent interface 514 and/or the provider agent interface 516 can maintain a record of entity agents 506 and/or provider agent 508 interactions (e.g., for compliance or dispute resolution purposes).

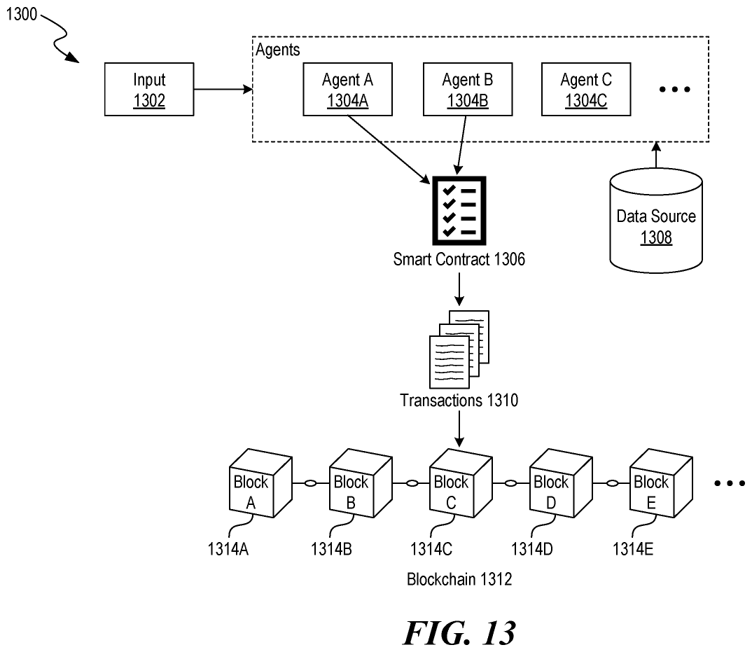

The smart contract layer 518 refers to a set of self-executing programs deployed on a shared data structure 520. The shared data structure 520 refers to a distributed ledger or blockchain system that operates to facilitate data exchange and transaction recording between the entity domain 502 and the service provider domain 504 (e.g., their respective agents). The shared data structure 520 can be implemented using a consortium blockchain architecture, where participating entities maintain nodes that collectively validate and store transactions. The smart contract layer 518 can include modules for generating and updating data structures defining agreements (e.g., parent service agreements, which operate as contracts governing the communications between the entity and service provider or their respective agent(s)). Further methods of generating and updating smart contracts between AI agents are discussed with reference to FIGS. 13-18. These data structures defining agreements can be implemented as template-based smart contracts with parameterizable clauses that can be customized for specific engagements. The smart contract layer 518 can, in some implementations, use a compliance verification module that uses zero-knowledge proofs to perform compliance checks without revealing sensitive operational data to enable trustless verification of adherence to agreed-upon terms. Additionally, the smart contract layer 518 can include a multi-part orchestration module used to manage interactions and dependencies between the smart contract between the entity agents and the provider agents and any subcontractor agreements between the provider agents and subcontractor agents, thereby ensuring compliance across the entire service delivery chain.

The internal governance module 522 within the entity domain 502 operates to manage internal policies, rules, and operational standards. The internal governance module 522 can use rule-based systems and/or machine learning models to dynamically update and enforce policies based on changing regulatory landscapes. The internal governance module 522 can automatically propose and/or execute updates to the entity rules repository 510. The internal governance module 522 can continuously monitor operational data of the entity domain and trigger automated responses to policy violations (e.g., remediation actions, alerts). The internal governance module 522 can maintain an audit trail using, for example, append-only data structures to ensure the immutability of governance-related actions and decisions. Additionally, the internal governance module 522 can continuously monitor operational data of the entity domain to determine one or more performance-based metrics (e.g., latency, accuracy) and use the determined metrics to assess the effectiveness of governance policies and identify areas for improvement.

The subcontractor network 524 within the service provider domain 504 refers to a hierarchical (e.g., graph-based) network of additional service providers or subcontractors that can be communicated with by the service provider agents 508 to fulfill specific aspects of the data structures defining agreements between the service provider agents 508 and the entity agents 506. The network can be implemented as a dynamic, graph-based structure that represents the relationships and dependencies between various subcontractor agents. Each node in the network data structure can correspond to a unique subcontractor agent, defined by digital identity keys and operational capability descriptors, while edges can encode communication channels, dependency hierarchies, or cascading workflow triggers. The subcontractor network 524 can use smart contracts to manage and enforce cascading compliance requirements across multiple tiers of subcontractor agents. In some implementations, the agent management platform can instantiate, monitor, and enforce smart contract terms programmatically and propagate compliance verification logic through the subcontractor graph.

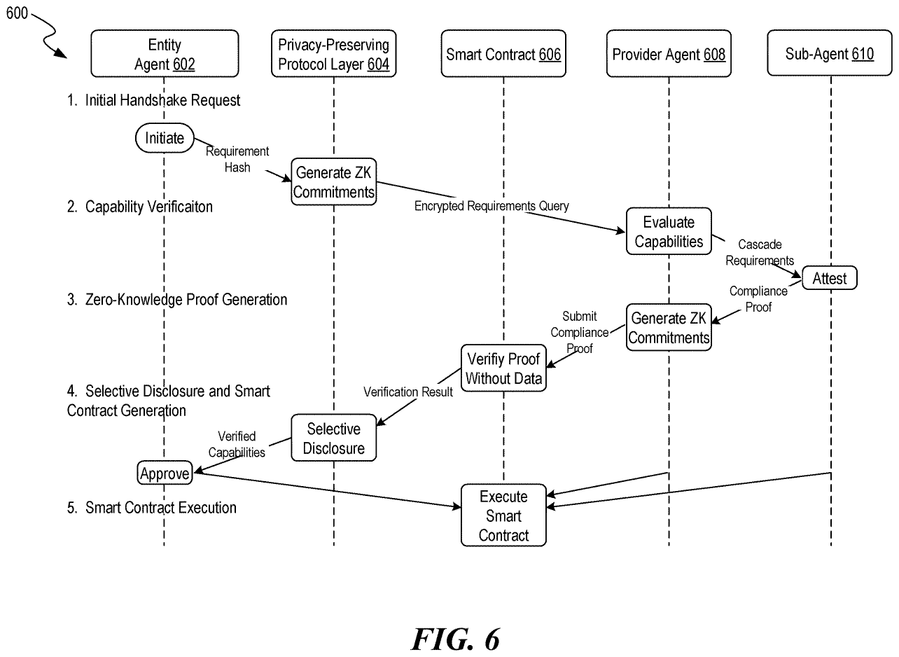

FIG. 6 illustrates an example environment 600 of an agent management platform for verifying autonomous agents in multi-tiered distributed systems that include a sub-agent associated with a provider agent, in accordance with some implementations of the present technology. Environment 600 includes an entity agent 602 (e.g., the entity agents 506 in FIG. 5), privacy-preserving protocol layer 604, smart contract 606, provider agent 608 (e.g., the provider agents 508 in FIG. 5), and sub-agent 610. The sub-agent 610 is the same as or similar to the AI system 2300 illustrated and described in more detail with reference to FIG. 23. The environment 600 can be implemented using components of example computer system 2400 illustrated and described in more detail with reference to FIG. 24. Likewise, implementations of example environment 600 can include different and/or additional components or can be connected in different ways.

The entity agent 602 refers to an agent representing the primary organization (e.g., entity) in the multi-tiered distributed system (e.g., the entity agents 506 in FIG. 5). The entity agent 602 can generate an initial handshake request, which includes a cryptographic requirement hash. For example, the entity agent 602 constructs an initialization packet containing digitally encoded operational parameters and constraints. The parameters are transformed into a fixed-length, non-invertible digital summary, thereby ensuring that the operational data can be uniquely referenced without direct exposure. The resulting digital artifact can be referred to as a cryptographic commitment and can be transmitted to a privacy-preserving protocol layer 604.

The privacy-preserving protocol layer 604 is enabled to facilitate secure and confidential interactions between the various agents in the system. Upon receiving the requirement hash from the entity agent 602, this privacy-preserving protocol layer 604 generates zero-knowledge (ZK) commitments, or additional binding values (i.e., commitments that securely reference but do not expose values of the original dataset). The values can be linked to their source data via collision-resistant transformations and can include random secret values to prevent reverse engineering. The privacy-preserving protocol layer 604 enables computational routines (such as verification of agent capabilities) to be executed on encrypted or obfuscated data inputs, such that assertions about agent compliance or resource sufficiency can be verified by external parties without the underlying operational data being revealed.

The smart contract 606 refers to a self-executing program deployed on a distributed ledger or blockchain infrastructure. The smart contract 606 can implement zero-knowledge proof verification to validate compliance proofs submitted by the provider agent 608. The provider agent 608 refers to an agent representing a service provider or vendor in the multi-tiered system (e.g., the provider agents 508 in FIG. 5). The provider agent 608 receives encrypted requirements queries and evaluates the respective capabilities of the provider agent 608 against these requirements. The provider agent 608 can generate and submit compliance proofs.

In some implementations, the requirements query from the smart contract 606 includes cascading requirements. Cascading requirements refer to a hierarchical set of operational, regulatory, or contractual obligations that originate from a primary contracting entity and are enforced across every tier of participating service agents, ensuring that not only provider agent 608 but also any associated sub-agent 610 adheres to the same standards. When the provider agent 608 receives these upstream requirements, the provider agent 608 can determine which obligations are applicable to each sub-agent under its domain. For example, the provider agent 608 can generate a subset of requirements applicable to a sub-agent 610 by applying one or more field filters on the requirements. The provider agent 608 can transmit the resulting subset of requirements to the sub-agent 610.

The sub-agent 610 refers to an agent operating under the purview of the provider agent 608. Upon receiving cascaded requirements, the sub-agent 610 can verify its compliance by running self-diagnostic routines, analyzing historical performance data, or conducting near-real-time or real-time capability assessments. The sub-agent 610 generates its own artifacts, such as ZK commitments, which can be aggregated or composed with those of the provider agent 608. These artifacts can be relayed upstream to provider agent 608, who aggregates and/or verifies them prior to generating an overall compliance proof for submission to the contracting entity or smart contract layer. The smart contract 606 and/or the entity agent 602 can verify incoming proofs, generated and submitted by the provider agent 608 and/or the sub-agent 610, against predefined compliance conditions whose parameters correspond to the commitment artifacts transmitted earlier in the process. Upon successful validation of these proofs by the smart contract 606 and/or the entity agent 602, the smart contract 606 autonomously updates the shared ledger.

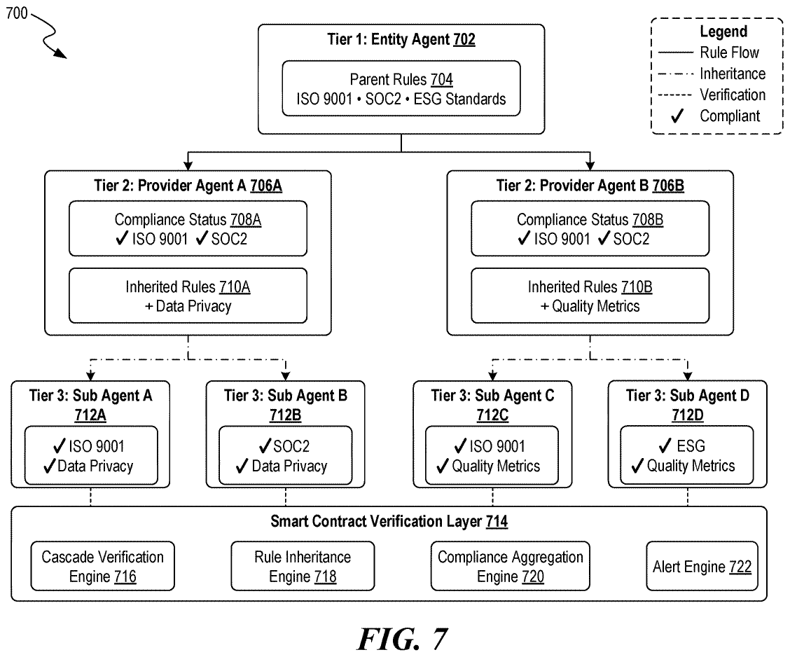

FIG. 7 illustrates an example environment 700 of an agent management platform for verifying autonomous agents in multi-tiered distributed systems that include, for an entity agent 702 (e.g., the entity agent 602 in FIG. 6, the entity agents 506 in FIG. 5), multiple provider agents 706 (e.g., a first provider agent 706A, a second provider agent 706B, and so forth) and sub-agents (e.g., a first sub-agent 712A, a second sub-agent 712B, a third sub-agent 712C, a fourth sub-agent 712D, and so forth), in accordance with some implementations of the present technology. The environment 700 can be implemented using components of example computer system 2400 illustrated and described in more detail with reference to FIG. 24. Likewise, implementations of example environment 700 can include different and/or additional components or can be connected in different ways.

The entity agent 702 is instantiated as an autonomous or semiautonomous software module representing the primary organization's computational authority in a distributed, multi-tiered system. The entity agent 702 defines and/or maintains the parent rules 704, which operate to provide global requirement specifications for all subordinate nodes and agents throughout the system. These rules can cover technical standards, operational thresholds, security benchmarks, and compliance objectives (e.g., categories such as quality management, information security, and sustainability). In the illustrated example, the parent rules 704 include ISO 9001 quality management standards, SOC2 information security standards, and ESG (environmental, social, and governance) criteria. The parent rules 704 can be implemented as a dynamic, graph-based data structure to enable rule propagation and inheritance across multiple tiers. Each rule node can include metadata, conditional logic, and pointers to child rules for inheritance. If a parent rule is updated based on downstream feedback or external regulatory triggers, the change can be automatically distributed through the graph, thereby updating the rule subsets for each downstream provider agent or sub-agent. The parent rules 704 can include self-modifying code elements that enable automated updates based on feedback from lower tiers and/or external regulatory changes (e.g., automatically increasing security requirements if new risks are detected or downgrading thresholds upon regulatory relaxation).

The provider agents 706 (e.g., first provider agent 706A, second provider agent 706B) refer to second-tier (or lower-tier) agents representing service providers or vendors within the multi-tiered network. The provider agents 706 can interpret and implement particular subsets of the parent rules 704. Each provider agent can maintain its own digital compliance status 708 (e.g., first compliance status 708A, second compliance status 708B), which can be implemented as an updatable data object or transaction log that records the agent's current adherence to technical, operational, and contractual standards. Status updates can be computed via continuous assessments. For example, provider agents automatically ingest operational logs, telemetry data, and workflow outputs, then execute probabilistic, rule-based algorithms to determine and revise the real-time state of compliance. Status objects can generate and export cryptographically signed attestations or proofs, enabling compliance states to be independently verified by upstream agents or the system's smart contract layer.

The inherited rules 710 (e.g., first inherited rule 710A, second inherited rule 710B) refer to subsets of the parent rules 704 that are specifically associated with each provider agent and its associated sub-agents. For example, a rule inheritance engine (such as rule inheritance engine 718, detailed below) can parse the rule graph to identify and filter the specific requirements applicable to each agent's operational context, resource capabilities, and contractual obligations. The output is a machine-readable structure for each inherited rule (e.g., first inherited rule 710A on data privacy, second inherited rule 710B on quality metrics), with metadata tags linking each inherited rule back to its parent.

The sub-agents 712 (e.g., first sub-agent 712A, second sub-agent 712B, third sub-agent 712C, fourth sub-agent 712D) refer to agents operating under the purview of the provider agents. Each sub-agent 712 receives its assigned inherited rules 710, parses rule logic, and executes local verification routines to determine its own degree of compliance. The sub-agents 712 can form collaborative groups and execute multi-party computation protocols that enable the sub-agents 712 to jointly compute aggregate compliance metrics or execute shared compliance verification tasks. For example, the sub-agents 712 contribute encrypted data shares or partial proofs so that no single entity learns the complete operational data of another; yet, the system can still collectively determine the state of compliance across all collaborating sub-agents.

The smart contract verification layer 714 refers to a blockchain-based infrastructure that enables automated compliance verification and enforcement across all tiers of the system. The smart contract verification layer 714 hosts smart contracts that receive compliance data, proofs, and attestations from agents and execute deterministic verification routines encoded as program logic. The smart contract verification layer 714 can include a cascade verification engine 716, which propagates and verifies compliance requirements from the top tier down to the sub-agents. The cascade verification engine 716 can use directed acyclic graph (DAG) structures of verification dependencies to map which agents and which compliance tasks must be fulfilled before system-wide compliance is recognized. As compliance proofs are submitted, the engine traverses the DAG, validating each dependency and updating network state accordingly.

The rule inheritance engine 718 refers to a module that manages the dynamic generation and adaptation of inherited rules for each tier. The rule inheritance engine 718 accepts as input the parent rule graph and agent profile data, then applies inheritance policies and prioritization logic to output a customized set of inherited rules for every downstream agent. The rule inheritance engine 718 can continuously adapt rule assignments as new agents come online, as feedback or compliance reports are received, and/or as parent rules are updated, thereby ensuring all rule propagation is contextually accurate and up-to-date throughout the distributed network.

The compliance aggregation engine 720 can collect and synthesize compliance data streams from multiple provider agents and sub-agents. The compliance aggregation engine 720 can use weighted scoring to combine the disparate data into an overall compliance report or status object reflecting the state of the entire multi-agent, multi-tiered system. Results can be stored as machine-readable records.

The alert engine 722 refers to a near-real-time or real-time monitoring and notification system that detects and reports compliance violations or anomalies. The alert engine 722 can evaluate compliance data and system telemetry in near-real time or real time. When a violation or anomaly is detected, the alert engine 722 triggers automated notifications (such as digital alerts or on-chain events), and can include diagnostic data or remediation instructions. All alerts can be logged for auditability, and the alert engine's 722 thresholds and response behaviors can be dynamically adjustable based on evolving system states.

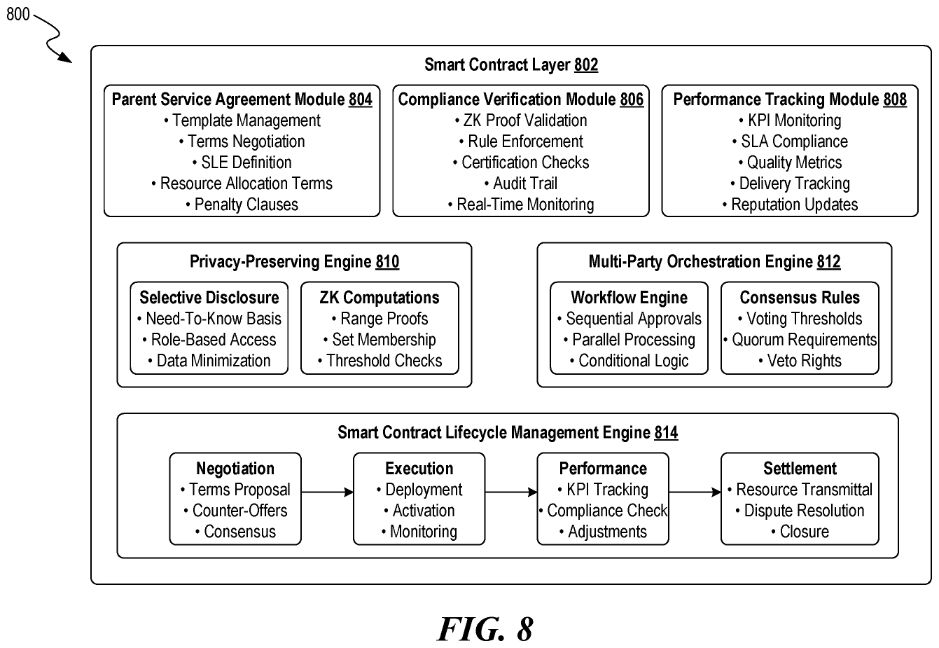

FIG. 8 illustrates an example environment 800 of a smart contract layer 802 within an agent management platform for verifying autonomous agents in multi-tiered distributed systems, in accordance with some implementations of the present technology. The smart contract layer 802 includes a parent service agreement module 804, a compliance verification module 806, a performance tracking module 808, a privacy-preserving engine 810, a multi-party orchestration engine 812, and a smart contract lifecycle management engine 814. The environment 800 can be implemented using components of example computer system 2400 illustrated and described in more detail with reference to FIG. 24. Likewise, implementations of example environment 800 can include different and/or additional components or can be connected in different ways.

The parent service agreement module 804 refers to a software component managing the formation, adaptation, and enforcement of obligations between the entity agent and downstream provider or sub-agent entities within the multi-tiered system. The parent service agreement module 804 enables the generation of standardized templates that can be dynamically instantiated according to specific agent roles, protocol state, or service context. Upon initiation, historical interaction data and machine-readable business rules can be used to forecast negotiation outcomes or proactively suggest amendments to the contractual terms. The parent service agreement module 804 can manage Service Level Expectation (SLE) definitions by translating requirements within smart contracts or agreements into measurable technical parameters (e.g., latency thresholds, uptime guarantees) and encoding these as monitorable variables inside smart contracts. During operation, the parent service agreement module 804 can track resource allocation states, such as payment flows or token-based disbursements, and trigger automated, condition-based value transfers when predefined thresholds or service proofs are detected on-chain. For enforcement, the parent service agreement module 804 maintains digitally encoded penalty clauses, such that if a monitored parameter falls out of compliance, the parent service agreement module 804 programmatically invokes corresponding penalty routines (e.g., withholding or debiting digital assets) without manual intervention.

The compliance verification module 806 uses ZK proof validation to enable parties to verify compliance without revealing sensitive underlying data. For example, when an agent claims compliance with a contractual obligation, the compliance verification module 806 receives a proof package structured to conceal underlying sensitive data. The compliance verification module 806 can check contract execution against predefined compliance criteria, triggering alerts or actions when deviations are detected. Validation processes can be fully automated, on contract execution or at scheduled compliance checkpoints, and can initiate protocol-defined responses or alert routines if deviations or violations are detected. The compliance verification module 806 can conduct certification checks by interfacing with external systems to validate and update the certification status of involved parties. The compliance verification module 806 maintains an audit trail by recording compliance-related activities and verifications in a blockchain-based log.

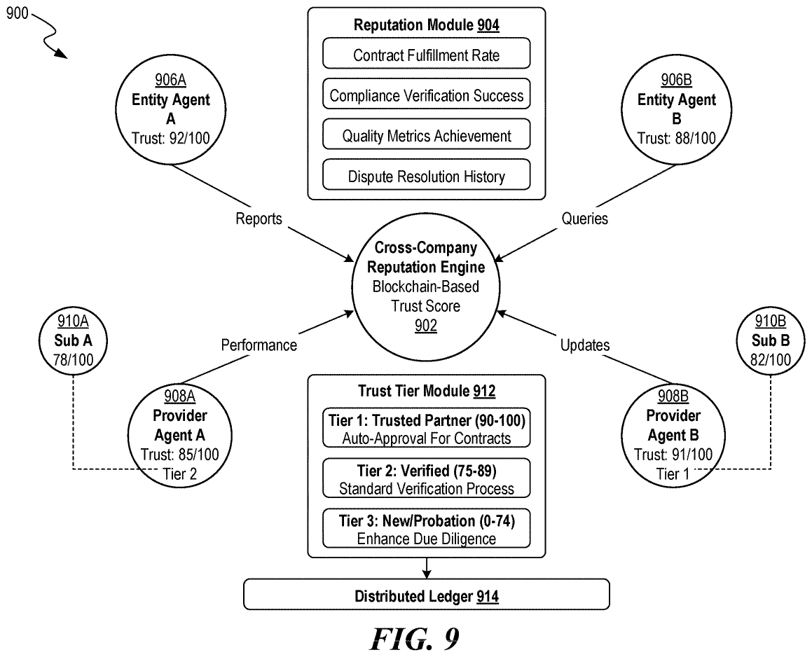

The performance tracking module 808 monitors and evaluates the operational execution of the smart contracts. The performance tracking module 808 ingests event logs, telemetry streams, and data feeds from agent interfaces and external sensors, such as IoT devices monitoring delivery or production metrics. The performance tracking module 808 parses contract terms to derive quantifiable performance indicators, translates these requirements into runtime queries, and then compares observed system behavior with expected benchmarks (e.g., SLA parameters, performance thresholds). As performance is measured against each benchmark, the performance tracking module 808 can automatically record trend data, detect anomalies or deviations, and/or update the compliance status signals for each involved party. The performance tracking module 808 can perform reputation updates, aggregating performance data to dynamically adjust trust or reliability indices/scores for involved parties (as described below in further detail with reference to FIG. 9), which can influence future execution parameters of the smart contract.

The privacy-preserving engine 810 enables parties to reveal only the required information on a need-to-know basis using role-based access controls to ensure that data and contract functionalities are accessible only to authorized entities based on their defined roles and permissions within the system. For example, each data transaction or contract function call is checked against an authenticated role and permission set. The privacy-preserving engine 810 enables operations to run directly on encrypted, tokenized, or obfuscated data structures, using techniques such as range evaluation, set membership approximation, or threshold validation, so that only the outcome (e.g., whether a number falls within a range or a status is affirmative) is revealed to the querying party rather than the underlying raw value. For example, the privacy-preserving engine 810 can use range proofs to demonstrate that a value falls within a specified range without disclosing the actual value, set membership verifications to prove inclusion in a set without revealing other set elements, and/or perform threshold checks to validate that certain conditions are met without exposing the specific data points involved in the evaluation.

The multi-party orchestration engine 812 uses a workflow engine to manage sequential approvals, ensuring that contract actions or state transitions occur in a predefined order and only when particular conditions are met. The multi-party orchestration engine 812 can use consensus rules that define how agreement is reached among multiple parties, which can include voting thresholds specifying the level of agreement required for different types of decisions, quorum requirements ensuring that a minimum number of participants are involved in decision-making processes, veto rights that allow designated parties to block certain actions under specified conditions, and so forth.

The smart contract lifecycle management engine 814 can manage a negotiation phase to facilitate the proposal of contract terms, respond to counter-offers through automated or semiautomated processes, and/or coordinate consensus among involved parties. The smart contract lifecycle management engine 814 tracks contract activation triggers, whether event-driven, time-based, or KPI-dependent, and monitors ongoing performance and compliance by ingesting near-real-time or real-time system data and executing rule-based state evaluation routines. The smart contract lifecycle management engine 814, for example, tracks KPIs, performs ongoing compliance checks, and executes adjustments to contract parameters or execution based on observed outcomes or changing conditions. In the settlement phase, the smart contract lifecycle management engine 814 manages resource (e.g., payment) releases by, for example, interfacing with digital payment systems. The smart contract lifecycle management engine 814 can manage dispute resolution processes that can include automated arbitration or integration with external dispute resolution systems. The smart contract lifecycle management engine 814 can further manage contract closure, ensuring all obligations are fulfilled, all parties are notified, and/or that the contract state is archived for future reference or audit purposes.

FIG. 9 illustrates an example environment 900 of a reputation engine 902 within an agent management platform for verifying autonomous agents in multi-tiered distributed systems, in accordance with some implementations of the present technology. The environment 900 can be implemented using components of example computer system 2400 illustrated and described in more detail with reference to FIG. 24. Likewise, implementations of example environment 900 can include different and/or additional components or can be connected in different ways.

The reputation engine 902 aggregates, processes, and maintains digital trust scores for agents (including entity agents, provider agents, and/or sub-agents) operating within the multi-tiered distributed system. The reputation engine 902 can continuously collect performance data, operational logs, compliance outcomes, and dispute resolution records from multiple system modules and external sources via authenticated data feeds. Upon receipt, the engine stores raw and processed data in a distributed ledger, such as a blockchain. Computational routines can be periodically executed on this data to recalculate trust scores based on updated metrics or changing network context. The reputation engine 902 exposes transaction endpoints through which agents can submit new records, query current scores, or request aggregated reports.

The reputation module 904 defines the concrete parameters and operational metrics used to compute trust scores for each agent. The reputation module 904 can encode a set of scoring metrics, which can include contract fulfillment rate (quantifying on-time and complete delivery of agreed tasks), compliance verification success (measuring the agent's historical adherence to requirements and standards), quality metric achievement (scoring based on objective outcomes such as error rate, defect absence, or service consistency), and dispute resolution history (capturing the agent's track record for resolving conflicts within protocol parameters). Data for the metrics can be ingested as time-series logs. Metric weightings can be dynamically recalibrated by system administrators or in response to particular received data signals (e.g., changes in sub-agents, provider agents, entity agents, and so forth).

The entity agents 906 (e.g., first entity agent 906A, second entity agent 906B) refer to agents representing primary organizations within the network. The entity agents 906 can transmit digitally signed operational reports, submit event records for scoring, and/or query the reputation engine 902 for up-to-date trust scores on itself or third parties. Trust scores for entity agents 906, such as the illustrative 92/100 (for agent 906A) and 88/100 (for agent 906B), can be computed through the weighted aggregation of the metrics provided by the reputation module 904. The reputation engine 902 can reconfigure weights based on factors such as industry vertical, contract type, or network risk signals. Updated trust scores can be recorded as transaction entries to the distributed ledger.

The provider agents 908 (e.g., first provider agent 908A, second provider agent 908B) refer to agents representing service providers or vendors. The provider agents 908 collect and submit quantitative performance data, such as delivery punctuality, transaction accuracy, and compliance proof submissions, to the reputation engine 902, where the data is used to update their corresponding trust scores (e.g., provider agent 908A: 85/100, provider agent 908B: 91/100). Trust scores can directly influence automated classification into tiers, which can be referenced by smart contracts and the multi-party orchestration engine for determining workflow paths, verification requirements, and/or permission or settlement protocols. The provider agents can receive automated trust score updates at a conclusion of each transactional or monitoring cycle.

The sub-agents 910 (e.g., first sub-agent 910A, second sub-agent 910B) refer to third-tier AI systems operating under the purview of provider agents. The trust scores for sub-agents (e.g., 910A: 78/100, 910B: 82/100) can be determined using hierarchical aggregation logic, in which a sub-agent's performance data is evaluated both independently (via direct metrics) and in the context of its parent provider agent's reputation footprint. Thus, trust signals can be weighted or modified by the performance and standing of supervising agents.

The trust tier module 912 can categorize agents into predefined categories or “tiers” (e.g., Tier 1, Tier 2, Tier 3) according to configurable threshold criteria. For instance, Tier 1 can be reserved for trust scores in the 90-100 range, enabling privileges such as smart contract auto-approval, whereas lower tiers (e.g., Tier 2:75-89, Tier 3:0-74) can impose graduated verification, additional review steps, or additional due diligence requirements. The module can dynamically shift tier boundaries in response to environmental signals, such as systemic changes in network risk, new regulatory mandates, or altered transaction volume.

The distributed ledger 914 refers to the underlying blockchain infrastructure that stores and validates reputation-related transactions and/or trust scores. Smart contracts deployed on the distributed ledger 914 automate the execution of reputation calculations, tier assignments, and access control based on trust scores. Transactions, reputation updates, and tier assignments can be encoded as cryptographically hashed, append-only record objects, providing an immutable audit trail and non-repudiable evidence chain for all trust management activities. The distributed ledger 914 exposes API endpoints to modules across the platform for both data retrieval and transactional submission.

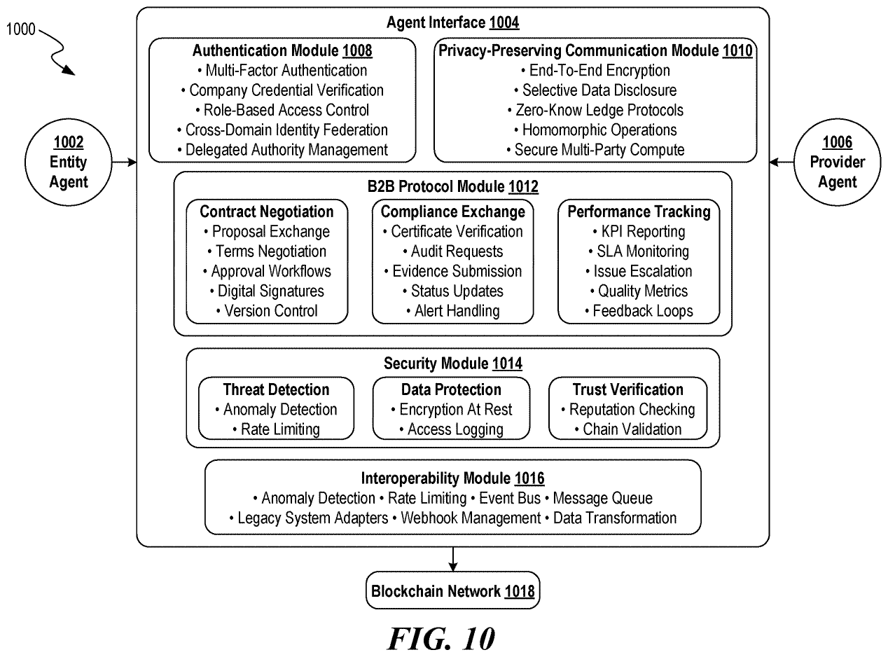

FIG. 10 illustrates an example environment 1000 of an agent interface 1004 within an agent management platform for enabling communication between autonomous agents in multi-tiered distributed systems, in accordance with some implementations of the present technology. The environment 1000 can be implemented using components of example computer system 2400 illustrated and described in more detail with reference to FIG. 24. Likewise, implementations of example environment 1000 can include different and/or additional components or can be connected in different ways.

The environment 1000 includes an entity agent 1002, the agent interface 1004, and a provider agent 1006. The agent interface 1004 operates as an intermediary layer between different autonomous agents and provides a standardized set of protocols and services for inter-agent communication. The agent interface 1004 includes an authentication module 1008, a communication module 1010, a protocol module 1012, a security module 1014, an interoperability module 1016, and a network 1018.

The authentication module 1008 can be used to verify the identity and credentials of agents attempting to interact with the system. The authentication module 1008 can implement multi-factor authentication, which can combine various authentication methods such as digital certificates, biometric data, and time-based one-time passwords. When an agent initiates a session or requests access to a protected operation, it submits authentication credentials, which can include digital certificates, biometric vectors, or one-time digital tokens. The authentication module 1008 can compile these credentials into an authentication request, which is then compared against verifiable credential records stored within a distributed identity management registry. By employing digital signatures and time-based proofs, the authentication module 1008 can ensure both the origin and validity of submitted credentials. Role-based access assignments can be invoked. Once authenticated, each agent's unique identity can be mapped to a predefined role that encodes permissions for actions and data access within the system. The authentication module 1008 can enable federated authentication, allowing agents validated in external domains with compatible protocols to gain time-bound or task-specific authorization, managed through temporary access tokens and enforced expiration logic. All authentication and authorization events can be written as immutable logs, providing a permanent and auditable transaction trail.

The privacy-preserving communication module 1010 uses end-to-end encryption to ensure that data remains secure throughout its transmission. Each communication session can generate a negotiated encryption context, so that transmitted packets are only intelligible to authorized senders and recipients. For interactions requiring minimal disclosure, the privacy-preserving communication module 1010 can extract only the verification statements from agent data, then package the statements as proofs or attestations, which are relayed to requesting agents or subsystems. All non-essential data (i.e., data that is not the verification statement) can be withheld from transmission. When agents establish that they possess (or comply with) certain knowledge, rules, or properties without exposing the details, the privacy-preserving communication module 1010 can generate and validate proof objects that confirm properties without disseminating the protected data. In collaborative scenarios involving multiple agents, the privacy-preserving communication module 1010 enables computation routines that allow joint calculation or protocol advancement based solely on exchanged, privacy-preserving proofs, so that no party gains access to another's underlying inputs.

The business-to-business (B2B) protocol module 1012 manages the interactions and data exchanges specific to entity-to-entity operations. Data packets including proposals, negotiation terms, and/or approval workflows can be formatted into standardized, machine-readable documents. When an entity submits a proposal, the B2B protocol module 1012 routes the proposal to the recipient agent, which can accept, modify, or reject the proposal. Approved terms can be automatically registered as transaction records on the platform. For ongoing relationships, the B2B protocol module 1012 can perform periodic transmission and archiving of KPI data, service level reports, and incident or escalation notices.

The security module 1014 implements threat detection operations to identify potential security threats in real time or near-real time. As data and interaction requests flow through the platform, the security module 1014 continuously inspects all payloads, session states, and event logs for anomalous patterns, unauthorized signatures, or deviations from known baselines of trusted agent behaviors. Whenever an interaction originates from an agent, the security module 1014 cross-references the agent's trust profile (as derived from an internal reputation system or external trust registry) to determine whether access constraints should be applied. Should a pattern indicative of attack or policy violation be detected, the security module 1014 automatically generates alerts, initiates session quarantines, or triggers protocol-level blocks.

The interoperability module 1016 coordinates communications and protocol conversions between the current platform and external or legacy systems. The interoperability module 1016 maintains an event bus, which refers to an internal messaging infrastructure that receives, packages, and sequentially distributes events, data packets, or notifications to all relevant modules. Upon receiving data from outside systems, the interoperability module 1016 adapts and transforms legacy or non-standard data formats to the agent management platform's schema, validates external signatures, and injects integration events onto the bus. In reverse, when outgoing communications target older or third-party systems, the interoperability module 1016 translates structured records into compatible formats and manages delivery channels.

The blockchain network 1018 refers to the underlying distributed ledger technology that enables immutable recording of transactions and interactions between agents. Each agent or organization can operate a node within this network, which receives transaction proposals, bundles them into blocks, and participates in decentralized validation cycles. Upon reaching protocol consensus, new blocks are appended to the shared ledger, and all network participants synchronize their local copies, ensuring a single, non-repudiable source of truth. Contract terms, permissions changes, dispute resolutions, and audit logs can be stored as structured records within the ledger. Smart contracts deployed to the blockchain automate the enforcement of agreement conditions. When conditions are satisfied or violated by agent actions, the contracts autonomously trigger or prevent subsequent operations (such as payment release or service continuation).

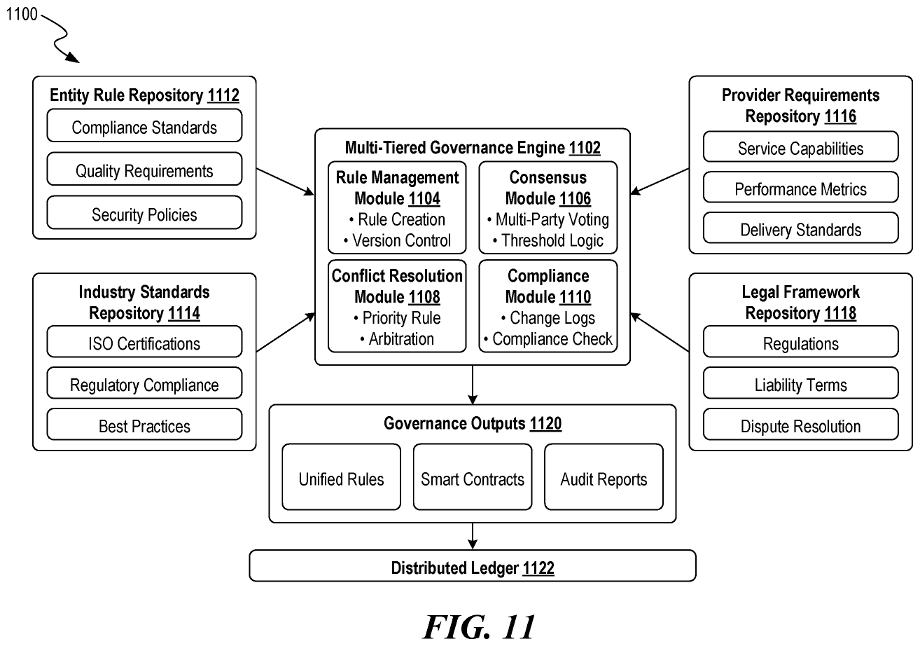

FIG. 11 illustrates an example environment 1100 of a governance engine within an agent management platform defining operative boundaries of autonomous agents in multi-tiered distributed systems, in accordance with some implementations of the present technology. The environment 1100 can be implemented using components of example computer system 2400 illustrated and described in more detail with reference to FIG. 24. Likewise, implementations of example environment 1100 can include different and/or additional components or can be connected in different ways.

The governance engine 1102 refers to a modular computational subsystem that can be implemented as a federated service using distributed microservices, or as a containerized software runtime within a cloud environment, and is configured to ingest, process, normalize, and propagate governance policies and requirements across the agent management platform. The governance engine 1102 can receive inputs such as rule definitions, change proposals, compliance logs, contract state transitions, and external legal updates and transform these inputs into actionable governance outputs and audit artifacts consumed by downstream modules using, for example, rule-based mappings.

Within the governance engine 1102, the rule management module 1104 operates to generate and/or update machine-readable rule sets and governance logic. The rule management module 1104 can provide user-facing APIs or agent-accessible endpoints for submission, validation, and approval of new or revised rules. When a new rule is added, the rule management module 1104 can store the rules as persistent objects, which can be appended with metadata such as authorship, version sequence, timestamps, and digital signatures. Rule updates and deprecations can be similarly managed, with each event producing immutable change records. In some implementations, the rule management module 1104 can be integrated with external policy sources or receive input from industry-specific domain ontologies.

The consensus module 1106 mediates multi-party decision-making regarding policy adoptions, updates, or dispute adjudications. The consensus module 1106 aggregates stakeholder votes, agent endorsements, or digital ballots according to predetermined voting schemas, such as majority, supermajority, or weighted-reputation methods, and continuously transforms submitted votes into single, deterministic consensus results. The consensus module 1106 can validate submitted ballots for authenticity and eligibility, compute attested outcomes, and propagate consensus state changes to other system modules.

The conflict resolution module 1108 detects, logs, and/or resolves policy or data conflicts that can arise from asynchronous actions, competing rule updates, or network-level adversarial behavior. The conflict resolution module 1108 ingests divergent state records, contradictory rule changes, or evidence of operational anomaly and executes rule-based or adjudication workflows for alignment, rollback, or dispute mediation. Conflict resolution can include automated precedence logic, voting resolution by a select panel, or escalation to external arbiters (e.g., administrators). Each resolution operation can be logged with immutable event records, such as before-and-after state hashes.

The compliance module 1110 validates agent and workflow conformance with approved rules, contract clauses, and regulatory requirements. The compliance module 1110 receives compliance criteria from the rule management module, applies these checks to event streams and agent actions (such as transaction logs or resource allocation events), and/or records the outcome of each compliance assessment as a machine-readable verdict (e.g., pass/fail, out-of-bounds, or escalation-needed). The compliance module 1110 can trigger automated enforcement actions, such as penalties, role adjustments, or notifications to other governance elements in the case of detected violations.

The entity rule repository 1112 refers to a persistent, version-controlled data store for storing rules and policies authored by or otherwise associated with the primary organizational entity. The entity rule repository 1112 can be implemented as a distributed, append-only ledger, a cloud-based document datastore, or a blockchain state channel backing and stores each rule entry with structured metadata and historical lineage to support provenance and audit tracing. Rule entries can be retrieved by authorized governance engine components to inform real-time compliance, update cascades, or versioned change reconciliations.

The industry standards repository 1114 refers to a persistent storage and retrieval subsystem maintaining externally sourced or standardized policy objects, such as ISO standards, industry frameworks, or regulatory reference rulesets. The industry standards repository 1114 can operate both as a near-real-time or real-time policy lookup (enabling the governance engine to map internal rules to external obligations) as well as a historical policy audit log (storing timestamped records of standards in effect at any given time). The industry standards repository 1114 can receive inputs from third-party data feeds or manual data import. The provider requirements repository 1116 refers to a structured data store identifying input requirements stipulated by providers, vendors, or external agents interacting with the platform. The provider requirements repository 1116 ensures that provider-specific obligations, such as quality metrics, delivery guarantees, or compatibility thresholds, are encoded as structured objects, transformed to match internal taxonomies, and evaluated against respective agents for operational alignment. The legal framework repository 1118 refers to a database that manages codified legal requirements and regulatory provisions applicable to the system and its agents. The legal framework repository 1118 can be updated with jurisdictional and cross-jurisdictional legal texts, statutory obligations, and case law and operates to provide an authoritative reference during rule design, compliance checks, or dispute resolutions. Repository entries can be annotated to indicate applicable regions, effective dates, and citation sources.

Governance outputs 1120 refer to the collection of artifacts generated by the governance engine 1102 to identify system policies, compliance verdicts, and audit traces. Governance outputs 1120 can include signed compliance certificates, change-of-state notifications, escalation alerts, conflict resolution records, and machine-readable configuration changes. Governance outputs 1120 can be formatted for automated consumption by other system modules, downstream agents, or audit platforms. The distributed ledger 1122 can validate and/or store the governance outputs 1120 and can supply synchronous and/or asynchronous data access to system components and external auditors.

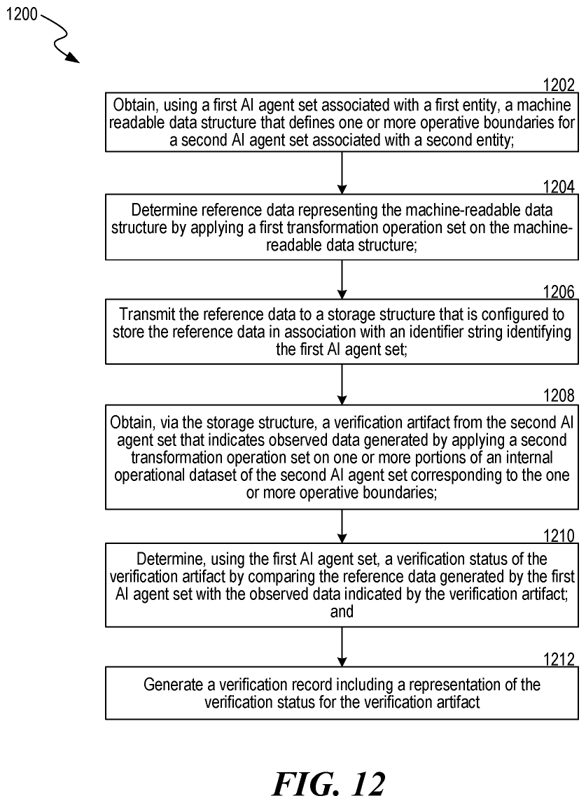

FIG. 12 is a flow diagram illustrating an example process 1200 of verifying autonomous agents in multi-tiered distributed systems using an agent management platform according to some implementations of the present technology. In some implementations, the process 1200 is performed by a computer system, e.g., example computer system 2400 illustrated and described in more detail with reference to FIG. 24. Implementations can include different and/or additional operations or can perform the operations in different orders.

In operation 1202, the agent management platform can obtain, using a first AI agent associated with a first entity (i.e., the primary organization), a machine-readable data structure (i.e., a requirements hash) that defines one or more operative boundaries for a second AI agent associated with a second entity (e.g., representing organizational guidelines, industry standards, or provider criteria). The machine-readable data structure can indicate permissible value ranges for model parameters (e.g., weight coefficients of a neural network) of a second AI agent (e.g., a provider agent), a data signal used in operation of the second AI agent (e.g., feature vectors, event traces), information related to a completed computational operation of the second AI agent (e.g., specifications of allowable outputs for completed computational operations such as a result set cardinality, data type conformance, or adherence to external regulatory normative), and the like. For example, the first AI agent can obtain the machine-readable data structure through an API call. If the operative boundary includes references to dynamic or externally sourced values (such as regulatory rules that change over time), the first AI agent fetches the current authoritative values from one or more predefined “trusted” sources. The first AI agent can be referred to herein also as an auditing AI agent and the second AI agent can be referred to herein also as a target AI agent.

In operation 1204, the agent management platform can generate/determine a unique fixed reference value (e.g., reference data, or encrypted requirements query generated by privacy-preserving protocol layer) representing the machine-readable data structure by applying a first transformation operation set (e.g., a cryptographic hash function, a keyed hash function, or a deterministic encoding function) on the machine-readable data structure. To generate the unique fixed reference value representing the machine-readable data structure, the agent management platform can serialize the input structure, such as an object with nested fields and values, into a canonical byte sequence that captures its hierarchical arrangement and/or data content in a format agnostic to particular differences (such as field order or whitespace). The agent management platform can process the resulting byte sequence through a deterministic and/or fixed-size transformation operation by mapping the entire data structure, regardless of its original length or complexity, into a compact, uniquely identifying fixed-length output. Therefore, the agent management platform can generate the same output for any two semantically equivalent inputs, yet yield distinctly different results for even minor changes within the original data.

In operation 1206, the agent management platform can transmit the unique fixed reference value to a multi-agent storage (e.g., storage structure such as a distributed ledger or blockchain). In some implementations, the storage structure is a distributed ledger. The verification record can be stored as a transaction on the distributed ledger. The multi-agent storage can include a memory structure accessible to multiple AI agents including the first AI agent and the second AI agent. The multi-agent storage can store the unique fixed reference value in association with an identifier, such as an identifier string (e.g., name or unique code), identifying the first AI agent. For example, before the transaction is transmitted, the agent management platform can digitally sign the transaction using a private cryptographic key of the submitting agent. The signed record can be broadcast to all nodes or participants in the storage structure, where the record can be checked and validated according to the agent management platform's rules for consensus. Once approved, the transaction can be permanently added to the storage structure.

In operation 1208, the agent management platform can obtain/receive, via the multi-agent storage, a verification artifact (e.g., compliance proof) from the second AI agent that indicates an observed value (e.g., a commitment value) generated by applying a second transformation operation set (e.g., a different hash/binding function such as a cryptographic hash function, a cryptographic commitment, or a zero-knowledge proof) on one or more portions of an internal operational dataset of the second AI agent corresponding to the one or more operative boundaries.

In some implementations, the second AI agent generates a transaction that includes the artifact (such as the hash or proof) and transmits the transaction to a blockchain or distributed ledger, where it is stored immutably and associated with the submitting second AI agent's unique identifier. In some implementations, the artifact is uploaded to a shared cloud repository or decentralized file system with an indexed reference stored on a ledger. The agent management platform can obtain the verification artifact by querying the multi-agent storage using the agent's identifier or other transaction metadata. The agent management platform can retrieve the artifact and/or associated metadata such as timestamps or digital signatures.

In operation 1210, the agent management platform can determine, using the first AI agent, a verification status (e.g., compliance status) of the verification artifact by comparing the unique fixed reference value generated by the first AI agent with the observed value indicated by the verification artifact. In some implementations, the verification artifact includes a zero-knowledge proof generated by the second AI agent. The zero-knowledge proof can indicate that the internal operational dataset satisfies the one or more operative boundaries defined by the machine-readable data structure. The verification status can be determined using the zero-knowledge proof. For sequential approvals, the verification artifact can be routed to a plurality of AI agents within the first AI agent set in a predetermined sequence. Each AI agent in the predetermined sequence can generate an agent-specific verification status indicating satisfaction of the verification artifact with the one or more operative boundaries.

For example, if both values are cryptographic hashes, the agent management platform performs a direct byte-to-byte equality check, where a match confirms that the second agent's internal dataset satisfies the operative boundaries, resulting in a positive compliance (or verification) status, while a mismatch triggers a noncompliance flag. In some implementations, such as when the verification artifact includes a ZK proof, the first AI agent can operate as a verifier by using the original reference value and the ZK proof to validate that the second agent's internal dataset meets essential boundaries without revealing the data itself using cryptographic operations (specific to a ZK protocol chosen, such as verifying elliptic curve pairings for zk-SNARKs or checking inner product equations for Bulletproofs). If the ZK proof is valid, the compliance status indicates that the second AI agent is verified. In some implementations, if the verification status indicates that the observed value satisfies the unique fixed reference value, the AI agents can share portions of data. For example, the agent management platform autonomously executes, using the first AI agent, one or more computer-implemented actions to transmit one or more portions of a respective internal operational dataset to the second AI agent. In some implementations, the agent management platform can automatically approve/verify, using the first AI agent, a transaction associated with the second AI agent in response to the reputation score exceeding a predetermined threshold.

To implement reputation-based scoring, the agent management platform can determine, using the first AI agent, a reputation score for the second AI agent based on a plurality of verification artifacts associated with the second AI agent. The reputation score can be determined by a weighted average of one or more verification statuses indicating satisfaction of a respective observed value with a respective unique fixed reference value, a decay value applied on one or more verification statuses based on a time since last failure of satisfaction of the respective observed value with the respective unique fixed reference value, a penalty value applied on one or more verification statuses indicating a failure of satisfaction of the respective observed value with the respective unique fixed reference value, and so forth. For example, historical verification statuses for previously evaluated verification artifacts of agents can be standardized into a score or flag, such as corresponding numerical representations (e.g., 1 for pass, 0 for fail). The agent management platform can apply a time-based decay such that older scores are discounted relative to more recent events by multiplying scores by a decay factor that decreases as the age of each event increases. Failures can cause the agent management platform to apply penalty adjustments by subtracting predefined amounts to reduce the overall score. The agent management platform can assign, using the first AI agent set, a reputation score for the second AI agent set based on a plurality of verification artifacts associated with a third AI agent set (e.g., a sub-agent) associated with a third entity using the same or similar methods described above with reference to determining the reputation score for the second AI agent.

In some implementations, the agent management platform can assign, by the first AI agent, a probationary status to the second AI agent in response to the reputation score being within a predetermined range. The agent management platform can remove the probationary status from the second AI agent in response to the reputation score exceeding the predetermined range for a predetermined time period. For example, the reputation score can be compared against lower and upper numeric bounds specifically designated for probation. If the score meets this conditional range, a “probationary” flag or marker can be programmatically added to the status metadata of the second agent within an agent directory or profile registry by updating a structured status field and/or triggering additional controls such as restricted permissions or increased monitoring. While in the probationary state, the agent management platform can continuously or periodically reevaluate the agent's reputation score at periodic intervals or upon event triggers (such as new verification artifacts). If the score rises above the probationary threshold and/or remains there for a defined observation period the probationary flag can be removed.

To implement voting when determining consensus between a plurality of agents, the agent management platform can determine, using each AI agent of the first AI agent set, an agent-specific verification status for a particular verification artifact. The agent management platform can determine the verification status (e.g., a “yes,” “no,” or a numerical confidence score) based on a number of respective agent-specific verification statuses indicating satisfaction of the second AI agent set with the one or more operative boundaries exceeding a predetermined threshold (for example, requiring a simple majority, supermajority, or a minimum reputation-weighted score).

In operation 1212, the agent management platform can autonomously generate a verification record (e.g., blockchain transaction) including a representation of the verification status for the verification artifact, a timestamp, a digital signature of the first AI agent, and/or an indication of the machine-readable data structure. In some implementations, the agent management platform transmits (e.g., via APIs or direct smart contract calls) the verification record to the multi-agent storage, wherein the verification record is stored in association with respective identifier strings identifying the first AI agent and the second AI agent. To notify an administrator/supervisor of noncompliance in cases where the verification status indicates that the observed value fails to satisfy the unique fixed reference value, the agent management platform can transmit, by the first AI agent, a notification message to a predetermined network address indicating the verification status for the verification artifact.

The agent management platform can generate, by the second AI agent, a second verification record including a representation of a second verification status for a third AI agent associated with a third entity. The agent management platform can store the second verification record in the multi-agent storage in association with respective identifier strings identifying the second AI agent and the third AI agent.

### Example Implementations of Generating and Executing Computer Programs Between Verified AI Agents

FIG. 13 illustrates an example environment 1300 of an agent management platform for automatically generating and executing computer programs using artificial intelligence (AI) models in accordance with some implementations of the present technology. Environment 1300 includes input 1302 to be input into the agents 1304 (e.g., a first agent 1304A, a second agent 1304B, a third agent 1304C), a smart contract 1306 generated by the agents 1304 using a data source 1308, and transactions 1310 to be stored on a blockchain 1312 that includes blocks 1314 (e.g., a first block 1314A, a second block 1314B, a third block 1314C, a fourth block 1314D, a fifth block 1314E). The agents 1304 are the same as or similar to the AI system 2300 illustrated and described in more detail with reference to FIG. 23. The environment 1300 can be implemented using components of example computer system 2400 illustrated and described in more detail with reference to FIG. 24. Likewise, implementations of example environment 1300 can include different and/or additional components or can be connected in different ways.

The input 1302 refers to user inputs, sensory data, structured data, unstructured data, and so forth, and can include a set of instructions to generate an output using the agents 1304. For instance, the input 1302 can include textual data, image data, audio data, video data, multi-modal data, and so forth. For instance, textual data can include documents, emails, chat messages, and/or logs. Image data can include photographs, diagrams, scanned documents, and/or other visual representations. In some implementations, multi-modal data combines two or more data types, such as annotated images, which might include both visual data and text data in the annotations, or videos with corresponding subtitles. In some implementations, the input 1302 includes a link (e.g., a URL) pointing to a knowledge base and/or a website.

The agents 1304 are autonomous (or semiautonomous) software and/or hardware entity that processes the input 1302 and generates a set of actions to fulfill the user's request. For example, a first agent 1304A can perform data cleaning, a second agent 1304B can perform feature extraction, and so forth. In some implementations, the agents 1304 are AI-based and use outputs from AI models (e.g., LLMs) and predefined objectives to autonomously generate and execute actions. The actions can be intended to fulfill specific tasks or requests made by the user, as well as other tasks or requests that are related to or associated with requests made by the user. In some implementations, actions can include tasks such as data retrieval, transaction processing, or system configuration changes. The predefined objectives of the agents 1304 are the specific goals or targets that the agents 1304 aim to achieve when generating the actions. The objectives can be set when constructing the agents 1304 or defined by the user through input parameters. In some implementations, predefined objectives are encoded within the architecture of the agents 1304. For example, when the agents 1304 adopt a neural network architecture, these objectives can weigh the activations of neurons within the network to influence the decision-making process. Certain neurons can be activated to prioritize actions that ensure compliance with specific guidelines or align with specific user preferences.

The agents 1304 can include a series of modules such as a natural language processing (NLP) module to interpret user inputs, a decision-making engine to determine the appropriate actions, and/or an execution module to carry out the actions on hardware or software assets. The agents 1304 can have access to various databases (e.g., knowledge bases) and APIs to retrieve particular information (e.g., domain-specific information, historical data, user preferences, and so forth). Additionally, the agents 1304 can operate in different modes, such as fully autonomous, semiautonomous with human oversight, or in collaboration with other agents. In fully autonomous mode, the agents 1304 can make decisions and execute actions without human intervention, relying entirely on the agents' 1304 programming and/or learned behaviors. Semiautonomous mode incorporates human oversight, allowing for manual review or approval of certain actions (e.g., in high-stakes or sensitive scenarios). The collaborative mode enables the agents 1304 to work in conjunction with other agents (i.e., different agents specializing in different tasks or domains to achieve more complex objectives). For example, the agents 1304 can be a specialized AI model designed for specific tasks, such as a virtual assistant, a chatbot, or an automation bot.

The agents 1304 can automatically generate and/or execute the smart contract 1306 based on the input 1302. The smart contract 1306 refers to a computational workflow (e.g., a series of computer-executable commands, a computer program, or a transaction protocol) that include rules, conditions, and/or execution logic governing the transformation of data within the agent management platform. A smart contract automatically executes, controls or documents events and actions according to the terms of the conditions. The smart contract 1306 can translate variable inputs 1302 into predetermined, executable commands that can subsequently be audited. The computational workflow includes instructions that dictate the operations to be performed, the order in which they should be executed, and the conditions under which certain actions should be triggered. For instance, the rules can specify that if a certain variable meets a particular threshold, a specific computational task will be initiated.

In some implementations, the data source 1308 injects additional context and parameters, in addition to the input 1302, used to generate the smart contract. The data source 1308 can include one or more database systems, external APIs, or real-time/near real-time data feeds to ensure that the smart contracts are according to the up-to-date data. The databases can be structured (e.g., SQL databases) or unstructured (e.g., NoSQL databases). For example, a database can store historical loan repayment data, which can be retrieved to assess a risk profile of a new loan application. External APIs can be used to fetch data from third-party services. These APIs can interface with various external systems to supply real-time or near-real-time data used for the operations of smart contracts. For example, real-time or near real-time data can be used if the conditions of a smart contract 1306 depend on live data. In some implementations, the data source 1308 can be managed by an agent. The agent can selectively transmit data to the agents 1304 to, for example, prevent the dissemination of personal data to certain agents 1304.

The transactions 1310 delineate one or more operations recorded as the smart contract 1306 executes its computational workflow. The transactions 1310 can indicate the occurrence of specific operations, such as data transformations, decision points, or events triggered within the smart contract 1306, that are determined, validated, and/or stored within the blockchain 1312. Each transaction can be associated with metadata that is stored along with the transaction on an immutable ledger such as the blockchain 1312. The metadata can include the timestamp of the transaction, which records the date and/or time the operation occurred, the parties involved in the transaction 1310, the nature of the operation (e.g., specific actions taken or conditions met), parameters or conditions that were applied during the operation, and so forth.

The blockchain 1312 can include a series of blocks 1314. Each block within blockchain 1312 can refer to a repository for one or more transactions 1310. Each block can be cryptographically linked to its predecessor to create a chain of transaction logs. Thus, any attempt to change the data within a block would require altering all subsequent blocks, making tampering computationally infeasible. Each block 1314 can include a block header and a block body. The block header includes metadata about the block 1314 itself, such as a unique identifier (hash) of the block 1314, the hash of the previous block 1314 in the chain, a timestamp providing the creation time of the block 1314, and/or a nonce (e.g., a number that increases sequentially in every attempt to generate a hash). The block body can include the transactions 1310 that have been validated and included in the block 1314. For example, users generate transactions broadcasted to the network. Network nodes (miners or validators) can verify transactions based on set rules and criteria. the validated transactions can be bundled into a new block by a miner or validator. The miner or validator can solve a cryptographic puzzle (proof of work) and/or demonstrate ownership (proof of stake) to add the block. Once verified, the new block can be added to the blockchain 1312, updating the chain across all nodes in the network.

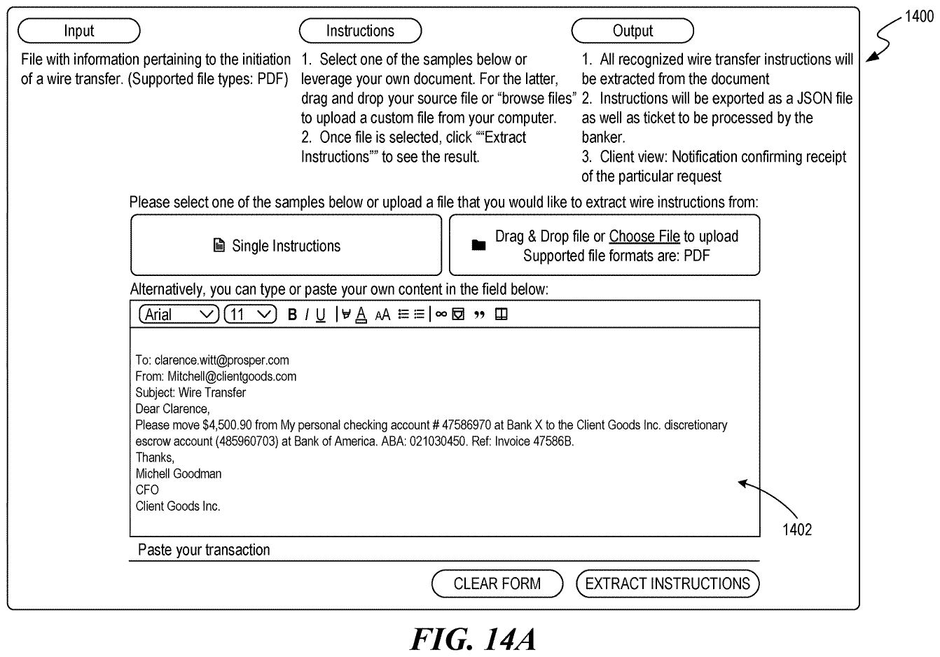

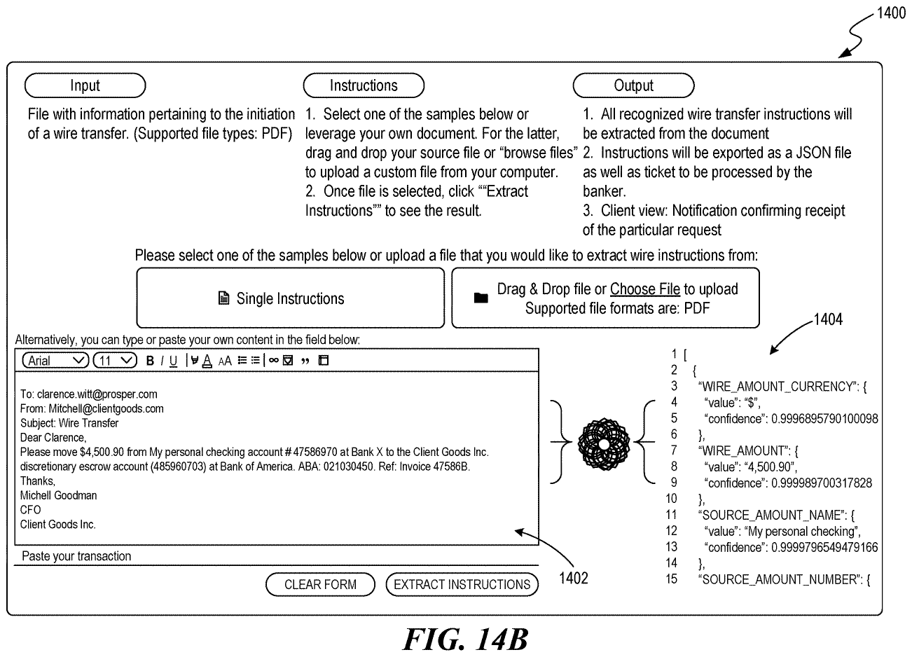

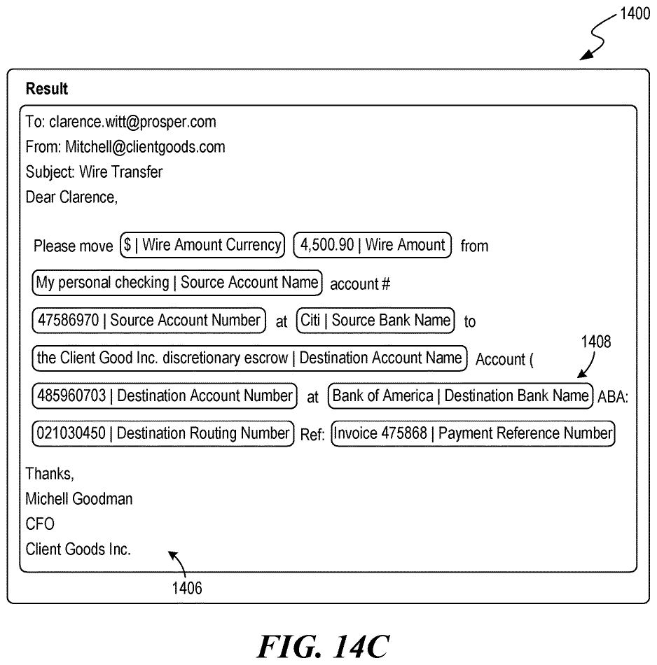

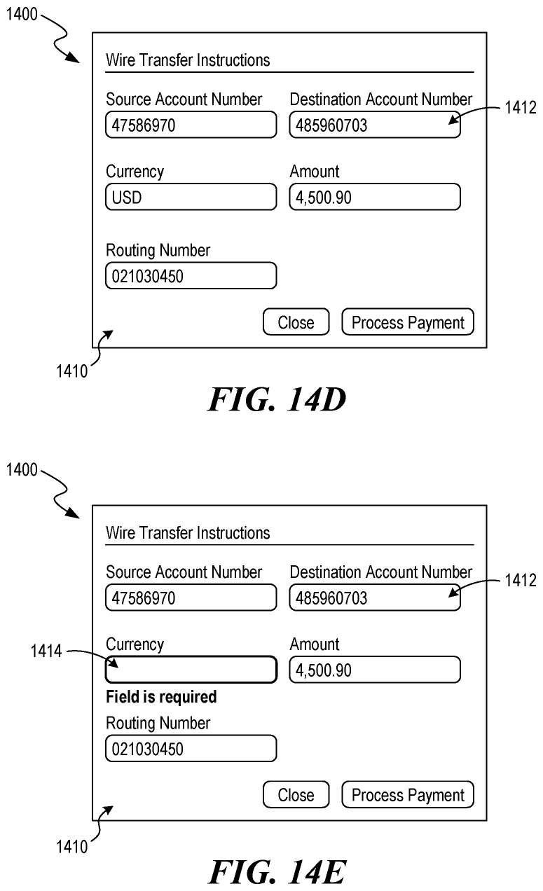

FIGS. 14A-14E illustrate screenshots of a user interface 1400 of the agent management platform. The user interface 1400 can be implemented using components of example computer system 2400 illustrated and described in more detail with reference to FIG. 24. Likewise, implementations of user interface 1400 can include different and/or additional components or can be connected in different ways. FIG. 14A is a screenshot of the user interface 1400 illustrating uploading unstructured data 1402 to an agent management platform in accordance with some implementations of the present technology. The user interface 1400 enables the user to interact with the agent management platform. In the depicted user interface 1400, unstructured data 1402 refers to any data that lacks a predefined data model or organization, such as plain text documents, images, emails, and PDFs. For example, the user can select or upload a file, which can be in formats such as PDF, Word documents, or other formats that do not follow a structured schema. Upon selection, the interface 1400 displays the chosen file to enable the user to review their input before proceeding. The sample wire transfer instruction email provided in FIG. 14A includes a request such as: “Please move $4,1900.90 from My personal savings account at ABCD Bank to my checking account at XYZ Bank, account number 0987654321, routing number 123457890.”

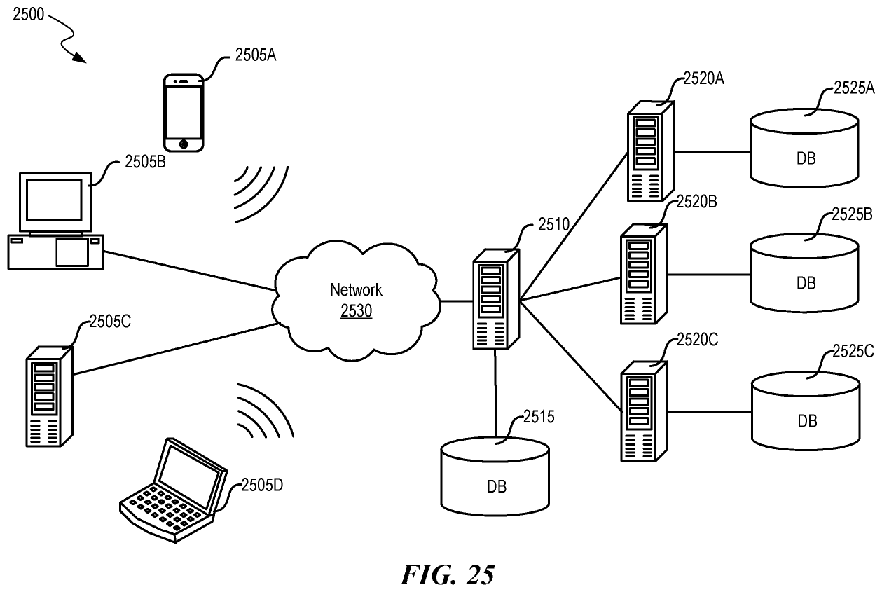

Upon receiving a user interaction (e.g., clicking the “Extract Instructions” button in FIG. 14A), the agent management platform identifies and extracts features such as wire transfer instructions, text segments, or other information in a structured format. FIG. 14B is a screenshot of the user interface 1400 displaying confidence scores 1404 of features extracted from the unstructured data 1402 that is generated using an agent management platform according to some implementations of the present technology. For example, the user interface 1400 in FIG. 14B illustrates several extracted features such as “WIRE_AMOUNT_CURRENCY,” “WIRE_AMOUNT,” and “SOURCE_AMOUNT_NAME,” along with their corresponding values and confidence scores 1404. The agent management platform generates confidence scores 1404 to indicate a level of certainty regarding the accuracy of the extracted data. The confidence scores 1404 can be numerical values that represent the likelihood that a particular extracted feature is accurate. For example, in FIG. 14B, the “WIRE_AMOUNT_CURRENCY” feature extracted from the unstructured data has a value of “$” with a confidence score of approximately 0.9997, and the “WIRE_AMOUNT” feature has a value of “4,1900.90” with a confidence score close to 0.99999. High confidence scores 1404 (e.g., confidence scores above a predefined threshold) can indicate that there is a high likelihood of the accuracy of the extracted values. Methods of generating the confidence scores 1404 are discussed in further detail with reference to FIG. 25. In some implementations, the user interface 1400 displays the scores alongside the extracted data.

FIG. 14C is a screenshot of the user interface 1400 displaying a result 1406 including the extracted features 1408 according to some implementations of the present technology. The user interface 1400 in FIG. 14C can display a structured output of the artifact (e.g., wire transfer request) generated by the agent management platform. In FIG. 14C, the extracted features 1408 can include portions of the instructions within the unstructured data 1402, such as “WIRE_AMOUNT_CURRENCY,” “WIRE_AMOUNT,” “SOURCE_ACCOUNT_NAME,” “SOURCE_ACCOUNT_NUMBER,” and so forth. The extracted features 1408 can include variables and corresponding values. For example, the extracted currency “$” indicates that the transaction involves United States Dollars. Similarly, “WIRE_AMOUNT” represents the specific amount to be transferred—in the case of FIG. 14C, “4,1900.90.” The result 1406 provides the extracted features 1408 in a structured manner.

FIG. 14D is a screenshot of an artifact 1410 generated by the agent management platform using complete unstructured data 1412 according to some implementations of the present technology. In FIG. 14D, the agent management platform has generated detailed wire transfer instructions, including the source account number, destination account number, currency type, amount to be transferred, and the routing number. In some implementations, the artifact 1410 can be generated by an AI-based agent that is different from the AI-based agent that extracted the features from the unstructured data 1402. The artifact 1410 refers to the structured output generated by the agent management platform from the complete unstructured data 1412. For example, the artifact 1410 displays wire transfer details extracted from the unstructured data, which includes: the source account number (47586970), the destination account number (485960703), the currency (USD), the amount (4,1900.90), and the routing number (021030450). The user interface 1400 can display the artifact 1410 and enable users to modify the artifact 1410 before executing the computational workflow indicated by the artifact (e.g., before submitting the wire transfer request). In some implementations, the agent management platform can use one or more AI models (e.g., an AI-based agent) to automatically execute the computer-executable commands associated with the artifact 1410 (e.g., automatically processing the wire transfer request).

Before automatically executing the computer-executable commands, the AI-based agent can first validate that the artifact 1410 created by, for example, a different AI-based agent, includes complete information (e.g., validating that the unstructured data 1402 is complete). In some implementations, when the unstructured data 1402 is incomplete, the agent management platform flags and/or alerts the user of the incomplete data. FIG. 14E is a screenshot of the artifact 1410 generated by the agent management platform using incomplete unstructured data 1414 according to some implementations of the present technology. The artifact 1410 displays wire transfer instructions including the source account number (47586970), destination account number (485960703), transfer amount (4,1900.90), and routing number (021030450). However, the currency type field is blank due to the incomplete unstructured data 1414.

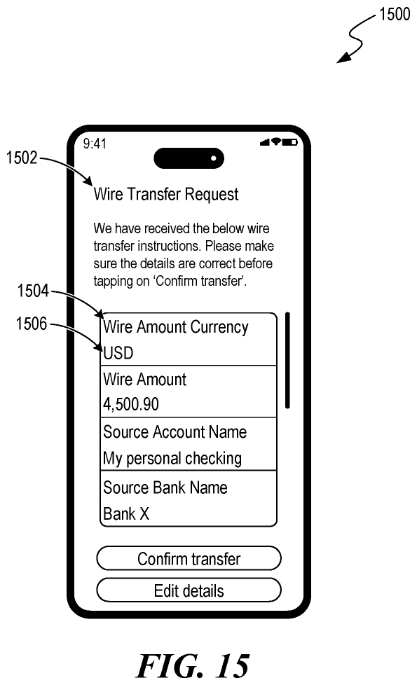

FIG. 15 is a screenshot 1500 displaying the artifact 1502 generated by the agent management platform on a user interface according to some implementations of the present technology. The artifact 1502 can include one or more variables 1504 and corresponding values 1506 extracted from the unstructured data. The screenshot 1500 can be implemented using components of example computer system 2400 illustrated and described in more detail with reference to FIG. 24. Likewise, implementations of the screenshot 1500 can include different and/or additional components or can be connected in different ways.

The screenshot 1500 displays the generated artifact 1502. The artifact 1502 can include the set of variables 1504. Variables 1504 represent the data fields extracted from the unstructured dataset. In the screenshot 1500, the variables 1504 include the currency, amount, source account name, source account number, destination account name, destination account number, and routing number. Each variable can correspond to information used to process the wire transfer. For instance, the variable indicating the currency is denoted as “USD,” specifies the currency in which the transfer is to be executed.

Corresponding values 1506 denote the specific data points associated with each variable 1504. Corresponding values 1506 can be extracted from the unstructured dataset and populated into their respective fields within the artifact 1502. For example, the currency variable holds the value “USD,” the transfer amount variable holds the value “4,1900.90,” the source account name holds the value “My personal checking,” and so forth. In some implementations, the agent management platform can display additional metadata such as the confidence reliability or historical usage patterns associated with the extracted variables 1504. Interactive buttons within the interface, such as “Close” and “Process Payment,” can enable users to trigger or modify the computational workflow. In some implementations, the agent management platform automatically triggers the computational workflow.

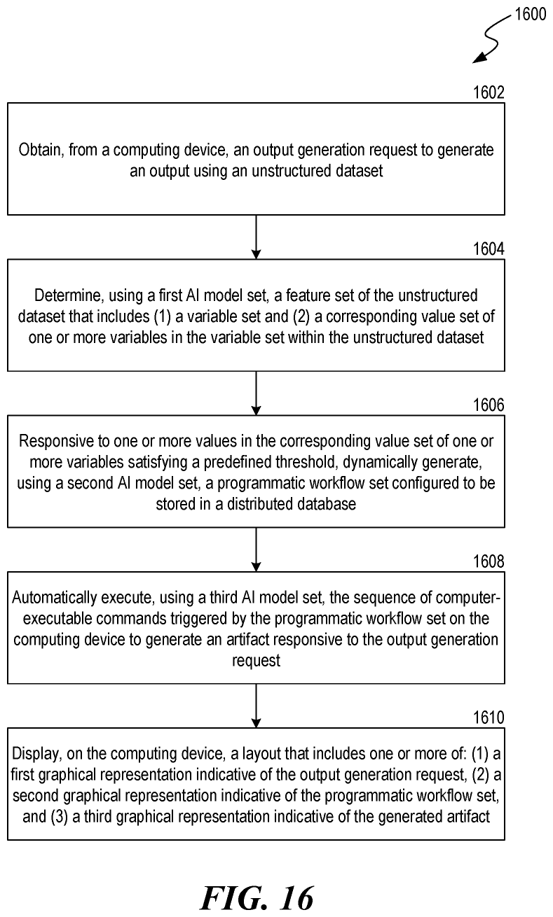

FIG. 16 is a flow diagram illustrating an example process 1600 of generating and executing computer programs using an agent management platform according to some implementations of the present technology. In some implementations, the process 1600 is performed by a computer system, e.g., example computer system 2400 illustrated and described in more detail with reference to FIG. 24. Implementations can include different and/or additional operations or can perform the operations in different orders.

In operation 1602, the agent management platform obtains (e.g., receives from a graphical user interface (GUI) of a computing device) an output generation request (e.g., a wire request) to generate an output using an unstructured dataset. The requested output can satisfy a guideline set defining an operative boundary set of the output generation request. In some implementations, the agent management platform establishes a communication channel with the GUI of the computing device. For example, the GUI can transmit a request to the agent management platform's server endpoint. The request can include metadata defining the output generation request, such as the type of output required, specific parameters, and/or the dataset to be used.

In operation 1604, the agent management platform determines, using a first AI model set, a feature set of the unstructured dataset that includes a variable set and/or a corresponding value set of each variable in the variable set within the unstructured dataset. For text data, the agent management platform can tokenize the text into words or subwords, and convert these tokens into numerical representations using methods such as word embeddings (e.g., Word2Vec, GloVe) or contextual embeddings (e.g., BERT embeddings). The first AI model set can identify variables such as named entities, parts of speech, and/or syntactic dependencies, and assign corresponding values to the variables based on the context within the text. For example, the agent management platform can identify features (e.g., variables) such as named entities (e.g., people, organizations, locations), parts of speech (e.g., nouns, verbs, adjectives), and syntactic dependencies (e.g., subject, object relationships). For instance, in the sentence “The quick brown fox jumps over the lazy dog,” the model identifies “fox” and “dog” as nouns, “jumps” as a verb, and “quick” and “lazy” as adjectives.

For image data, the AI model set can use a model such as a CNN to identify features including edges, textures, shapes, and/or higher-level patterns. The model can identify variables and assign corresponding values to these variables based on the detected features within the images. For instance, in an image of a cat, the model can first detect edges that form the outline of the cat, and then identify textures such as fur, and subsequently identify the overall shape and specific features such as eyes and ears. The model can assign variables such as object classes (e.g., cat, dog), bounding box coordinates (e.g., the position of the cat in the image), and pixel intensities (e.g., color values).

For audio data, the AI model set can convert the raw audio signals into spectrograms or other time-frequency representations. The model can extract features such as pitch (frequency of the sound), timbre (quality of the sound), and/or rhythm (timing patterns). For example, in a piece of music, the model can identify the pitch of each note, the sound characteristics of different instruments, and so forth. Variables such as frequency bands (e.g., low, mid, high frequencies), amplitude levels (e.g., loudness), and temporal patterns (e.g., beats per minute) can be identified and assigned corresponding values.

The agent management platform can generate confidence scores for each feature of the feature set and compare the confidence score to a particular threshold. Each feature included in the feature set can satisfy the particular threshold. In some implementations, confidence scores can be generated (e.g., agents 1304) based on a chatter index, or an indication of the amount of time agent spent communicating with another system. For text data, the agent management platform can use NLP models to assign confidence scores to features such as named entities, parts of speech, and/or syntactic dependencies. For example, if the model identifies “New York” as a location in a sentence, the model generates a confidence score indicating how certain it is that “New York” is a location. The confidence score can be based on the context in which the term appears and calculated by converting the model's raw output into a probabilities that sum to one. The resulting probability for each term indicates the model's confidence in its prediction, with higher probabilities reflecting greater confidence.

For image data, CNNs can be used to assign confidence scores to features such as object classes, bounding box coordinates, and/or pixel intensities. For instance, if the model detects a cat in an image, the model generates a confidence score reflecting the likelihood that the detected object is a cat. The confidence score can be derived from the activation levels of the neurons in the final layers of the CNN, which indicate the model's certainty about the classification. The confidence score can be typically a value between 0 and 1, where higher values indicate greater confidence. For audio data, the agent management platform can use spectrograms to assign confidence scores to features such as pitch, timbre, and/pr rhythm. For example, if the model identifies a specific musical note, the model generates a confidence score indicating how certain it is about the note's pitch. The confidence score can be calculated based on the probability of the feature given the observed data.

Once the confidence scores are generated, the agent management platform can compare each score to a predefined threshold. This threshold can be set based on the desired level of certainty for the features to be considered valid. The agent management platform can iterate through each feature and its corresponding confidence score, checking if the score meets or exceeds the threshold.

Responsive to one or more values in the corresponding value set of each variable satisfying a predefined threshold, in operation 1606, the agent management platform dynamically generates, using a second AI model set (same as or different from the first AI model set), a programmatic workflow set (e.g., a smart contract) configured to be stored in a distributed database (e.g., a blockchain network) by mapping a vector representation of each feature of the feature set to an antecedent set (e.g., conditional statements) representative of the feature, a corresponding programmatic workflow of the programmatic workflow set satisfying the operative boundary set of the guideline set, and/or one or more nodes of the distributed database (e.g., blocks on a blockchain network). For example, the agent management platform can determine that if a loanable value within the output generation request is greater than $10 million, the agent management platform automatically generates additional smart contract code to be executed on the computing device.

The antecedent set can include conditional statements that represent the logical conditions and rules associated with each feature. For example, if the feature is a loanable value, the antecedent set can include conditions such as “if loanable value >$10 million.” The agent management platform can use these conditional statements to construct the programmatic workflow. The programmatic workflow can be a sequence of programmatic instructions or code that defines the actions to be taken based on the conditions specified in the antecedent set. In the case of a smart contract, the programmatic workflow can include the logic and rules that govern the execution of the contract. For example, the programmatic workflow can specify that if the loanable value exceeds $10 million, additional clauses or conditions are added to the smart contract.

To ensure that the generated programmatic workflow satisfies the operative boundary set of the guideline set, the agent management platform can cross-reference the workflow with the predefined guidelines. Once the programmatic workflow is generated and validated, the agent management platform can store the programmatic workflow in a distributed database, such as a blockchain network. In some implementations, the corresponding programmatic workflow triggers a sequence of computer-executable commands responsive to satisfying the antecedent set. For example, if the agent management platform determines that a loanable value within the output generation request is greater than $10 million, the agent management platform automatically generates additional smart contract code to handle this condition. This code is stored on the blockchain, where it can be executed by the computing device when the specified conditions are met.

Each node of the one or more nodes can be assigned a unique cryptographic hash by applying a particular hash function on the node. The one or more nodes can each be linked to a corresponding unique cryptographic hash of a different node in the distributed database. The hash function uses the data contained within the node as input to generate a fixed-size string of characters, which is the cryptographic hash. This hash uniquely represents the data in the node, ensuring that changes in the node's data results in a different hash. The agent management platform applies the hash function to the data of each node. The agent management platform links each node to a corresponding unique cryptographic hash of a different node in the distributed database. For example, the agent management platform can link the hash of the previous node in the data of the current node before applying the hash function. For instance, if Node A is followed by Node B, the data of Node B can include the hash of Node A. When the hash function is applied to Node B, it generates a hash that includes the hash of Node A, creating a cryptographic link between the two nodes. Thus, if any data in a node is altered, the hash of that node will change, which will also affect the hashes of all subsequent nodes.

To generate the smart contract based on previous similar contracts, in some implementations, the agent management platform generates a similarity score between the feature set and a plurality of historical feature sets by determining a degree of similarity between vector representations of one or more features within the feature set with vector representations of one or more historical features of the historical feature set. Similarity measures can include cosine similarity, Euclidean distance, or other metrics that quantify how close the vectors are to each other in the high-dimensional space. For example, cosine similarity measures the cosine of the angle between two vectors, with values closer to 1 indicating higher similarity. The agent management platform can generate the programmatic workflow set using a historical programmatic workflow set associated with a historical feature set that has a highest similarity score with the feature set.

In operation 1608, the agent management platform automatically executes, using a third AI model set (same as or different from the first and second AI model sets), the sequence of computer-executable commands triggered by the programmatic workflow set on the computing device to generate an artifact (e.g., a wire transfer ticket) responsive to the output generation request. Each command can be processed in order. As the agent management platform executes each command, the agent management platform can dynamically update the state of the computing device and the data being used.

In operation 1610, the agent management platform displays, on the GUI of the computing device, a graphical layout that includes a first graphical representation indicative of the output generation request, a second graphical representation indicative of the programmatic workflow set, and/or a third graphical representation indicative of the generated artifact. The first, second, and/or third graphical representation can include a preview of the content, such as an embedded PDF viewer, a link, or an image viewer, or can include the entirety of the content.

To keep track of who accessed which data and/or executed which contracts, in some implementations, the agent management platform, responsive to the execution of the sequence of the computer-executable commands, stores an indication of the execution in the distributed database. The indication can be linked to the one or more nodes of the distributed database. The agent management platform can capture information associated with execution (e.g., execution metadata) of the computer-executable commands, such as the identity of the user or system that initiated the execution, the specific commands that were executed, the time and date of execution, data used by the commands, and so forth. Once the execution metadata is collected, the agent management platform can format the metadata into a structured record such as one that includes fields for the information, such as user ID, command details, timestamp, and so forth. The agent management platform can generate a unique identifier for the execution record. The identifier can be a cryptographic hash to ensure the immutability of the execution record, as changes to the metadata would result in a different hash.

The agent management platform can create a new node in the distributed database to store the execution record. The node can include the execution metadata and the generated hash value. The node can be linked to the relevant nodes in the distributed database, such as the nodes representing the data accessed or the contracts executed, by including references to the unique cryptographic hashes of the related nodes within the new node. To store the new node in the distributed database, the agent management platform can initiate a transaction on the blockchain network.

To maintain auditability, in some implementations, each programmatic workflow of the programmatic workflow set is associated with an explanation associated with the antecedent set and/or the sequence of computer-executable commands, a timestamp, and/or a version identifier. The explanation associated with the antecedent set and the sequence of computer-executable commands can be a human-readable description of the logic and conditions associated with the programmatic workflow. For example, if the workflow includes a conditional statement such as “if loanable value >$10 million,” the explanation can describe the condition and/or its corresponding consequent. The explanations can be stored as text strings and can be included in the metadata for each workflow.

The agent management platform can record a timestamp for each workflow using the system clock and include the timestamp in the metadata to provide a chronological record of the workflow's history. The agent management platform can assign, in some implementations, a version identifier to each workflow. This identifier can be a unique string or number that distinguishes different versions of the workflow. Each time the workflow is updated or modified, the agent management platform can increment or otherwise modify the version identifier to reflect the changes. The version identifier enables users and auditors to track the evolution of the workflow over time and to reference specific versions when needed. Once the metadata is generated, the agent management platform can associate it with the corresponding programmatic workflow in the structured record. The agent management platform can store the metadata record alongside the workflow in the distributed database.

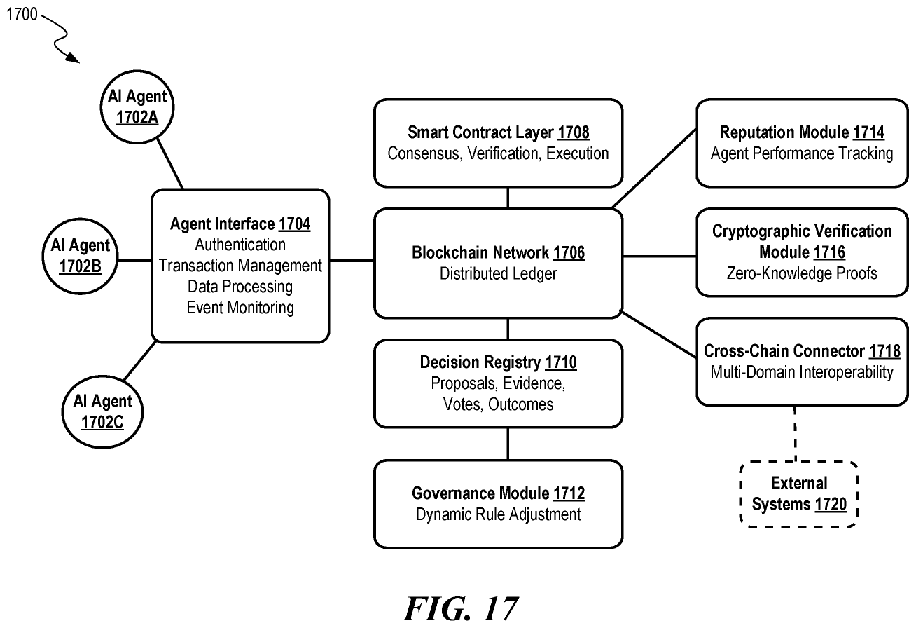

FIG. 17 illustrates an example environment 1700 of blockchain-based decision making for AI agent(s) using the agent management platform in accordance with some implementations of the present technology. Environment 1700 includes AI agents 1702, an agent interface 1704, a blockchain network 1706, a smart contract layer 1708, a decision registry 1710, a governance module 1712, a reputation module 1714, a cryptographic verification module 1716, a cross-chain connector 1718, and external systems 1720. The AI agents 1702 are the same as or similar to the AI system 2300 illustrated and described in more detail with reference to FIG. 23. The environment 1700 can be implemented using components of example computer system 2400 illustrated and described in more detail with reference to FIG. 24. Likewise, implementations of example environment 1700 can include different and/or additional components or can be connected in different ways.

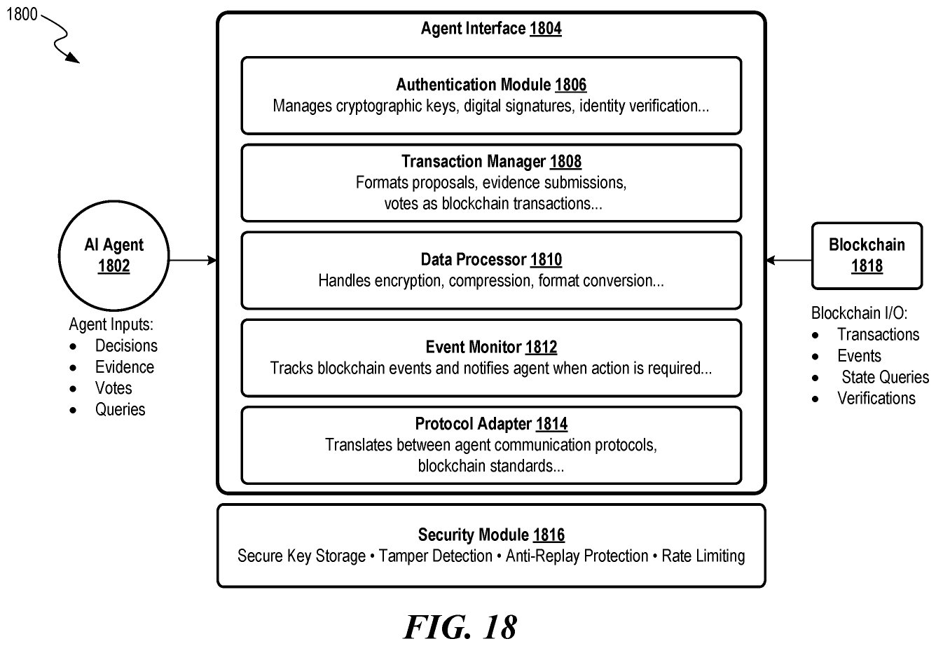

The environment 1700 includes multiple AI agents 1702, such as a first AI agent 1702A, a second AI agent 1702B, a third AI agent 1702C, and so forth. These AI agents 1702 can be specialized for different tasks or domains (i.e., trained on domain-specific data). The AI agents 1702 interact with the system through an agent interface 1704, which provides a standardized communication protocol to manage the agents'interactions with other components of the agent management platform. The agent interface 1704 can include modules to perform, for example, authentication, transaction formatting, data encryption/decryption, and/or communication with other system components. Examples and methods of operating the agent interface 1704 are further discussed with reference to FIG. 18 below.

The blockchain network 1706 refers to a distributed and immutable ledger for recording transactions and decisions. The blockchain network 1706 can use consensus mechanisms such as multiple rounds of communication between nodes to validate transactions, propose new blocks, and/or reach agreement on the state of the ledger. By ensuring that all participating nodes agree on the state of the blockchain, the agent management platform can provide a reliable and tamper-resistant foundation for recording and executing decisions made by the AI agents. In some implementations, the blockchain network 1706 can be implemented as a private, permissioned network to control access and refine the management of AI agent interactions. The smart contract layer 1708 is communicatively connected to the blockchain network 1706, and can include pre-programmed rules and conditions that govern the execution of transactions. The smart contract layer 1708 can include consensus protocols that define voting mechanisms and/or thresholds for different decision types, verification contracts that validate agent credentials and/or contributions, execution contracts that trigger actions based on decision outcomes, and so forth.

Records of decisions made by the AI agents, including proposals, evidence, votes, and/or outcomes can be stored and/or managed by the decision registry 1710. The decision registry 1710, for example, can be structured as a structured database within the blockchain. The governance module 1712 can be used to enforce rules and policies within the agent management platform. In some implementations the governance module 1712 is enabled to dynamically adjust parameters of one or more rules (e.g., smart contracts) based on predefined criteria or collective decisions by the AI agents 1702. To provide reliability and effectiveness of the AI agents, the reputation module 1714 is enabled to track and evaluate the performance and/or assign a degree of reliability to individual AI agents 1702 based on, for example, previous actions and decisions. The reputation scores maintained by the reputation module 1714 can influence the weight given to each agent's input in collective decision-making processes.

To ensure the security of the agent management platform, the cryptographic verification module 1716 can perform one or more cryptographic techniques such as zero-knowledge proofs to verify transactions, agent reasoning, and/or decisions without revealing sensitive information. To facilitate interoperability with other blockchain networks or external systems, the cross-chain connector 1718 enables the exchange of data and execution of transactions across different blockchain networks to expand the capabilities of the agent management platform. The cross-chain connector 1718 can enable interoperability with other blockchain networks for decisions that span multiple domains. The cross-chain connector 1718 can interface with external systems 1720 to enable the integration of external data sources, services, or applications into the decision-making process.

FIG. 18 illustrates an example environment 1800 of an interface of an AI agent used within an agent management platform in accordance with some implementations of the present technology. Environment 1800 includes an AI agent 1802 (e.g., the AI agents 1702 in FIG. 17) and an agent interface 1804 (e.g., the agent interface 1704 in FIG. 17) that includes an authentication module 1806, a transaction manager 1808, a data processor 1810, an event monitor 1812, and a protocol adapter 1814. The environment 1800 further includes a security module 1816 and a blockchain 1818. The AI agent 1802 are the same as or similar to the AI system 2300 illustrated and described in more detail with reference to FIG. 23. The environment 1800 can be implemented using components of example computer system 2400 illustrated and described in more detail with reference to FIG. 24. Likewise, implementations of example environment 1800 can include different and/or additional components or can be connected in different ways.

The AI agent 1802 interacts with the blockchain network through the agent interface 1804. When the AI agent 1802 generates a decision, evidence, action, vote, query, and so forth (e.g., based on the agent's internal algorithms, which can include machine learning models, rule-based systems, or other decision-making mechanisms), it can trigger a series of processes within the agent interface 1804 to interact with the blockchain 1818 (e.g., transactions, events, state queries, verifications, and so forth). Within the agent interface 1804, the authentication module 1806 can verify the AI agent's identity and permissions within the agent management platform. The authentication module 1806 can use one or more cryptographic techniques such as digital signatures or multi-factor authentication to ensure that only authorized agents are enabled to participate in the decision-making process. For example, the agent management platform can generate a digital signature using the agent's private key, which can be verified by other participants in the network. In another example, the agent management platform can validate the agent's current status and permissions against a predefined set of criteria implemented on the blockchain.

Once authenticated, the transaction manager 1808 formats the decision or action into a blockchain transaction. The transaction manager 1808 can structure the data according to the specific criteria of the blockchain protocol, such as including metadata, timestamps, and transaction identifiers. In some implementations, the transaction manager 1808 can sequence and prioritize transactions within the blockchain 1818. The data processor 1810 can be used to encrypt, compress, and/or otherwise format the conversion of data exchanged between the AI agent 1802 and the blockchain 1818. In some implementations, the data processor 1810 can use advanced techniques such as zero-knowledge proofs to enable verification of certain properties of the data without revealing the data itself. Throughout the operation of the agent management platform, the event monitor 1812 can track events occurring on the blockchain 1818. The event monitor 1812 can filter blockchain 1818 events and notify the AI agent when action is required or when relevant information becomes available.

The protocol adapter 1814 can be used as a translation layer between the communication protocols used by the AI agent and those used by the blockchain network. The protocol adapter 1814 enables interoperability between different AI systems and blockchain platforms. For example, the protocol adapter 1814 can translate between different data serialization formats, adjust byte orders, or implement any blockchain-specific cryptographic operations used for transaction submission. Before the transaction is submitted to the blockchain 1818, the security module 1816 can apply one or more security measures such as performing an encryption of the transaction payload, implementing anti-replay protection by including nonces or timestamps, applying rate limiting to prevent potential denial-of-service attacks on the blockchain network, and so forth.

### Example Implementations of Verifying AI Agents Based on Resource Availability

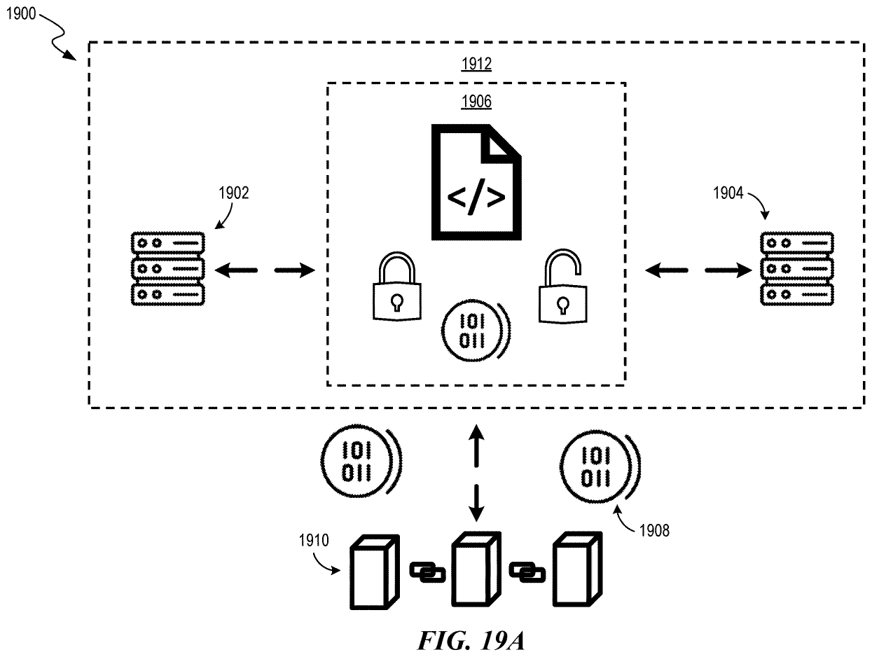

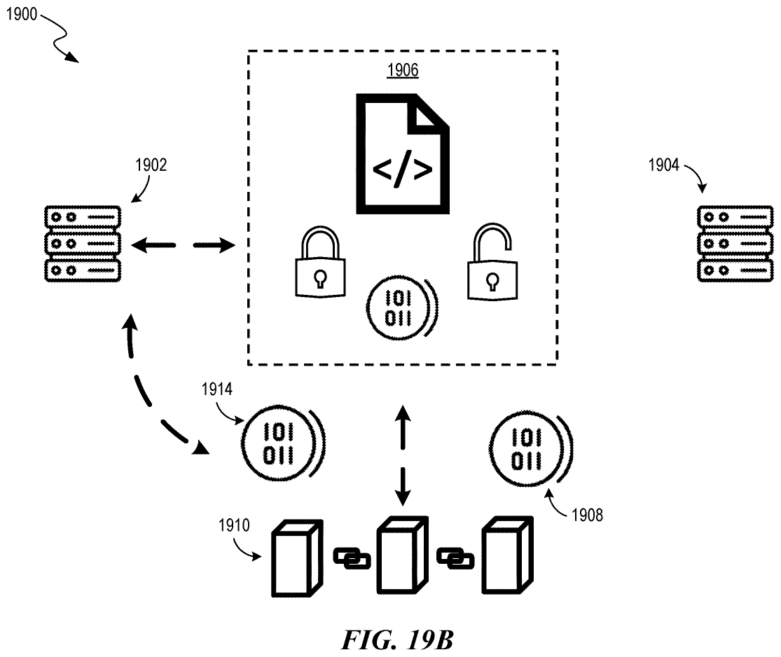

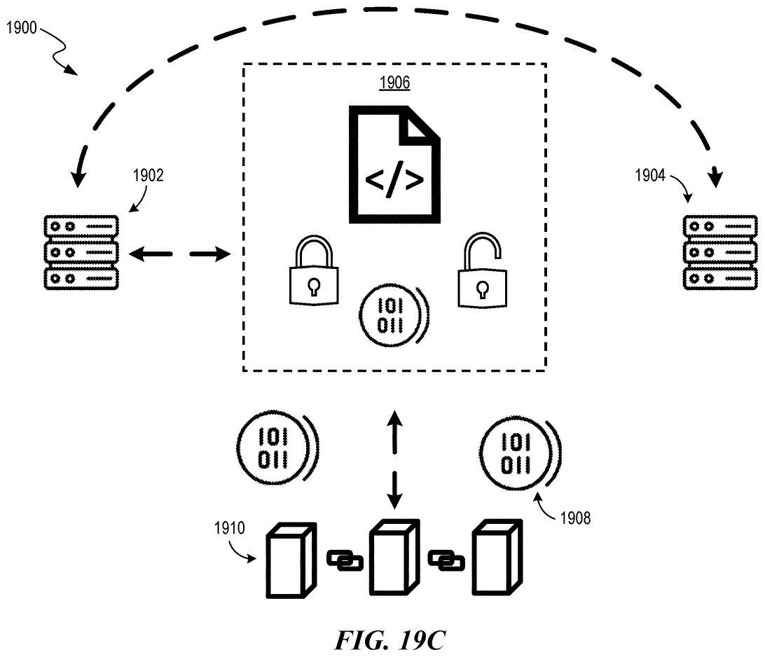

FIGS. 19A-19C show an illustrative diagram for managing resources, in accordance with one or more implementations. FIG. 19A shows an illustrative architecture for managing resources across global or cloud networks, in accordance with one or more implementations. For example, system 1900 includes a network between two resources (e.g., resource 1902 and resource 1904). As described herein, a resource can refer to any entity or component within the network that is made available and accessible for use by network users, applications, or devices. These resources can be hardware devices, software applications, or data that are shared across the network for various purposes. Hardware devices can include physical devices connected to the network that can be shared among multiple users or applications. Examples of hardware resources in a network include printers, scanners, servers, routers, switches, storage devices (like NAS Network Attached Storage), and other peripheral devices. Software resources can be software applications, programs, or services made available for access and utilization over the network. This could include shared databases, file servers, web servers, email servers, application servers, and any other software-based services accessible to network users. Data resources refer to information or data stored and shared within the network. This could include shared files, documents, databases, multimedia content, and any other data that can be accessed and utilized by authorized users or applications within the network. Network resources are typically made accessible through a process called resource sharing or resource sharing protocols, which allow authorized users or devices to access, use, or modify these resources based on permissions and security configurations set by the network administrators. For instance, in a client-server network model, a server could host resources such as files or applications, and client devices can request access to these resources over the network. Access control mechanisms, such as user authentication and permissions, regulate who can access specific resources and what actions they can perform on those resources.

In some implementations, resources can encompass a wide array of assets, tools, and components that are essential for conducting operations, delivering services, managing finances, and supporting a financial service firm's overall functioning. For example, a resource can include financial assets. Financial assets include cash reserves, investments, securities, loans, and other financial instruments held by the firm or managed on behalf of clients. For example, a resource corresponding to a user can include a bank account for that user.

In some implementations, a resource can include a bank branch or other subdivision of the firm and/or an amount of liquidity for the bank branch or subdivision. For example, when a resource is a bank branch or other subdivision, the resource can go on and/or off-line based on the operating hours (or regulated trading hours) for the bank branch or subdivision. For example, banks and financial institutions often have specific business hours during which their systems and staff are available to process transactions. Outside these hours, certain banking functions, including fund transfers, can not be processed immediately. Some financial regulations or rules can limit or dictate the processing of certain types of transactions or transfers after regular business hours for security, compliance, or fraud prevention purposes. Banks can also risk management measures in place to detect and prevent fraudulent activities. Transactions initiated after hours can be flagged for additional scrutiny to ensure they are legitimate, which could cause delays.

In some implementations, system 1900 can illustrate one or more communications between resource 1902 and resource 1904 as managed by a platform application. For example, a platform application can be used to facilitate one or more blockchain actions (e.g., via self-executing program 1906) to conduct the communications across computer network 1912. In some implementations, blockchain actions can also include actions related to a self-executing program (e.g., a smart contract). As referred to herein, a “self-executing program” includes a program in which rules for execution are written into lines of code. The code and the rules contained therein can then exist across a distributed, decentralized blockchain network. For example, a self-executing program can include a contract in which the terms of the agreement between buyer and seller are written into lines of code. In some implementations, the self-executing program can be a program in which rules for execution are written into lines of code that is executed in response to a trigger.

As referred to herein, a computer network can refer to a collection of interconnected computers and other devices that are linked together to share resources, information, and services. These networks can be established using various technologies and configurations, allowing devices to communicate and exchange data with each other. In some implementations, the computer network can comprise a network for a financial services firm.

In some implementations, a computer network (or simply network) can refer to the interconnected system of computers, devices, and infrastructure specifically designed and configured to support the operations and services provided by a financial service firm and/or the financial industry. The network infrastructure can enable the firm to process transactions efficiently and securely. This includes services like online banking, wire transfers, trading platforms for stocks and securities, electronic fund transfers, and other financial transactions. For example, financial firms often require connectivity to various financial markets, exchanges, and data providers. The network infrastructure allows access to real-time market data, trade execution platforms, and connections to external financial systems.

In some implementations, the computer network can comprise a global payment network that facilitate credit and debit card transactions. The network can connect issuing banks, acquiring banks, merchants, and cardholders, enabling electronic payments at point-of-sale terminals and online. In some implementations, the computer network can comprise an ACH (Automated Clearing House). An ACH is a network used for electronic fund transfers and direct deposits in the United States. It enables the processing of large volumes of credit and debit transactions, including payroll deposits, bill payments, and person-to-person transfers. In some implementations, the computer network can comprise a SWIFT (Society for Worldwide Interbank Financial Telecommunication) network. SWIFT is a global messaging network used by financial institutions for secure communication and the transfer of financial messages, particularly for international transactions and cross-border payments. In some implementations, the computer network can comprise a blockchain network.

As described herein, a “platform application” can refer to software or an application that serves as a foundation or infrastructure for developing and deploying other software applications or services. It provides a set of tools, frameworks, and functionalities upon which developers can build, integrate, and run applications. These platforms form the basis for running other software applications. Examples include Windows, macOS, Linux, iOS, and Android. They provide the necessary environment and services for software to execute on devices like computers, smartphones, and tablets.

In some implementations, the platform application can be used to manage the availability of devices in a computer network (e.g., a “platform management application”). This type of platform application is designed to monitor, control, and manage various devices and components within a network to ensure their availability, performance, and security. The platform application can automatically identify and map devices present on the network, including computers, routers, switches, servers, printers, and other network-connected devices. The platform application can constantly monitor the status and performance metrics (such as bandwidth usage, CPU usage, memory, etc.) of network devices to identify any abnormalities or performance bottlenecks. The platform application can generate alerts or notifications when certain predefined thresholds are breached or when anomalies in network behavior are detected. This helps in proactive issue resolution and prevents network downtime. The platform application can allow administrators to centrally manage and update device configurations, ensuring consistency and compliance with network policies and standards. The platform application can monitor the network for security threats, unauthorized access attempts, malware, and other vulnerabilities, providing insights into potential security breaches.

In some implementations, the platform application can comprise a platform application for a financial services firm. A platform application, in the context of a financial services firm or a global bank, typically refers to a software application or system that serves as a foundation or framework for delivering various financial services, managing transactions, facilitating communication, and supporting interactions between different entities within the firm or with external stakeholders such as clients, partners, or regulatory bodies. These platform applications can be designed to integrate multiple functionalities and services within a unified infrastructure. These functionalities and services can encompass various aspects such as banking operations (e.g., day-to-day banking operations including customer onboarding, account management, transaction processing, and compliance), trading (e.g., trading functionalities for various financial instruments like stocks, bonds, derivatives, and currencies), risk management (e.g., risk assessment and management tools to monitor and mitigate risks across different financial activities), Customer Relationship Management (CRM) (e.g., functionalities that manage client interactions, track customer preferences, and personalize services), data analytics and reporting (e.g., capabilities that derive insights from large volumes of financial data), compliance and regulatory requirements (e.g., features to ensure compliance with various financial regulations and standards), mobile and online banking (e.g., mobile applications and online banking portals).

In some implementations, the system receives the first request can comprise receiving, at a platform management application, a user request to perform a first off-chain action. The system can then determine that the first blockchain action corresponds to first off-chain action. For example, a user can initiate a request for a specific action that needs to be performed off-chain. This request could come through a user interface, API call, or any other user interaction method supported by the platform. The user request is received by the system and routed to a platform management application that serves as the central control or coordination point for managing various actions within the system. The platform management application analyzes the received user request and identifies the nature of the action requested. It parses and understands the details of the requested off-chain action, such as its purpose, parameters, and requirements. The system, through its logic or predefined mapping rules, identifies that the requested off-chain action has a corresponding action or operation that needs to be executed on the blockchain. This mapping could be based on predetermined correlations between off-chain and on-chain actions within the system's architecture or business logic.

The platform management application can validate the user request, ensuring it meets necessary criteria, security checks, and any required authorizations before proceeding further. Upon recognizing the corresponding blockchain action linked to the off-chain request, the system prepares the necessary data, parameters, or transaction details (e.g., other resources involved in the blockchain action) required to execute the corresponding action on the blockchain. For example, the system can receive a first user request to perform a first off-chain action determining that the first blockchain action corresponds to a second resource (e.g., a transaction from a first resource to a second resource).

Using appropriate mechanisms or interfaces (e.g., one or more self-executing programs, APIs, etc.), the platform management application triggers the execution of the determined blockchain action that aligns with the requested off-chain action. The prepared blockchain action is broadcasted to the blockchain network, initiating the process of validating, processing, and confirming the action by network nodes or validators. Validators in the blockchain network process the transaction, execute the action according to the defined logic, and include the validated transaction in a block. Once confirmed and added to the blockchain, the action is considered completed on-chain. The platform management application updates the status of the user request, providing feedback or notifications to the user about the successful execution of the requested action, whether it is off-chain or on-chain.

System 1900 (e.g., using a platform application) can facilitate the performance of an off-chain action. As described herein, an “off-chain action” can refer to any activity or transaction that occurs outside the underlying blockchain network or protocol. Off-chain actions can take various forms, including off-chain transactions. These are transactions that occur outside the main blockchain network. They are conducted through secondary layers or channels and are settled or reconciled on-chain later. This helps in reducing congestion on the main chain and lowering transaction fees. Off-chain actions can also comprise off-chain computations. For example, complex computations or operations that are computationally expensive can be performed off-chain. For instance, certain computations or processes needed to support a decentralized application (DApp) might be handled off-chain to improve performance and reduce latency, with only the final outcome or necessary data being recorded on the blockchain.

For example, in the context of blockchain technology, on-chain data and assets are those that are recorded and stored directly on the blockchain. In contrast, off-chain data or assets are not directly stored on the blockchain but are instead managed off the blockchain. For example, off-chain data can be information that is not stored on the blockchain but is referenced or linked to it. This could include data stored in traditional databases, external files, or other systems. Off-chain assets can be assets that are represented or exist in the physical world or in other systems, but their ownership or status is tracked and managed on the blockchain. This could include real-world assets like real estate, commodities, or even digital assets that are not stored directly on the blockchain.

In some implementations, off-chain actions can also comprise state channels, rollups, and/or sidechains. For example, these are off-chain scaling solutions that enable parties to conduct transactions or execute self-executing programs off the main chain. State channels allow participants to interact directly with each other off-chain, updating the state between them, while sidechains are separate blockchains that can be connected to the main blockchain, facilitating faster and more scalable transactions. In the context of blockchain and cryptocurrency, a “rollup” can be a layer 2 scaling solution. It is designed to improve the efficiency and scalability of blockchain networks. Rollups work by processing and bundling multiple transactions off-chain, and then submitting a single transaction to the main blockchain. This helps reduce congestion and lower transaction costs.

In some implementations, off-chain actions can also comprise usage of off-chain data storage. For example, storing large amounts of data directly on a blockchain can be inefficient and costly. Off-chain data storage solutions, such as decentralized storage networks (e.g., IPFS, Filecoin), enable the storage of data off-chain while maintaining references or proofs of the data's existence or integrity on the blockchain.

In some implementations, an off-chain action (or result thereof) can refer to any data, information, or transactional details that are stored, processed, or maintained outside of the primary blockchain network. In blockchain technology, off-chain records exist separately from the main distributed ledger or blockchain itself. For example, an off-chain record can comprise a user bank account and/or other account linked to a user and/or other entity.

To facilitate the off-chain action, system 1900 can use one or more on-chain actions related to network 1910. Network 1910 can comprise a blockchain. As described herein, a blockchain is a decentralized ledger of transactions built upon a combination of cryptography techniques (e.g., secret-keys, hash functions, etc.), consensus mechanisms (e.g., Proof of Work, Proof of Stake, etc.), and computer networks (e.g., peer-to-peer (“P2P”) networks, the Internet, etc.). The blockchain stores information electronically, grouped together into a series of subsets of the information, called “blocks.” The information can be maintained by a network of computers using cryptography and consensus mechanisms, which make the practically impossible to hack or alter. Specifically, the integrity of the information in each block can be maintained through one-way cryptographic functions that make the information immutable for practical purposes.

As blocks of information are added, the various blocks form a chain, which represents an immutable record of all the previous transactions across the network. Given the immutability of the records, the public availability of the information in the blockchain, and the reliance on consensus mechanisms for adding new blocks, the blockchain does not require a central authority to monitor transactions, maintain records, and/or enforce rules. As such, blockchains and blockchain technology has become a foundation of many decentralized applications.

For example, network 1910 can comprise a digital log. A digital log can comprise a record or file that captures and stores a chronological sequence of events, actions, or transactions in a digital format. These logs serve various purposes across different domains, including information technology, cybersecurity, finance, and more. Digital logs can maintain a time-sequenced record of activities, events, or changes. Each entry in the log file typically includes a timestamp indicating when the event occurred. The digital log can contain specific details about the events or actions being logged. This information could include user activities, system events, errors, security-related events, transactions, or changes in configurations. Digital logs can be stored in various formats, including text files, structured databases, JSON, XML, or other formats that suit the specific requirements of the system or application generating the logs. The digital logs can be used for diagnosing issues, troubleshooting problems, monitoring system performance, conducting forensic analysis, and auditing activities. They serve as a historical record for understanding past actions or incidents.

In some implementations, the digital log can comprise a distributed ledger (e.g., for a blockchain) and/or other index of blockchain data. For example, the distributed ledger can be a type of database or digital ledger that exists across multiple locations or nodes within a decentralized network. It records transactions, contracts, or any form of data in a secure, transparent, and tamper-evident manner without the need for a central authority or intermediary. Unlike traditional centralized ledgers, distributed ledgers are not controlled by a single entity. Instead, they are distributed among multiple participants or nodes in a network, each maintaining an identical copy of the ledger. This decentralization increases transparency and resiliency by eliminating a single point of control or failure. Distributed Ledgers use consensus mechanisms among network participants to validate and agree upon the state of the ledger. Consensus protocols ensure that all copies of the ledger across the network are in sync and agree on the validity of transactions, maintaining a consistent record of data. Once information is added to the ledger, it becomes virtually immutable, meaning it cannot be altered or deleted retroactively without consensus from the network. The use of cryptographic techniques ensures the security and integrity of the data stored on the ledger.

Network 1910 can be used by system 1900 to manage and/or facilitate one or more cryptographically secure digital assets (e.g., asset 1908). A cryptographically secure digital asset can comprise a tokenization of a value or asset (e.g., a tokenized bank deposit). For example, a cryptographically secure digital asset refers to a digital representation of value, ownership, and/or rights that is secured by cryptographic techniques, ensuring its integrity, authenticity, and/or protection against unauthorized access or modification. These assets exist in digital form and rely on cryptographic protocols and technologies for their security and verification. For example, the asset's security can be based on cryptographic algorithms and techniques that provide strong encryption, hashing, digital signatures, and other cryptographic mechanisms to protect its data and transactions. The cryptographically secure digital assets can operate on blockchain networks. Blockchains use decentralized and distributed ledger technology, ensuring tamper-proof records of transactions and asset ownership. Transactions involving these assets are recorded on a blockchain, creating an immutable and transparent history of ownership and transactional history. Once recorded, data on the blockchain cannot be altered retroactively without consensus from the network. Cryptographically secure digital assets allow ownership and transfer of value or rights in a decentralized manner. Users can securely transfer ownership or conduct transactions directly without relying on intermediaries. Users can access and manage these assets using cryptographic keys. Public and private keys allow users to securely interact with the assets, sign transactions, and prove ownership without revealing sensitive information.

Network 1910 can be used to facilitate communications (e.g., blockchain actions) irrespective of whether a resource is on-line. For example, a resource in a network can be “online,” whether it is a device, service, and/or application, when it is currently connected and available for communication and interaction within the network. In contrast, a resource can be off-line when it is not on-line. For example, the term “online” signifies that the resource is active, operational, and accessible to other devices or users in the network. Being online implies that the resource is powered on, connected to the network infrastructure (such as the internet or a local network), and ready to send, receive, or process data, requests, or commands.

For example, a computer, server, printer, or any network-connected device is considered online when it is powered up, connected to the network (via Ethernet or Wi-Fi), and ready to send and receive data. In another example, applications, websites, or cloud-based services can be online when their servers are operational, connected to the internet, and available for users to access or utilize their functionalities. In yet another example, being online indicates that the resource is reachable and responsive to requests or communication attempts from other devices or users on the network. For example, in implementations, in which the resource is a bank account, bank branch, etc. the resource can be on-line when the resource (or assets held by the resource) are reachable and responsive to requests or communication attempts from other devices or users on the network.

In some implementations, system 1900 can be used to manage resources across network 1910. For example, system 1900 can manage resources based on the availability of resources in network 1910. In some implementations, availability can comprise resource availability. Resource availability in a computer network can refer to the accessibility and readiness of various network resources, devices, services, or applications for use by authorized users or other components within the network. It signifies the ability of these resources to fulfill requests, process data, or perform tasks effectively and efficiently when required. For example, availability can correspond to device accessibility (e.g., the ability of devices (such as computers, servers, routers, switches, printers, etc.) to be reachable and responsive on the network), service uptime (e.g., time services remain operational and responsive to user requests), bandwidth and performance (e.g., resources promptly accessing and/or delivering data or services efficiently without delays or bottlenecks), data and information access (e.g., availability of data resources, databases, files, and information required by users or applications within the network).

In some implementations, availability can correspond to liquidity. Liquidity refers to the ability of a bank or financial institution to meet its short-term obligations and fund its day-to-day operations efficiently. It represents the availability of liquid assets that can be quickly converted into cash to cover liabilities, withdrawals, or unexpected demands for funds. Banks maintain liquidity primarily through liquid assets such as cash, reserves held at central banks, short-term government securities, highly marketable securities, and other instruments that can be easily sold or converted into cash without significant loss of value. Banks can engage in asset-liability management to balance their assets and liabilities, ensuring that they have sufficient liquid assets to cover liabilities and maintain a healthy liquidity position. For example, a tokenized availability of a resource can correspond to assets available at a given resource (e.g., a digital account). The transfer of this can correspond to the assets being transferred from one resource to another.

In some implementations, the system can determine one or more characteristics of availability in one or more resources. The system can then select a cryptographically secure digital asset, from a plurality of cryptographically secure digital assets, based on the characteristics. For example, the system (or self-executing program) can determine a condition for performing the first blockchain action and select a first cryptographically secure digital asset, from a plurality of cryptographically secure digital assets, based on the condition. For example, the condition can indicate a requirement for a cryptographically secure digital asset as recorded in a predetermined digital log corresponding to the first resource. For example, the self-executing program condition can determine a requirement for a first cryptographically secure digital asset, as recorded in a predetermined digital log corresponding to a resource, involves encoding specific criteria or rules within the self-executing program's code to validate the possession or existence of the digital asset before executing certain actions or operations. For example, developers encode conditions within the self-executing program's code using a programming language suitable for self-executing programs (e.g., Solidity for Ethereum). These conditions define the rules or requirements that need to be met regarding the possession or existence of the cryptographically secure digital asset. The self-executing program can interact with a predetermined digital log or ledger that records information related to resources. The condition within the program can check this log to verify the presence or ownership of the specific digital asset corresponding to the resource. The condition can specify requirements such as verifying the ownership of the digital asset through cryptographic keys, checking the asset's unique identifier or token ID, validating a specific transaction or event recorded in the digital log related to the asset, or confirming its existence in a specific state. When a user initiates an action or transaction involving the resource within the self-executing program, the condition is evaluated. If the condition verifies the possession or existence of the required cryptographically secure digital asset in the predetermined digital log, the self-executing program proceeds with the intended operation or execution.

As described herein, a characteristic of availability can comprise any attribute that distinguishes the availability (or availability on a resource) from other availability (or availability on another resource). In some implementations, characteristics of availability in resources within a computer network can refer to attributes or factors that define the accessibility, reliability, and continuity of these resources. For example, in implementations describing the transfer of availability, the availability can be transferred by a change (or transfer) of a characteristic of the availability being transferred.

For example, a characteristic can refer to uptime and reliability as availability is associated with the ability of resources to remain operational and accessible over time without unexpected interruptions. High availability implies minimal downtime and consistent reliability. In another example, a characteristic can refer to accessibility. Available resources should be easily accessible and reachable by users or systems when needed. This includes factors such as network connectivity, response time, and the absence of barriers preventing access. In another example, a characteristic can refer to redundancy and fault tolerance. Systems designed with redundancy have backup mechanisms or duplicate resources to ensure continuous operation even if one component fails. Fault-tolerant systems can detect and recover from failures without significant impact on availability. In another example, a characteristic can refer to resilience to failures. Availability can be linked to a system's resilience against failures caused by hardware malfunctions, software errors, network issues, or other disruptions. Systems designed for high availability can withstand failures and maintain functionality. In another example, a characteristic can refer to scalability and capacity planning. Availability considerations involve the ability to scale resources to meet increasing demand without compromising performance or accessibility. Proper capacity planning ensures resources are available as needed. In another example, a characteristic can refer to monitoring and maintenance. Continuous monitoring, proactive maintenance, and timely interventions play a crucial role in ensuring resource availability. Monitoring tools help detect issues early, allowing for prompt resolution and minimizing downtime. In another example, a characteristic can refer to recovery and disaster preparedness. Availability includes having recovery strategies and disaster preparedness plans in place. These plans help restore services quickly after unexpected events, such as natural disasters or cyber-attacks. In another example, a characteristic can refer to service level agreements (SLAs) characteristics. Defining and adhering to SLAs regarding availability metrics, such as uptime percentage, response time, and maintenance windows, is essential in ensuring commitments to users or customers.

In another example, a characteristic can refer to geographical distribution and load balancing. Distribution of resources across multiple geographical locations and load balancing techniques contribute to availability by ensuring even distribution of workload and minimizing the impact of localized disruptions. In another example, a characteristic can refer to security measures. Availability is linked to security practices that protect resources from unauthorized access, cyber threats, or malicious attacks. Security measures prevent service disruptions caused by security breaches. In another example, a characteristic can refer to documentation and recovery procedures. Maintaining comprehensive documentation and well-defined recovery procedures helps restore services efficiently in case of outages or failures, minimizing the impact on availability.

In some implementations, a characteristic of availability can refer to a characteristic of a good, service, and/or medium of exchange (e.g., money). The characteristics of currency, which is issued by governments and central banks. For example, a characteristic can refer to an issuing authority (e.g., a recognized government or central monetary authority within a country), legal tender (e.g., whether it is authorized by the government for settling debts, transactions, and payments within the country's borders), denomination and/or amount, physical form (e.g., banknotes and coins), type (e.g., fiat, commodity-backed), security features, exchange rate, stability, regulation, etc.

Selecting a cryptographically secure digital asset from a plurality of such assets based on characteristics involves a process that considers various attributes or features associated with these assets. The system can identify the specific characteristics or attributes that are essential for the system's purpose or requirements. These criteria could include factors such as security features, transaction speed, scalability, decentralization, consensus mechanism, token standard (e.g., ERC-20, ERC-721), utility, or network adoption. The system can obtain information and data about the plurality of cryptographically secure digital assets under consideration. This information can include technical specifications, whitepapers, historical performance, market data, developer community, security audits, and use case relevance. The system can evaluate and compare the characteristics of each digital asset against the predefined selection criteria. Assess how well each asset aligns with the system's requirements, considering factors like security, functionality, transaction costs, liquidity, governance, or regulatory compliance. The system can apply a weighted scoring system or ranking mechanism to assign importance or priority to different characteristics based on their relevance to the system's goals. For example, security might have higher weightage compared to transaction speed. The system can conduct both quantitative analysis (e.g., metrics, performance data) and qualitative analysis (e.g., community support, development activity) to comprehensively assess the assets'characteristics. In some implementations, the system can employ decision models or algorithms that factor in the weighted criteria and analysis to generate a scoring system or rank the assets based on their suitability for the system's requirements.

FIG. 19B shows an illustrative architecture for managing resources across global or cloud networks, in accordance with one or more implementations. For example, in FIG. 19B, system 1900 can receive, at a platform application, a first user request to perform a first off-chain action. For example, the off-chain action can represent resource 1902 (e.g., a buyer) creating a self-executing program (e.g., self-executing program 1906). The system can determine a first blockchain action that corresponds to first off-chain action. As referred to herein, a self-executing program (or smart contract) can comprise a program with predefined terms (e.g., terms of an agreement between buyer and seller) written into the code of the program. The self-executing program can be implemented on blockchain platforms, such as Ethereum, which allows for decentralized and automated execution of terms without the need for intermediaries. The self-executing program can be programmed to automatically enforce, verify, and/or facilitate the negotiation or performance of a predefined term (e.g., contract), eliminating the need for a trusted third party. These programs can run on a blockchain, which is a distributed and immutable ledger that records all transactions across a network of computers.

System 1900 can receive a first request, at a first action specific self-executing program, to perform a first blockchain action using a first resource, wherein the first blockchain action is encoded in the first action specific self-executing program. The request (e.g., a computer request) can refer to a communication or a query made by a computer or a software application to another computer, server, and/or device on a network. This request is typically initiated by a client computer seeking specific information, data, resources, or services from a server or another computing device. As described herein, an action-specific self-executing program can refer to a type of self-executing program designed to execute or facilitate a specific action, task, or set of predefined operations within a blockchain network. Unlike general-purpose self-executing programs that can handle various functions, an action-specific self-executing program is tailored to perform a particular action or a limited range of actions based on predefined conditions.

The system can also receive a transfer of cash or other assets that are tokenized on blockchain network 1910 as cryptographically secure digital asset 1914. For example, the system can determine, at the first action specific self-executing program (e.g., self-executing program 1906), a first condition for performing the first blockchain action, wherein the first condition is encoded in the first action specific self-executing program. For example, the first condition can comprise a required amount of available digital assets (or cash or other assets) at a given resource.

In a self-executing program, a condition can refer to a predefined rule, criteria, or set of instructions written into the program's code that determines how the program operates or executes. Conditions establish the logic and parameters that must be met for the self-executing program to perform specific actions or trigger certain outcomes. Conditions define the logic or decision-making process within the self-executing program. They specify the circumstances under which the program will perform certain functions, make decisions, or execute predefined actions.

Conditions are often associated with trigger events or specific states within the blockchain network. When these trigger events occur, the conditions embedded in the self-executing program are evaluated, and corresponding actions are executed if the conditions are met. Conditions can depend on various input parameters, such as timestamps, user input, external data feeds, or the state of other programs or variables within the blockchain network. Based on the fulfillment or non-fulfillment of conditions, a self-executing program can execute specific actions, proceed with a transaction, release funds, transfer tokens, update states, or terminate its execution.

In some implementations, the condition can be a time-based conditions (e.g., a self-executing program might have conditions that execute a particular action only after a specific date, time, or a defined duration has elapsed), threshold conditions (e.g., conditions might specify that a certain number of participants need to approve an action or that a certain amount of tokens needs to be accumulated before an action is executed), external data conditions (e.g., self-executing programs can incorporate external data sources, and conditions can rely on data retrieved from these sources to trigger actions).

Conditions in a self-executing program are encoded using programming languages and specific syntax within the code of the self-executing program. Self-executing programs are typically written in specialized programming languages, such as Solidity for Ethereum or Chaincode for Hyperledger Fabric, and these languages have their syntax and structures to encode conditions. In response to a user request, the system can write self-executing programs using programming languages specifically designed for blockchain platforms. They use the language's syntax and logic to encode conditions within the contract's code. Programming languages used for self-executing programs offer conditional statements (if, else if, else) that allow developers to specify conditions and define the actions or behaviors to be executed based on the evaluation of these conditions. The user request can define the logic, rules, and parameters for conditions within the contract's code. This includes specifying trigger events, input variables, comparison operations, and logical operators to create the conditions. Some self-executing program languages allow the creation of event handlers that can detect external triggers or changes in the blockchain state. These event handlers can be associated with specific conditions to execute actions when triggered.

Self-executing program 1906 can then monitor for the tokenized availability (e.g., cryptographically secure digital assets corresponding to a sale price in self-executing program 1906). For example, the system can receive, by the first action specific self-executing program, a first tokenized availability of the first resource from a first blockchain network. Tokenized availability can refer to the representation or conversion of the availability of assets, resources, or services into digital tokens or cryptographic tokens on a blockchain or digital ledger. It involves using tokens as a representation or proof of ownership, access rights, or availability of certain resources within a decentralized network.

FIG. 19C shows an illustrative architecture for managing resources across global or cloud networks, in accordance with one or more implementations. For example, system 1900 can determine, by the first action specific self-executing program, whether to perform the first blockchain action based on comparing the first condition to the first tokenized availability. For example, the system can determine whether or not to execute the self-executing program. The system can make this determination based on one or more criteria.

As shown in FIG. 19C, the system can determine whether conditions of the self-executing program have been completed. In some implementations, in response to determining to perform the first blockchain action, the system can transmit a second user request to complete the first off-chain action. For example, the system can determine whether a seller delivers services or goods to buyer in accordance with the self-executing program terms and conditions. In such cases, the system can query a buyer and/or seller or request other information of an off-chain action.

The system can execute the first blockchain action, by the first action specific self-executing program, based on determining that the first off-chain action is completed, wherein executing the first blockchain action causes the first tokenized availability of the first resource to be transferred to a second resource.

The system can receive, at the platform application, a confirmation of the first blockchain action being executed. A confirmation of a blockchain action being executed can refer to the acknowledgment or verification that a specific transaction or operation has been successfully processed and added to the blockchain.

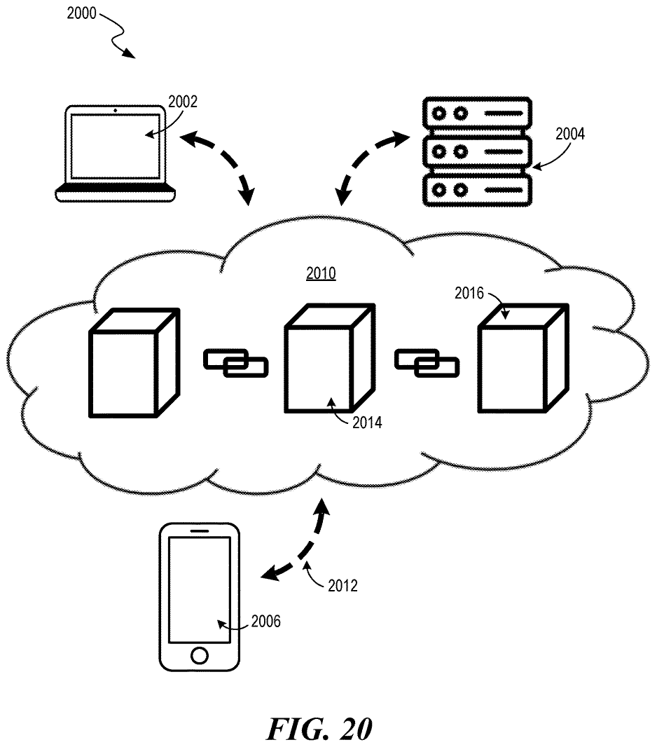

FIG. 20 shows an illustrative diagram of an implementation featuring a blockchain network, in accordance with one or more implementations. For example, system 2000 can comprise a distributed state machine, in which each of the components in FIG. 20 acts as a client of system 2000. For example, system 2000 (as well as other systems described herein) can comprise a large data structure that holds not only all accounts and balances but also a state machine, which can change from block to block according to a predefined set of rules and which can execute arbitrary machine code. The specific rules of changing state from block to block can be maintained by a virtual machine (e.g., a computer file implemented on and/or accessible by one or more client, which behaves like an actual computer) for the system. The data structure can comprise one or more devices and/or components, which can act in concert to facilitate blockchain 2010.

As referred to herein, blockchain 2010 can comprise a type of distributed ledger technology that consists of growing list of records, called blocks (e.g., block 2014 and block 2016), that are securely linked together using cryptography. Each block can contain a cryptographic hash of the previous block (e.g., block 2016 can contain a cryptographic hash of block 2014), and that cryptographic hash can itself be based on a state of a preceding block (e.g., the cryptographic hash of block 2016 is based not only on the state of block 2014). For example, each block can include a timestamp and blockchain action data (e.g., represented as a Merkle tree, where data nodes are represented by leaves). The timestamp proves that the blockchain action data (e.g., the state of the block) existed when the block was created. As each block is based on information about the previous block, the blocks effectively form a chain with each additional block linking to the ones before it. Consequently, blockchain actions are irreversible in that, once they are recorded, the data in any given block cannot be altered retroactively without altering all subsequent blocks.

Blockchains are typically managed by a peer-to-peer (P2P) computer network for use as a public distributed ledger, where nodes collectively adhere to a consensus algorithm protocol to add and validate new transaction blocks. Although, in some implementations, a blockchain can be managed by a private consortium of computers. While blockchain records are not unalterable, since blockchain forks are possible, blockchains can be considered secure by design and exemplify a distributed computing system with high Byzantine fault tolerance.

As shown in FIG. 20, system 2000 comprises user device 2002, user device 2004, and user device 2006. It should be noted that, while shown as a smartphone, a personal computer, and a server in FIG. 20, the user devices can be any type of computing device, including, but not limited to, a laptop computer, a tablet computer, a hand-held computer, and/or other computing equipment (e.g., a server), including “smart,” wireless, wearable, and/or mobile devices. It should be noted that implementations describing system 2000 performing a blockchain action can equally be applied to, and correspond to, an individual user device (e.g., user device 2002, user device 2004, and/or user device 2006) performing the blockchain action. That is, system 2000 can correspond to the user devices (e.g., user device 2002, user device 2004, and/or user device 2006) collectively or individually.

For example, system 2000 can comprise a plurality of nodes for blockchain 2010. Each node can correspond to a user device (e.g., user device 2002, user device 2004, and/or user device 2006). A node for a blockchain network can comprise an application or other software that records and/or monitors peer connections to other nodes and/or miners for the blockchain network. For example, a miner comprises a node in a blockchain network that facilitates blockchain actions by verifying blockchain actions on the blockchain, adding new blocks to the existing chain, and/or ensuring that these additions are accurate. The nodes can continually record the state of the blockchain and respond to remote procedure requests for information about the blockchain.

In some implementations, the user devices of system 2000 can comprise one or more cloud components. For example, cloud components can be implemented as a cloud computing system and can feature one or more component devices. It should also be noted that system 2000 is not limited to three devices. Users may, for instance, utilize one or more devices to interact with one another, one or more servers, or other components of system 2000. It should be further noted that while one or more actions (e.g., blockchain actions) are described herein as being performed by a particular component (e.g., user device 2002) of system 2000, those actions may, in some implementations, be performed by other components of system 2000. As an example, while one or more actions are described herein as being performed by components of user device 2002, those actions may, in some implementations, be performed by one or more cloud components. In some implementations, the various computers and systems described herein can include one or more computing devices that are programmed to perform the described functions. Additionally, or alternatively, multiple users can interact with system 2000 and/or one or more components of system 2000. For example, in one implementation, a first user and a second user can interact with system 2000 using two different components (e.g., user device 2004 and user device 2006, respectively). Additionally, or alternatively, a single user (and/or a user account linked to a single user) can interact with system 2000 and/or one or more components of system 2000 using two different components (e.g., user device 2002 and user device 2006, respectively).

With respect to the components of system 2000, each of these devices can receive content and data via input/output (hereinafter “I/O”) paths using I/O circuitry. Each of these devices can also include processors and/or control circuitry to send and receive commands, requests, and other suitable data using the I/O paths. The control circuitry can comprise any suitable processing, storage, and/or I/O circuitry. Each of these devices can also include a user input interface and/or user output interface (e.g., a display) for use in receiving and displaying data. For example, as shown in FIG. 20, both user device 2002 and user device 2006 include a display upon which to display data (e.g., content related to one or more blockchain actions).

Additionally, the devices in system 2000 can run an application (or another suitable program). The application can cause the processors and/or control circuitry to perform operations related to determining resource availability within a decentralized application environment.

Each of these devices can also include electronic storage. The electronic storages can include non-transitory storage media that electronically stores information. The electronic storage media of the electronic storages can include one or both of (i) system storage that is provided integrally (e.g., is substantially non-removable) with servers or client devices, or (ii) removable storage that is removably connectable to the servers or client devices via, for example, a port (e.g., a USB port, a firewire port, etc.) or a drive (e.g., a disk drive, etc.). The electronic storages can include one or more optically readable storage media (e.g., optical disk, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. The electronic storages can include one or more virtual storage resources (e.g., cloud storage, a virtual private network, and/or other virtual storage resources). The electronic storages can store software algorithms, information determined by the processors, information obtained from servers, information obtained from client devices, or other information that enables the functionality as described herein.

FIG. 20 also includes network 2012, which can comprise communication paths between user devices. The communication paths can include the Internet, a mobile phone network, a mobile voice or data network (e.g., a 5G or LTE network), a cable network, a public switched telephone network, or other types of communication networks or combinations of communication networks. The communication paths can separately or together include one or more communication paths, such as a satellite path, a fiber-optic path, a cable path, a path that supports Internet communications (e.g., IPTV), free-space connections (e.g., for broadcast or other wireless signals), or any other suitable wired or wireless communication path or combination of such paths. The computing devices can include additional communication paths linking a plurality of hardware, software, and/or firmware components operating together. For example, the computing devices can be implemented by a cloud of computing platforms operating together as the computing devices.

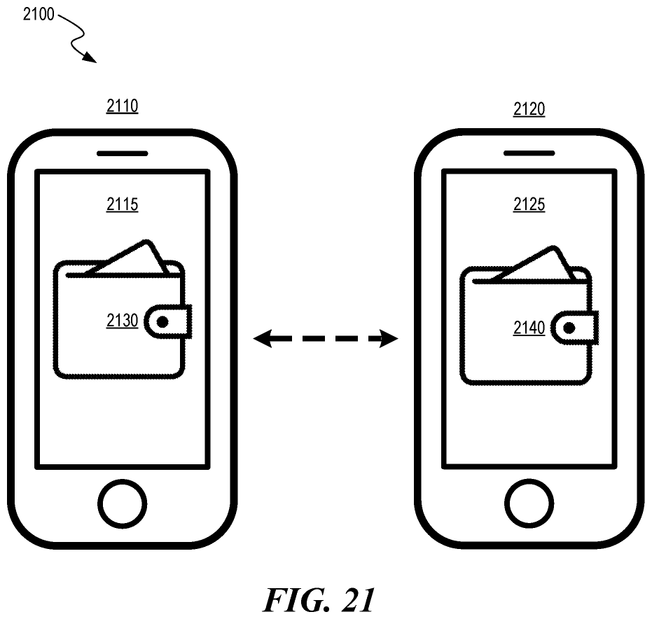

FIG. 21 shows an illustrative diagram for conducting blockchain actions, in accordance with one or more implementations. For example, the diagram presents various components that can be used to determining resource availability in some implementations.

As referred to herein, a “blockchain action” can comprise any action including and/or related to blockchains and blockchain technology. For example, blockchain actions can include conducting transactions, querying a distributed ledger, generating additional blocks for a blockchain, transmitting communications-related nonfungible tokens, performing encryption/decryption, exchanging public/private keys, and/or other actions related to blockchains and blockchain technology. In some implementations, a blockchain action can comprise the creation, modification, detection, and/or execution of a smart contract or program stored on a blockchain. For example, a self-executing program can comprise a program stored on a blockchain that is executed (e.g., automatically and/or without any intermediary's involvement or time loss following a trigger) when one or more predetermined conditions are met. In some implementations, a blockchain action can comprise the creation, modification, exchange, and/or review of a token (e.g., a digital blockchain-specific asset), including a nonfungible token. A nonfungible token can comprise a token that is associated with a good, a service, a self-executing program, and/or other content that can be verified by, and stored using, blockchain technology. In some implementations, blockchain actions can also comprise actions related to mechanisms that facilitate other blockchain actions (e.g., actions related to metering activities for blockchain actions on a given blockchain network).

FIG. 21 includes system 2100, which includes user device 2110 and user device 2120, although other devices and/or components can also be featured in system 2100 (e.g., one or more of devices and/or components shown in FIG. 20). User device 2110 includes user interface 2115. User device 2120 includes user interface 2125. As referred to herein, a “user interface” can comprise a mechanism for human-computer interaction and communication in a device and can include display screens, keyboards, a mouse, and the appearance of a desktop. For example, a user interface can comprise a way for a user interact with and/or access an application, website, and/or other program in order to determining resource availability. A user interface can display content related to resources. As referred to herein, “content” should be understood to mean an electronically consumable user asset, representations of goods or services (including nonfungible tokens), Internet content (e.g., streaming content, downloadable content, webcasts, etc.), video data, audio data, image data, and/or textual data, etc.

In some implementations, gas can be obtained as part of a blockchain action (e.g., a purchase) using a network-specific cryptocurrency (e.g., ether in the case of Ethereum). The system can require gas (or the amount of the network-specific cryptocurrency corresponding to the required amount of gas) to be transmitted with the blockchain action as an earmark to the blockchain action. In some implementations, gas that is earmarked for a blockchain action can be refunded back to the originator of the blockchain action if, after the computation is executed, an amount remains unused.

As shown in FIG. 21, one or more user devices can include a cryptography-based, storage application (e.g., cryptography-based, storage application 2130 and cryptography-based, storage application 2140) used to perform blockchain actions. The cryptography-based, storage application can be used to perform a plurality of blockchain actions across a computer network. For example, the cryptography-based, storage application can comprise a decentralized application that functions to perform one or more blockchain actions.

In some implementations, the cryptography-based, storage application can comprise and/or be compatible with one or more application program interfaces (e.g., APIs). For example, an API can be implemented on user device 2110 and/or communicate with an API implemented on user device 2120. Alternatively or additionally, an API can reside on one or more cloud components. For example, an API can reside on a server and comprise a platform service for a custodial wallet service, decentralized application, etc. An API (which can be a representational state transfer (REST) or web services API layer) can provide a decoupled interface to data and/or functionality of one or more applications.

The API can provide various low-level and/or blockchain-specific operations in order to facilitate resource management. For example, the API can provide blockchain actions such as blockchain writes. Furthermore, the API can perform a transfer validation ahead of forwarding the blockchain action (e.g., a transaction) to another service (e.g., a crypto service). The API can then log the outcome. For example, by logging to the blockchain prior to forwarding, the API can maintain internal records and balances without relying on external verification (e.g., which can take up to ten minutes based on blockchain updating activity).

The API can also provide informational reads. For example, the API (or a platform service powered by the API) can generate blockchain action logs and write to an additional ledger (e.g., an internal record and/or indexer service) the outcome of the reads. If this is done, a user accessing the information through other means can see consistent information such that downstream users ingest the same data point as the user. The API can also provide a unified API to access balances, transaction histories, and/or other blockchain actions activity records between one or more decentralized applications and custodial user accounts. By doing so, the system maintains the security of sensitive information such as the balances and transaction history. Alternatively, a mechanism for maintaining such security would separate the API access between the decentralized applications and custodial user accounts through the use of special logic. The introduction of the special logic decreases the streamlining of the system, which can result in system errors based on divergence and reconciliation.

The API can provide a common, language-agnostic way of interacting with an application. In some implementations, the API can comprise a web services API that offers a well-defined contract that describes the services in terms of their operations and the data types used to exchange information. REST APIs do not typically have this contract; instead, they are documented with client libraries for most common languages including Ruby, Java, PHP, and JavaScript. Simple Object Access Protocol (“SOAP”) web services have traditionally been adopted in the enterprise for publishing internal services as well as for exchanging information with partners in business-to-business (“B2B”) transactions.

The API can use various architectural arrangements. For example, system 2100 can be partially based on the API, such that there is strong adoption of SOAP and RESTful web services, using resources such as Service Repository and Developer Portal, but with low governance, standardization, and separation of concerns. Alternatively, system 2100 can be fully based on the API, such that separation of concerns between layers such as an API layer, services, and applications are in place.

In some implementations, the system architecture can use a microservice approach. Such systems can use two types of layers: front-end layers and back-end layers, where microservices reside. In this kind of architecture, the role of the API can be to provide integration between front-end and back-end layers. In such cases, the API can use RESTful APIs (exposition to front-end or even communication between microservices). The API can use the Advanced Message Queuing Protocol (AMQP), which is an open standard for passing business messages between applications or organizations. The API can use an open-source, high-performance remote procedure call (RPC) framework that can run in a decentralized application environment. In some implementations, the system architecture can use an open API approach. In such cases, the API can use commercial or open-source API platforms and their modules. The API can use a developer portal. The API can use strong security constraints applying a web application firewall that protects the decentralized applications and/or the API against common web exploits, bots, and denial-of-service (DDoS) attacks. The API can use RESTful APIs as standard for external integration.

In some implementations, the system can also use one or more Application Binary Interfaces (ABIs) and an alternative to and/or in addition to an API. An ABI is an interface between two program modules, often between operating systems and user programs. ABIs can be specific to a blockchain protocol. For example, ABI defines the methods and structures used to interact with the binary contract similar to an API, but on a lower-level. The ABI indicates the caller of the function to encode (e.g., ABI encoding) the needed information like function signatures and variable declarations in a format that a virtual machine can understand to call that function in bytecode. ABI encoding can be automated by the system using compilers or wallets interacting with the blockchain.

The cryptography-based, storage application may, in some implementations, correspond to a digital wallet. For example, the digital wallet can comprise a repository that allows users to store, manage, and trade their cryptocurrencies and assets, interact with blockchains, and/or conduct blockchain actions using one or more applications. The digital wallet can be specific to a given blockchain protocol or can provide access to multiple blockchain protocols. In some implementations, the system can use various types of digital wallets such as hot wallets and cold wallets. Hot wallets are connected to the internet while cold wallets are not. Digital wallet holders can hold both a hot wallet and a cold wallet. Hot wallets are most often used to perform blockchain actions, while a cold wallet is generally used for managing a user account and can have no connection to the internet.

In some implementations, the cryptography-based, storage application can correspond to a key-based wallet or a smart contract wallet. For example, a key based wallet can feature public or private keys and allow a user to either have control of the account or receive transactions in the account. A smart contract wallet can comprise blockchain programs or digital agreements that execute transactions between parties once a predetermined condition is met. For example, a smart contract wallet can be managed by a smart contract (e.g., or smart contract code) instead of a private key. As such, a smart contract wallet can improve speed, accuracy, trust, and/or transparency in blockchain actions. In some implementation, a cryptography-based, storage application can include, or have access to, key-based wallet or a smart contract wallet. For example, the cryptography-based, storage application can comprise a digital or other construct (e.g., a reference, a pointer, a text on a blockchain, an address, etc.).

In some implementations, to conduct a blockchain action, user device 2110, user interface 2115, and/or cryptography-based, storage application 2130) can comprise, control, and/or have access to a private key and/or digital signature. For example, system 2100 can use cryptographic systems for conducting blockchain actions such as resource management. For example, system 2100 can use public-key cryptography, which features a pair of digital keys (e.g., which can comprise strings of data). In such cases, each pair comprises a public key (e.g., which can be public) and a private key (e.g., which can be kept private). System 2100 can generate the key pairs using cryptographic algorithms (e.g., featuring one-way functions). System 2100 can then encrypt a message (or other blockchain action) using an intended receiver's public key such that the encrypted message can be decrypted only with the receiver's corresponding private key. In some implementations, system 2100 can combine a message with a private key to create a digital signature on the message. For example, the digital signature can be used to verify the authenticity of blockchain actions. As an illustration, when conducting blockchain actions, system 2100 can use the digital signature to prove to every node in the system that it is authorized to conduct the blockchain actions.

For example, user device 2110 can request a blockchain action (e.g., conduct a transaction). The blockchain action can be authenticated by user device 2110 and/or another node (e.g., a user device in the community network of system 2100). For example, using cryptographic keys, system 2100 can identify users and give access to their respective user accounts (e.g., corresponding digital wallets) within system 2100. Using private keys (e.g., known only to the respective users) and public keys (e.g., known to the community network), system 2100 can create digital signatures to authenticate the users.

Following an authentication of the blockchain action, the blockchain action can be authorized. For example, after the blockchain action is authenticated between the users, system 2100 can authorize the blockchain action prior to adding it to the blockchain. System 2100 can add the blockchain action to a blockchain (e.g., blockchain 2010 (FIG. 20)) as part of a new block (e.g., block 2016 (FIG. 20)). System 2100 can perform this based on a consensus of the user devices within system 2100. For example, system 2100 can rely on a majority (or other metric) of the nodes in the community network to determine that the blockchain action is valid. In response to validation of the block, a node user device (e.g., user device 2120) in the community network (e.g., a miner) can receive a reward (e.g., in a given cryptocurrency) as an incentive for validating the block.

To validate the blockchain action, system 2100 can use one or more validation protocols and/or validation mechanisms. For example, system 2100 can use a proof-of-work mechanism in which a user device must provide evidence that it performed computational work to validate a blockchain action and thus this mechanism provides a manner for achieving consensus in a decentralized manner as well as preventing fraudulent validations. For example, the proof-of-work mechanism can involve iterations of a hashing algorithm. The user device that is successful aggregates and records blockchain actions from a mempool (e.g., a collection of all valid blockchain actions waiting to be confirmed by the blockchain network) into the next block. Alternatively or additionally, system 2100 can use a proof-of-stake mechanism in which a user account (e.g., corresponding to a node on the blockchain network) is required to have, or “stake,” a predetermined amount of tokens in order for system 2100 to recognize it as a validator in the blockchain network.

In response to validation of the block, the block is added to a blockchain (e.g., blockchain 2010 (FIG. 20)), and the blockchain action is completed. For example, to add the blockchain action to blockchain, the successful node (e.g., the successful miner) encapsulates the blockchain action in a new block before transmitting the block throughout system 2100.

In some implementations, a cryptography-based, storage application can comprise a decentralized application. As referred to herein, a “decentralized application” can comprise an application that exists on a blockchain and/or a peer-to-peer network. For example, a decentralized application can comprise an application that has a back end that is in part powered by a decentralized peer-to-peer network such as a decentralized, open-source blockchain with smart contract functionality.

For example, the cryptography-based, storage application (e.g., cryptography-based, storage application 2130) can allow a user device (e.g., user device 2110) to share files, access, and/or perform a blockchain action with another user device (e.g., user device 2120) and/or cryptography-based, storage application (e.g., cryptography-based, storage application 2140). For example, the peer-to-peer architecture and decentralized nature allows blockchain actions to be conducted between the user devices, without the need of any intermediaries or central authorities.

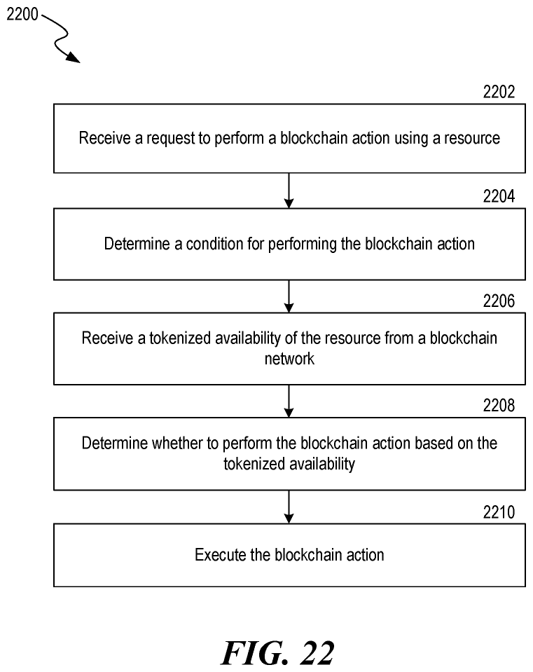

FIG. 22 shows a flowchart of the operations involved in determining availability of resources across global or cloud computer networks, in accordance with one or more implementations. For example, the system can use process 2200 (e.g., as implemented on one or more system components described above) in order to determine availability of resources across global or cloud computer networks while mitigating issues related to providing services with unstable resources

At operation 2202, process 2200 (e.g., using one or more components described above) receives a request to perform a blockchain action using a resource. For example, the system can receive a first request, at a first action specific self-executing program, to perform a first blockchain action using a first resource, wherein the first blockchain action is encoded in the first action specific self-executing program.

In some implementations, encoding the first blockchain action in the first action specific self-executing program can comprise the system (e.g., a self-executing program) receiving the first resource as a first statement in the first action specific self-executing program. A statement refers to a line or a set of instructions written in the code of the self-executing program. These statements represent specific actions, commands, or operations that the self-executing program is programmed to execute when certain conditions are met. Statements are fundamental building blocks of smart contract code. They are written using programming languages specific to the blockchain platform (e.g., Solidity for Ethereum, Chaincode for Hyperledger Fabric) and define the logic and operations of the self-executing program. Statements consist of commands, functions, or instructions that direct the smart contract on how to process data, interact with the blockchain network, manipulate variables, perform calculations, handle transactions, or execute conditional operations. Statements can include conditional structures (such as if-else statements), loops, variable assignments, function calls, event triggers, and other programming constructs that control the flow of execution within the self-executing program.

Additionally or alternatively, the system can receive a first logic in the first action specific self-executing program that determines the second resource upon execution of the first action specific self-executing program. Logic refers to the set of rules, conditions, and instructions encoded within the self-executing program's code that govern its behavior, decision-making process, and execution flow. It encompasses the logical operations, conditional statements, and procedural instructions that define how the self-executing program operates and responds to various inputs or conditions.

In some implementations, encoding the first blockchain action in the first action specific self-executing program can comprise the system receiving a first value for satisfying the first condition. For example, the first value for satisfying the first condition can incorporate information from external data sources, and conditions can rely on data retrieved from these sources to trigger actions. For instance, a weather-based insurance smart contract can pay out based on weather data obtained from an oracle. As another example, conditions might specify that a certain number of participants (e.g., indicated by the value) need to approve an action or that a certain amount of tokens needs to be accumulated before an action is executed. Additionally or alternatively, the system can receive a first time for satisfying a second condition. For example, the second value can be a particular action that executes the self-executing program only after a specific date, time, or a defined duration has elapsed.

At operation 2204, process 2200 (e.g., using one or more components described above) determines a condition for performing the blockchain action. For example, the system can determine, at the first action specific self-executing program, a first condition for performing the first blockchain action, wherein the first condition is encoded in the first action specific self-executing program.

At operation 2206, process 2200 (e.g., using one or more components described above) receives a tokenized availability of the resource from a blockchain network. For example, the system can receive, by the first action specific self-executing program, a first tokenized availability of the first resource from a first blockchain network.

At operation 2208, process 2200 (e.g., using one or more components described above) determines whether to perform the blockchain action based on the tokenized availability. For example, the system can determine, by the first action specific self-executing program, whether to perform the first blockchain action based on comparing the first condition to the first tokenized availability.

In some implementations, the system can determine whether to perform the first blockchain action is based on comparing the first condition to the first tokenized availability, determining a first actual availability for a first resource in a first computer network based on the first tokenized availability, and determining that the first condition corresponds to the first actual availability. For example, the system can define a specific condition or set of criteria that need to be met for triggering a blockchain action. This condition can be related to resource availability, a specific value threshold, time-based parameters, or any other predefined rule. The system can maintain tokenized representations or digital tokens that signify the availability or capacity of resources within the computer network. These tokens could represent the available resources or their capacity in a digital form. The system can compare the condition set for the blockchain action with the tokenized availability. It checks if the condition aligns with the tokenized representation of resource availability in the network. The system can utilize the tokenized availability to derive or determine the corresponding actual availability of the resource within the computer network. This involves a process where tokenized availability is converted or mapped to reflect the real-time or current status of the resource. The system can then compare the condition specified for the blockchain action with the determined actual availability of the resource. It verifies whether the condition matches or corresponds to the verified real-time availability status of the resource within the network. Based on the comparison between the condition, tokenized availability, and actual availability, the system can make a decision regarding whether the condition aligns with the current state of the resource. If the condition matches the actual availability, the system proceeds to perform the blockchain action. If the comparison confirms that the condition corresponds to the verified actual availability, the system triggers the specified blockchain action, such as initiating a transaction, updating a smart contract, or executing a programmed function on the blockchain. The system can record the executed action on the blockchain and maintains a log or record of the process, documenting the correlation between the condition, tokenized availability, and actual resource availability for auditing or future reference.

In some implementations, determining whether to perform the first blockchain action can be based on transmitting a second user request to complete a first off-chain action and determining that the first off-chain action is completed. For example, oracles are entities or services that provide off-chain data or trigger off-chain actions in a blockchain network. They act as bridges between the blockchain and external data sources or systems, enabling self-executing programs to interact with real-world information or execute actions that occur outside the blockchain. The self-executing program sends a request or query to the oracle, specifying the necessary information or action to be performed off-chain. This request could involve retrieving data from APIs, accessing databases, executing external systems, or any other action outside the blockchain. The oracle receives the request from the self-executing program and performs the necessary operations or accesses external resources to fulfill the requested action off-chain. This could involve interacting with external APIs, databases, sensors, or other systems.

In some implementations, the system can select cryptographically secure digital assets (or amount thereof) based on actual availability. For example, the system can determine a first actual availability for the first resource in a first computer network. The system can determine a first cryptographically secure digital asset corresponding to the first actual availability. The system can record the first cryptographically secure digital asset in a digital log. The system can continuously monitor or periodically checks the status and availability of the resource within the computer network. This monitoring can involve network probes, status queries, or other monitoring tools to assess the resource's accessibility. Upon monitoring, the system can gather data or metrics to measure the resource's availability. It might include metrics like uptime, response time, network connectivity, or any other relevant parameters that define the resource's accessibility. Once the system determines the current availability status of the resource, it associates this verified status with a specific cryptographically secure digital asset. This asset serves as a representation or tokenization of the resource's availability. The system can employ cryptographic techniques such as hashing, encryption, digital signatures, or other secure methods to ensure the integrity, authenticity, and immutability of the digital asset associated with the resource's availability. This enhances the security and trustworthiness of the recorded information. The system can record the association between the cryptographically secure digital asset and the verified actual availability of the resource in a digital log or ledger. This log acts as a tamper-proof record of the resource's availability status over time. Each entry in the digital log is timestamped to indicate the time of recording. This helps in tracking changes, auditing the history of resource availability, and providing a chronological record of events for analysis or compliance purposes.

At operation 2210, process 2200 (e.g., using one or more components described above) executes the blockchain action. For example, the system can execute the first blockchain action, by the first action specific self-executing program, based on determining to perform the first blockchain action, wherein executing the first blockchain action causes the first tokenized availability of the first resource to be transferred to a second resource.

In some implementations, the system can determine the first actual availability for the first resource in the first computer network by the system receiving a first verification that the first resource has the first actual availability and recording the first cryptographically secure digital asset as corresponding to the first resource based on the first verification. For example, the system can initiate a verification process to determine the actual availability of a specific resource (e.g., a balance in a bank account, liquidity in a bank branch, etc.) within the computer network. This verification can involve various methods, such as network monitoring, pinging the resource, querying its status, or using specific protocols to confirm its accessibility. Upon verification, the system receives a confirmation or verification signal indicating the current status or availability level of the resource. This signal signifies that the resource is accessible and operational at that particular moment, confirming its actual availability. Following the verification and confirmation of the resource's availability, the system records or associates this verified status with a cryptographically secure digital asset. This association establishes a link or correlation between the verified actual availability of the resource and a unique digital asset stored or represented on the network. The system ensures that the digital asset linked to the resource's availability is cryptographically secure. This involves employing encryption, hashing, or other cryptographic techniques to safeguard the asset's integrity and authenticity within the system. The system maintains a record or ledger where the association between the verified actual availability and the corresponding cryptographically secure digital asset is stored securely. This record serves as a reference point for the resource's status and can be accessed for verification or auditing purposes. As the availability status of the resource changes over time (due to network conditions, maintenance, transactions, liquidity changes, etc.), the system can dynamically update or revise the association with the corresponding digital asset to reflect the most current and verified availability status accurately.

In some implementations, the first verification can be determined based on an amount for an off-chain record corresponding to the first resource, and the first verification can be received at a first blockchain network via a first oracle. For example, the system can interact with an oracle that has access to off-chain data, such as databases, APIs, or external systems, where the off-chain record corresponding to a specific resource is stored or updated. The system can define conditions or rules specifying that an on-chain action should occur based on certain parameters or data retrieved from the off-chain record. For instance, the condition could be a specific amount or value associated with the resource in the off-chain record. The system can use the oracle to query the off-chain data source and retrieve the relevant information or amount corresponding to the resource. The oracle fetches this data from the off-chain record. Upon receiving the data from the off-chain source, the system can validate and compare it against the predefined conditions or rules set for triggering the on-chain action. If the retrieved amount matches or meets the specified criteria, the validation process confirms that the condition is satisfied. Once the validation confirms that the condition based on the off-chain record's data is met (e.g., a party delivers a good at issue in a transaction, a party paid for a good, a network connection is created, appropriate availability/liquidity is found, etc.), the system triggers the corresponding on-chain action or smart contract function. This action could involve initiating a transaction, updating a smart contract state, executing a programmatic function, or performing any predefined action on the blockchain. The verified on-chain action is broadcasted to the blockchain network for execution and inclusion in a block. Miners or validators on the blockchain network process and validate the transaction, ensuring its inclusion in the distributed ledger. After the transaction is confirmed and added to the blockchain, the on-chain action corresponding to the validated off-chain data is executed, thereby reflecting the updated state or result on the blockchain.

In some implementations, executing the first blockchain action based on determining to perform the first blockchain action can comprise the system recording the first cryptographically secure digital asset in a digital log for the second resource. The system can determine a second actual availability for the second resource based on the first cryptographically secure digital asset. The system can transmit a second verification that the second resource has the second actual availability.

It is contemplated that the operations or descriptions of FIG. 22 can be used with any other implementation of this disclosure. In addition, the operations and descriptions described in relation to FIG. 22 can be done in alternative orders or in parallel to further the purposes of this disclosure. For example, each of these operations can be performed in any order, in parallel, or simultaneously to reduce lag or increase the speed of the system or method. Furthermore, it should be noted that any of the components, devices, or equipment discussed in relation to the figures above could be used to perform one or more of the operations in FIG. 22.

### Example Implementation of the Models of the Agent Management Platform

FIG. 23 illustrates a layered architecture of an AI system 2300 that can implement the ML models of the agent management platform of FIG. 13, in accordance with some implementations of the present technology. Example ML models can include the models executed by the agent management platform, such as agents 1304. Accordingly, the agents 1304 can include one or more components of the AI system 2300.

As shown, the AI system 2300 can include a set of layers, which conceptually organize elements within an example network topology for the AI system's architecture to implement a particular AI model. Generally, an AI model is a computer-executable program implemented by the AI system 2300 that analyses data to make predictions. Information can pass through each layer of the AI system 2300 to generate outputs for the AI model. The layers can include a data layer 2302, a structure layer 2304, a model layer 2306, and an application layer 2308. The algorithm 2316 of the structure layer 2304 and the model structure 2320 and model parameters 2322 of the model layer 2306 together form an example AI model. The optimizer 2326, loss function engine 2324, and regularization engine 2328 work to refine and optimize the AI model, and the data layer 2302 provides resources and support for application of the AI model by the application layer 2308.

The data layer 2302 acts as the foundation of the AI system 2300 by preparing data for the AI model. As shown, the data layer 2302 can include two sub-layers: a hardware platform 2310 and one or more software libraries 2312. The hardware platform 2310 can be designed to perform operations for the AI model and include computing resources for storage, memory, logic and networking, such as the resources described in relation to FIGS. 24 and 25. The hardware platform 2310 can process amounts of data using one or more servers. The servers can perform backend operations such as matrix calculations, parallel calculations, machine learning (ML) training, and the like. Examples of servers used by the hardware platform 2310 include central processing units (CPUs) and graphics processing units (GPUs). CPUs are electronic circuitry designed to execute instructions for computer programs, such as arithmetic, logic, controlling, and input/output (I/O) operations, and can be implemented on integrated circuit (IC) microprocessors. GPUs are electric circuits that were originally designed for graphics manipulation and output but can be used for AI applications due to their vast computing and memory resources. GPUs use a parallel structure that generally makes their processing more efficient than that of CPUs. In some instances, the hardware platform 2310 can include computing resources, (e.g., servers, memory, etc.) offered by a cloud services provider. The hardware platform 2310 can also include computer memory for storing data about the AI model, application of the AI model, and training data for the AI model. The computer memory can be a form of random-access memory (RAM), such as dynamic RAM, static RAM, and non-volatile RAM.

The software libraries 2312 can be thought of suites of data and programming code, including executables, used to control the computing resources of the hardware platform 2310. The programming code can include low-level primitives (e.g., fundamental language elements) that form the foundation of one or more low-level programming languages, such that servers of the hardware platform 2310 can use the low-level primitives to carry out specific operations. The low-level programming languages do not require much, if any, abstraction from a computing resource's instruction set architecture, enabling them to run quickly with a small memory footprint. Examples of software libraries 2312 that can be included in the AI system 2300 include INTEL Math Kernel Library, NVIDIA cuDNN, EIGEN, and OpenBLAS.

The structure layer 2304 can include an ML framework 2314 and an algorithm 2316. The ML framework 2314 can be thought of as an interface, library, or tool that enables users to build and deploy the AI model. The ML framework 2314 can include an open-source library, an API, a gradient-boosting library, an ensemble method, and/or a deep learning toolkit that work with the layers of the AI system facilitate development of the AI model. For example, the ML framework 2314 can distribute processes for application or training of the AI model across multiple resources in the hardware platform 2310. The ML framework 2314 can also include a set of pre-built components that have the functionality to implement and train the AI model and enable users to use pre-built functions and classes to construct and train the AI model. Thus, the ML framework 2314 can be used to facilitate data engineering, development, hyperparameter tuning, testing, and training for the AI model. Examples of ML frameworks 2314 that can be used in the AI system 2300 include TENSORFLOW, PYTORCH, SCIKIT-LEARN, KERAS, LightGBM, RANDOM FOREST, and AMAZON WEB SERVICES.

The algorithm 2316 can be an organized set of computer-executable operations used to generate output data from a set of input data and can be described using pseudocode. The algorithm 2316 can include complex code that enables the computing resources to learn from new input data and create new/modified outputs based on what was learned. In some implementations, the algorithm 2316 can build the AI model through being trained while running computing resources of the hardware platform 2310. This training enables the algorithm 2316 to make predictions or decisions without being explicitly programmed to do so. Once trained, the algorithm 2316 can run at the computing resources as part of the AI model to make predictions or decisions, improve computing resource performance, or perform tasks. The algorithm 2316 can be trained using supervised learning, unsupervised learning, semi-supervised learning, and/or reinforcement learning.

Using supervised learning, the algorithm 2316 can be trained to learn patterns (e.g., map input data to output data) based on labeled training data. The training data can be labeled by an external user or operator. For instance, a user can collect a set of training data, such as by capturing data from sensors, images from a camera, outputs from a model, and the like. In an example implementation, training data can include native-format data collected (e.g., in the form of input 1302 in FIG. 13) from various source computing systems described in relation to FIG. 13. Furthermore, training data can include pre-processed data generated by various engines of the agent management platform described in relation to FIG. 13. The user can label the training data based on one or more classes and trains the AI model by inputting the training data to the algorithm 2316. The algorithm determines how to label the new data based on the labeled training data. The user can facilitate collection, labeling, and/or input via the ML framework 2314. In some instances, the user can convert the training data to a set of feature vectors for input to the algorithm 2316. Once trained, the user can test the algorithm 2316 on new data to determine if the algorithm 2316 is predicting accurate labels for the new data. For example, the user can use cross-validation methods to test the accuracy of the algorithm 2316 and retrain the algorithm 2316 on new training data if the results of the cross-validation are below an accuracy threshold.

Supervised learning can include classification and/or regression. Classification techniques include teaching the algorithm 2316 to identify a category of new observations based on training data and are used when input data for the algorithm 2316 is discrete. Said differently, when learning through classification techniques, the algorithm 2316 receives training data labeled with categories (e.g., classes) and determines how features observed in the training data (e.g., various claim elements, policy identifiers, tokens extracted from unstructured data) relate to the categories (e.g., risk propensity categories, claim leakage propensity categories, complaint propensity categories). Once trained, the algorithm 2316 can categorize new data by analyzing the new data for features that map to the categories. Examples of classification techniques include boosting, decision tree learning, genetic programming, learning vector quantization, k-nearest neighbor (k-NN) algorithm, and statistical classification.

Regression techniques include estimating relationships between independent and dependent variables and are used when input data to the algorithm 2316 is continuous. Regression techniques can be used to train the algorithm 2316 to predict or forecast relationships between variables. To train the algorithm 2316 using regression techniques, a user can select a regression method for estimating the parameters of the model. The user collects and labels training data that is input to the algorithm 2316 such that the algorithm 2316 is trained to understand the relationship between data features and the dependent variable(s). Once trained, the algorithm 2316 can predict missing historic data or future outcomes based on input data. Examples of regression methods include linear regression, multiple linear regression, logistic regression, regression tree analysis, least squares method, and gradient descent. In an example implementation, regression techniques can be used, for example, to estimate and fill-in missing data for machine learning based pre-processing operations.

Under unsupervised learning, the algorithm 2316 learns patterns from unlabeled training data. In particular, the algorithm 2316 is trained to learn hidden patterns and insights of input data, which can be used for data exploration or for generating new data. Here, the algorithm 2316 does not have a predefined output, unlike the labels output when the algorithm 2316 is trained using supervised learning. Said another way, unsupervised learning is used to train the algorithm 2316 to find an underlying structure of a set of data, group the data according to similarities, and represent that set of data in a compressed format. The agent management platform can use unsupervised learning to identify patterns in claim history (e.g., to identify particular event sequences) and so forth. In some implementations, performance of the agent management platform that can use unsupervised learning is improved because the incoming input 1302 is pre-processed and reduced, based on the relevant triggers, as described herein.

A few techniques can be used in supervised learning: clustering, anomaly detection, and techniques for learning latent variable models. Clustering techniques include grouping data into different clusters that include similar data, such that other clusters contain dissimilar data. For example, during clustering, data with possible similarities remain in a group that has less or no similarities to another group. Examples of clustering techniques density-based methods, hierarchical based methods, partitioning methods, and grid-based methods. In one example, the algorithm 2316 can be trained to be a k-means clustering algorithm, which partitions n observations in k clusters such that each observation belongs to the cluster with the nearest mean serving as a prototype of the cluster. Anomaly detection techniques are used to detect previously unseen rare objects or events represented in data without prior knowledge of these objects or events. Anomalies can include data that occur rarely in a set, a deviation from other observations, outliers that are inconsistent with the rest of the data, patterns that do not conform to well-defined normal behavior, and the like. When using anomaly detection techniques, the algorithm 2316 can be trained to be an Isolation Forest, local outlier factor (LOF) algorithm, or K-nearest neighbor (k-NN) algorithm. Latent variable techniques include relating observable variables to a set of latent variables. These techniques assume that the observable variables are the result of an individual's position on the latent variables and that the observable variables have nothing in common after controlling for the latent variables. Examples of latent variable techniques that can be used by the algorithm 2316 include factor analysis, item response theory, latent profile analysis, and latent class analysis.

The model layer 2306 implements the AI model using data from the data layer and the algorithm 2316 and ML framework 2314 from the structure layer 2304, thus enabling decision-making capabilities of the AI system 2300. The model layer 2306 includes a model structure 2320, model parameters 2322, a loss function engine 2324, an optimizer 2326, and a regularization engine 2328.

The model structure 2320 describes the architecture of the AI model of the AI system 2300. The model structure 2320 defines the complexity of the pattern/relationship that the AI model expresses. Examples of structures that can be used as the model structure 2320 include decision trees, support vector machines, regression analyses, Bayesian networks, Gaussian processes, genetic algorithms, and artificial neural networks (or, simply, neural networks). The model structure 2320 can include a number of structure layers, a number of nodes (or neurons) at each structure layer, and activation functions of each node. Each node's activation function defines how to node converts data received to data output. The structure layers can include an input layer of nodes that receive input data, an output layer of nodes that produce output data. The model structure 2320 can include one or more hidden layers of nodes between the input and output layers. The model structure 2320 can be an Artificial Neural Network (or, simply, neural network) that connects the nodes in the structured layers such that the nodes are interconnected. Examples of neural networks include Feedforward Neural Networks, convolutional neural networks (CNNs), Recurrent Neural Networks (RNNs), Autoencoder, and Generative Adversarial Networks (GANs).

The model parameters 2322 represent the relationships learned during training and can be used to make predictions and decisions based on input data. The model parameters 2322 can weight and bias the nodes and connections of the model structure 2320. For instance, when the model structure 2320 is a neural network, the model parameters 2322 can weight and bias the nodes in each layer of the neural networks, such that the weights determine the strength of the nodes and the biases determine the thresholds for the activation functions of each node. The model parameters 2322, in conjunction with the activation functions of the nodes, determine how input data is transformed into desired outputs. The model parameters 2322 can be determined and/or altered during training of the algorithm 2316.

The loss function engine 2324 can determine a loss function, which is a metric used to evaluate the AI model's performance during training. For instance, the loss function engine 2324 can measure the difference between a predicted output of the AI model and the actual output of the AI model and is used to guide optimization of the AI model during training to minimize the loss function. The loss function can be presented via the ML framework 2314, such that a user can determine whether to retrain or otherwise alter the algorithm 2316 if the loss function is over a threshold. In some instances, the algorithm 2316 can be retrained automatically if the loss function is over the threshold. Examples of loss functions include a binary-cross entropy function, hinge loss function, regression loss function (e.g., mean square error, quadratic loss, etc.), mean absolute error function, smooth mean absolute error function, log-cosh loss function, and quantile loss function.

The optimizer 2326 adjusts the model parameters 2322 to minimize the loss function during training of the algorithm 2316. In other words, the optimizer 2326 uses the loss function generated by the loss function engine 2324 as a guide to determine what model parameters lead to the most accurate AI model. Examples of optimizers include Gradient Descent (GD), Adaptive Gradient Algorithm (AdaGrad), Adaptive Moment Estimation (Adam), Root Mean Square Propagation (RMSprop), Radial Base Function (RBF) and Limited-memory BFGS (L-BFGS). The type of optimizer 2326 used can be determined based on the type of model structure 2320 and the size of data and the computing resources available in the data layer 2302.

The regularization engine 2328 executes regularization operations. Regularization is a technique that prevents over-and under-fitting of the AI model. Overfitting occurs when the algorithm 2316 is overly complex and too adapted to the training data, which can result in poor performance of the AI model. Underfitting occurs when the algorithm 2316 is unable to recognize even basic patterns from the training data such that it cannot perform well on training data or on validation data. The optimizer 2326 can apply one or more regularization techniques to fit the algorithm 2316 to the training data properly, which helps constraint the resulting AI model and improves its ability for generalized application. Examples of regularization techniques include lasso (L1) regularization, ridge (L2) regularization, and elastic (L1 and L2 regularization).

The application layer 2308 describes how the AI system 2300 is used to solve problem or perform tasks. In an example implementation, the application layer 2308 can include a front-end user interface of the agent management platform.

### Example Computing Environment of the Agent Management Platform

FIG. 24 is a block diagram showing some of the components typically incorporated in at least some of the computer systems 2400 and other devices on which the disclosed system operates in accordance with some implementations of the present technology. As shown, an example computer system 2400 can include: one or more processors 2402, main memory 2408, non-volatile memory 2412, a network interface device 2414, video display device 2420, an input/output device 2422, a control device 2424 (e.g., keyboard and pointing device), a drive unit 2426 that includes a machine-readable medium 2428, and a signal generation device 2432 that are communicatively connected to a bus 2418. The bus 2418 represents one or more physical buses and/or point-to-point connections that are connected by appropriate bridges, adapters, or controllers. Various common components (e.g., cache memory) are omitted from FIG. 24 for brevity. Instead, the computer system 2400 is intended to illustrate a hardware device on which components illustrated or described relative to the examples of the figures and any other components described in this specification can be implemented.

The computer system 2400 can take any suitable physical form. For example, the computer system 2400 can share a similar architecture to that of a server computer, personal computer (PC), tablet computer, mobile telephone, game console, music player, wearable electronic device, network-connected (“smart”) device (e.g., a television or home assistant device), AR/VR systems (e.g., head-mounted display), or any electronic device capable of executing a set of instructions that specify action(s) to be taken by the computer system 2400. In some implementations, the computer system 2400 can be an embedded computer system, a system-on-chip (SOC), a single-board computer system (SBC) or a distributed system such as a mesh of computer systems or include one or more cloud components in one or more networks. Where appropriate, one or more computer systems 2400 can perform operations in real time, near real time, or in batch mode.

The network interface device 2414 enables the computer system 2400 to exchange data in a network 2416 with an entity that is external to the computing system 2400 through any communication protocol supported by the computer system 2400 and the external entity. Examples of the network interface device 2414 include a network adaptor card, a wireless network interface card, a router, an access point, a wireless router, a switch, a multilayer switch, a protocol converter, a gateway, a bridge, bridge router, a hub, a digital media receiver, and/or a repeater, as well as all wireless elements noted herein.

The memory (e.g., main memory 2408, non-volatile memory 2412, machine-readable medium 2428) can be local, remote, or distributed. Although shown as a single medium, the machine-readable medium 2428 can include multiple media (e.g., a centralized/distributed database and/or associated caches and servers) that store one or more sets of instructions 2430. The machine-readable (storage) medium 2428 can include any medium that is capable of storing, encoding, or carrying a set of instructions for execution by the computer system 2400. The machine-readable medium 2428 can be non-transitory or comprise a non-transitory device. In this context, a non-transitory storage medium can include a device that is tangible, meaning that the device has a concrete physical form, although the device can change its physical state. Thus, for example, non-transitory refers to a device remaining tangible despite this change in state.

Although implementations have been described in the context of fully functioning computing devices, the various examples are capable of being distributed as a program product in a variety of forms. Examples of machine-readable storage media, machine-readable media, or computer-readable media include recordable-type media such as volatile and non-volatile memory, removable memory, hard disk drives, optical disks, and transmission-type media such as digital and analog communication links.

In general, the routines executed to implement examples herein can be implemented as part of an operating system or a specific application, component, program, object, module, or sequence of instructions (collectively referred to as “computer programs”). The computer programs typically comprise one or more instructions (e.g., instructions 2410, 2430) set at various times in various memory and storage devices in computing device(s). When read and executed by the processor 2402, the instruction(s) cause the computer system 2400 to perform operations to execute elements involving the various aspects of the disclosure.

FIG. 25 is a system diagram illustrating an example of a computing environment in which the disclosed system operates in some implementations. In some implementations, environment 2500 includes one or more client computing devices 1005A-D, examples of which can host the agent management platform of FIG. 13. Client computing devices 2505 operate in a networked environment using logical connections through network 2530 to one or more remote computers, such as a server computing device.

In some implementations, server computing device 2510 is an edge server which receives client requests and coordinates fulfillment of those requests through other servers, such as servers 1220A-C. In some implementations, server computing devices 2510 and 2520 comprise computing systems, such as the agent management platform of FIG. 13. Though each server computing device 2510 and 2520 is displayed logically as a single server, server computing devices can each be a distributed computing environment encompassing multiple computing devices located at the same or at geographically disparate physical locations. In some implementations, each server computing device 2520 corresponds to a group of servers.

Client computing devices 2505 and server computing devices 2510 and 2520 can each act as a server or client to other server or client devices. In some implementations, servers (2510, 1220A-C) connect to a corresponding database (2515, 1225A-C). As discussed above, each server computing device 2520 can correspond to a group of servers, and each of these servers can share a database or can have its own database. Databases 2515 and 2525 warehouse (e.g., store) information such as claims data, email data, call transcripts, call logs, policy data and so on. Though databases 2515 and 2525 are displayed logically as single units, databases 2515 and 2525 can each be a distributed computing environment encompassing multiple computing devices, can be located within their corresponding server, or can be located at the same or at geographically disparate physical locations.

Network 2530 can be a local area network (LAN) or a wide area network (WAN), but can also be other wired or wireless networks. In some implementations, network 2530 is the Internet or some other public or private network. Client computing devices 2505 are connected to network 2530 through a network interface, such as by wired or wireless communication. While the connections between server computing device 2510 and server computing devices 2520 are shown as separate connections, these connections can be any kind of local, wide area, wired, or wireless network, including network 2530 or a separate public or private network.

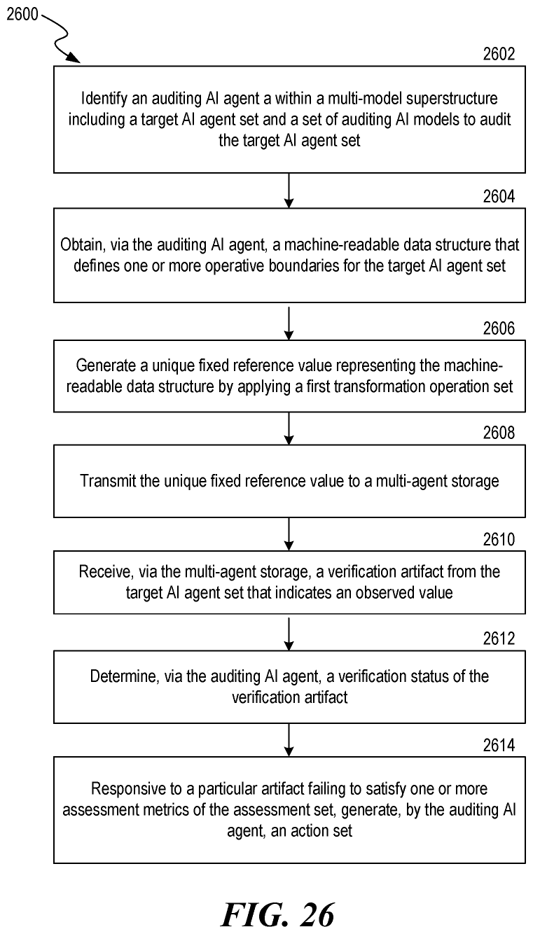

FIG. 26 shows a flowchart of the operations involved in verification of agents (e.g., third party agents), in accordance with one or more implementations. For example, the system can use process 2600 (e.g., as implemented on one or more system components described above) to dynamically assess target AI agents in a multi-model superstructure.

At operation 2602, process 2600 (e.g., using one or more components described above) identifies, and/or determines, an auditing AI agent within a multi-model superstructure, wherein the multi-model superstructure includes a target AI agent set and a set of auditing AI agents to audit the target AI agent set. For example, the system can identify the auditing AI agent from the set of auditing AI agents for assessing target AI agents. According to some implementations, the auditing AI agent can be associated with a first entity, such as an entity tied to the system or platform described herein, or in some cases, a third party entity. For example, the entity could be a financial firm.

In one implementation, the system can extend, to other agents (e.g., target AI agents) being assessed for compliance, a query for accepting compliance or auditing tasks to be performed. Upon receiving a response from the other agents, the system can automatically programmatically set a compliance audit flag within a contract management database, indicating that an auditing agent is authorized to monitor and enforce compliance. The auditing agent, whether internal or third-party, can be registered in the system with defined access credentials and permissions, enabling secure, role-based access to relevant transactional and compliance data.

In some implementations, the auditing AI agent is within a multi-model superstructure including (i) a target AI agent set and (ii) the plurality of sets of auditing AI agents to audit the target AI agent set. As referred to herein, a multi-model superstructure can include a first set of models (e.g., a target AI agent set) and a second set of models (e.g., the auditing AI agent set). The first set of models can be thought of as the monitored model(s) generating the artifact (e.g., an output based on the prompt or other output generation request such as artifact). The models in the multi-model superstructure can include various types of generative models (e.g., language models, image generation models, data synthesis models). The second set of models can be thought of as the monitoring model(s) evaluating and validating the artifact generated by the first set of models (e.g., checking accuracy, detecting biases, ensuring compliance with regulations such as a validation model and validating models). In some implementations, the multi-model superstructure can use a modular architecture to enable easy integration and replacement of models within the multi-model superstructure. Each model can be encapsulated within a microservice, which communicates with other microservices via APIs. Additionally, the multi-model superstructure can use containerization technologies, such as Docker, to package and deploy the models.

Identifying the auditing AI agent from the set of auditing AI agents can include selecting the auditing AI agent randomly, using a predefined schedule, and/or the like. For example, in some implementations the one or more models of the second set of models (e.g., the set of auditing AI agents) are determined randomly to introduce variability. By randomly selecting models from the second set (e.g., set of auditing AI agents), the multi-model superstructure can avoid potential biases that can arise from consistently using the same models. The random selection process can be implemented using algorithms such as random sampling or stochastic processes to ensure that each model in the second set has an equal probability of being chosen. The random determination can be combined with other selection criteria, such as performance metrics or resource availability, to balance randomness with practical considerations.

In some implementations, the multi-model superstructure can establish a predefined schedule to change the one or more models in the second set of models. The predefined schedule can be established using time intervals, such as changing models every hour or day, and/or a number of output generation requests processed, such as switching models after every 100 requests. Using the predefined schedule, the multi-model superstructure can determine the one or more models of the second set of models. By adhering to this schedule, the multi-model superstructure ensures that different models are periodically utilized, which can help in balancing the load, preventing model overfitting, and introducing variability in the outputs. The scheduling algorithm used can be, for example, a round-robin scheduling algorithm that assigns a fixed time slice to each model in a cyclic order. A weighted round-robin algorithm can allocate more processing time to higher-performing models based on assigned weights. Further, the scheduling algorithm used can include priority scheduling to ensure that preferred models are used more frequently by assigning them higher priority levels. Least Recently Used (LRU) scheduling can be used to ensure periodic usage of all models by selecting the model(s) that have been used the least recently. Dynamic scheduling can adjust the shifting of the models based on real-time metrics such as model performance and system load.

In some implementations, the multi-model superstructure can dynamically select the one or more models of the second set of models using the third set of models and using dimension-specific features of the particular dimension being evaluated. For instance, if the dimension being evaluated is related to financial data, the third set of models can extract features such as transaction types, regulatory requirements, and market conditions. The features can be used to match the artifact with models in the second set that are specifically trained on similar financial datasets. The selection process can be implemented (e.g., using the third set of models) using machine learning algorithms, such as decision trees, which are a type of supervised learning algorithm that splits the data into branches based on feature values, ultimately leading to a decision node that indicates the most suitable model.

Alternatively, the third set of models can map the artifact to the most suitable model(s) in the second set by minimizing a loss function, which measures the difference between the predicted and actual model selections. When a new artifact is received, the multi-model superstructure can input certain features (e.g., artifact type, artifact timestamp, artifact location, last used models in the second set, predefined schedules, metadata of capabilities and specializations of models in the second set, other metadata, and so forth) into the trained third set of models, which then predicts the most suitable model(s) from the second set of models to use to validate the artifact. Dynamically determining the monitoring models enables the multi-model superstructure to use, for example, different monitoring models on different artifact types (e.g., format, domain such as technical field) depending on the monitoring model's performance (e.g., better performing monitoring models for a particular artifact type is used on the particular artifact).

In addition to dynamically selecting models based on dimension-specific features, the multi-model superstructure can vary the monitoring models using dynamic balancing based on model performance metrics such as latency, accuracy, and/or precision. For instance, monitoring models with lower latency and higher accuracy can be prioritized for real-time applications, while those with higher precision can be selected for tasks executed by higher risk applications. Furthermore, the superstructure can use previous results by clustering artifacts with similar characteristics and thus select monitoring models that have historically performed well on similar artifacts.

In some implementations, the models in the multi-model superstructure include 1) general-purpose models and/or 2) domain-specific models. The artifacts can be routed to the one or more models of the second set of models trained on data sharing a common domain with one or more artifacts of the set of artifacts. The domain can indicate 1) an area of knowledge, such as healthcare or finance, 2) a data type, such as text, image, or numerical data, 3) a guideline type, such as regulatory compliance or industry standards, and/or 4) a type of task, such as classification, prediction, or summarization. The multi-model superstructure can categorize/tag the artifacts from the first set of models based on the artifact's domain's characteristics (e.g., keywords identified using NLP). For instance, if the artifact is a text document related to healthcare, it is tagged with the “healthcare” domain. The multi-model superstructure can use the tags to route the artifacts to the models in the second set.

At operation 2604, process 2600 (e.g., using one or more components described above) includes obtaining, via the auditing AI agent, a machine-readable data structure that defines one or more operative boundaries for the target AI agent set. In some examples, the target AI agent set can be associated with a second entity (e.g., representing organizational guidelines, industry standards, or provider criteria).

At operation 2606, process 2600 (e.g., using one or more components described above) includes generating a unique fixed reference value representing the machine-readable data structure by applying a first transformation operation set on the machine-readable data structure. The first transformation operation set and generation of the unique fixed reference value is described in relation to FIG. 12. At operation 2608, process 2600 (e.g., using one or more components described above) transmits the unique fixed reference value to a multi-agent storage. In some implementations, the multi-agent storage is configured to store the unique fixed reference value in association with an identifier string identifying the auditing AI agent. In some implementations, the multi-agent storage comprises a memory structure accessible to multiple AI agents including the auditing AI agent and the target AI agent set.

As described in relation with FIG. 12, the storage structure can include a distributed ledger and the verification record can be stored as a transaction on the distributed ledger. In some implementations, the distributed ledge can include a federated ledger and/or blockchain. The multi-agent storage can include a memory structure accessible to multiple AI agents including the first AI agent and the second AI agent. Similarly, as described in relation with FIG. 12, the multi-agent storage can store the unique fixed reference value in association with an identifier, such as an identifier string (e.g., name or unique code), identifying the first AI agent. For example, before the transaction is transmitted, the agent management platform can digitally sign the transaction using a private cryptographic key of the submitting agent. The signed record can be broadcast to all nodes or participants in the storage structure, where the record can be checked and validated according to the agent management platform's rules for consensus. Once approved, the transaction can be permanently added to the storage structure.

At operation 2610, process 2600 (e.g., using one or more components described above) receives or otherwise obtains, via the multi-agent storage, a verification artifact from the target AI agent set that indicates an observed value. In some implementations, the observed value is generated by applying a second transformation operation set on an artifact set generated by the target AI agent set. Alternatively or additionally, the observed value can be generated by applying the second transformation operation set on one or more portions of an internal operational dataset of the target AI agent set corresponding to the one or more operational boundaries, as described further in relation with FIG. 12.

As referred to herein, the artifact can be thought of as the subject to be monitored and validated, such as an output generated by one or more models (e.g., generative AI model) of the target AI agent set. For example, an artifact can be any form of data (e.g., structured, semi-structured, unstructured), such as text, images, or other multimedia content, produced by the AI model. In some implementations, an artifact can include structured data outputs, such as tables or graphs. For example, an artifact can be a text summary of a legal document, an image generated from a text description, and/or a graph representing data trends. An artifact is evaluated against various compliance and performance metrics.

An artifact can be evaluated for compliance against the criteria within policy sources. The policy sources encompass a range of regulatory and policy documents that provide guidelines and standards for AI model compliance. The policy sources can be the same as or similar to guidelines which can include various elements such as jurisdictional regulations, organizational regulations, and AI applications-specific regulations (e.g., unsupervised learning, natural language processing (NLP), generative AI). Jurisdictional regulations (e.g., governmental regulations) can include regulations gathered from authoritative sources such as government websites, legislative bodies, and regulatory agencies. Jurisdictional regulations can be published in legal documents or official publications and cover aspects related to the development, deployment, and use of AI technologies within specific jurisdictions. Organizational regulations include internal policies, procedures, and guidelines established by organizations to govern AI-related activities within the organization's operations. Organizational regulations can be developed in alignment with industry standards, legal requirements, and organizational objectives. AI application-specific regulations include regulations that pertain to specific types of AI applications, such as unsupervised learning, natural language processing (NLP), and generative AI.

The policy sources can include internal company policies, industry standards, legal regulations, and/or other guidelines. For example, policy sources can include ethical guidelines that ensure AI models operate within moral boundaries, such as avoiding bias and ensuring fairness. Additionally, policy sources can include regulations from financial regulatory bodies like the Financial Industry Regulatory Authority (FINRA). Compliance with FINRA regulations can include adhering to standards for transparency, accuracy, and/or investor protection. Policy sources can further include regulations such as the Sarbanes-Oxley Act (SOX), which sets requirements for financial reporting and corporate governance. For example, AI models used in financial reporting are required to comply with SOX standards relating to the accuracy and integrity of financial data. In some implementations, policy sources can integrate real-time updates from regulatory bodies to ensure the AI model remains compliant with the latest standards. The knowledge base within policy sources stores structured and unstructured data related to the policies. For example, structured data can be structured databases of regulations, while unstructured data can be text documents or emails.

To enable evaluation of an artifact, the policy context extraction module identifies the criteria within the policy sources. In particular, the policy context extraction module within the artifact observation platform extracts criteria and/or context within the knowledge base containing the policy sources to provide assessment metrics and threshold values of the assessment metrics in which to use to evaluate an artifact. The policy context extraction module can extract criteria and/or context. The extracted information can be used by the monitoring engine to continuously observe an artifact and detect deviations from expected behavior. For example, the monitoring engine can task one or more validation model(s) to detect bias, inaccuracies, and non-compliance with guidelines of an artifact.

At operation 2612, process 2600 (e.g., using one or more components described above) determines, via the auditing AI agent, a verification status of the verification artifact. For example, the system can determine the verification status by comparing the unique fixed reference value generated by the auditing AI agent with the observed value indicated by the verification artifact, wherein the verification status is indicative of satisfaction of the artifact set with an assessment metric set of an assessment set. For example, this can be done using techniques described in relation with FIG. 12.

At operation 2614, process 2600 (e.g., using one or more components described above), responsive to a particular artifact failing to satisfy one or more assessment metrics of the assessment set, generates, by the auditing AI agent, an action set. In particular, the action set can be configured to modify the target AI agent set using the verification status of the artifact set with the assessment metric set of the assessment set. According to some implementations, the action set includes one or more of: 1) parameters of one or more AI models of the target AI agent set indicated by the one or more assessment metrics or 2) an output generation request configured to generate the artifact set using the target AI agent set.

According to some implementations, the system can further, using the generated action set, update the output generation request by automatically triggering one or more computer-implemented commands indicated by the generated action set. For example, the multi-model superstructure can update the output generation request by automatically triggering an automated workflow indicated by the generated set of actions. The automated workflow can include executing the generated set of actions. For example, the multi-model superstructure can define the generated set of actions as discrete steps within a workflow definition file. The workflow definition specifies each step's action and parameters, such as querying a database, using NLP to generate clarifying questions, and/or updating the request with the new context. Once the workflow definition is created, a workflow engine (e.g., APACHE AIRFLOW, AWS STEP FUNCTIONS) can execute each step in the defined sequence. As each step is completed, the workflow engine can update the state of the workflow and passes the intermediate results to the next step.

In some implementations, the multi-model superstructure can automatically take corrective measures on both the model output and the monitored model that generated the output, based on the compliance indicators in an evaluation report. For example, if the evaluation report indicates non-compliant results, the superstructure can modify the input data of the monitored model(s) to drive desired changes, such as adjusting data distributions or incorporating additional data sources (i.e., knowledge bases). Additionally, the superstructure can initiate a retraining process for the monitored model(s) to guide the selection of new training data that addresses the indicated issues. For example, the superstructure can retrain the monitored model(s) with reduced or different input variables to eliminate those contributing to non-compliance.

For example, using the updated output generation request, the multi-model superstructure can supply the updated output generation request to the one or more models of the first set of models to generate a set of updated model-specific outputs. The second set of models can re-evaluate each particular updated model-specific output of the updated model-specific outputs against the set of assessments to determine satisfaction of the particular updated model-specific output with the corresponding set of assessment metrics of each assessment.

According to some implementations, the system can further cause display of a layout including one or more of: (1) a first representation of the artifact set, (2) a second representation of corresponding indications of satisfaction of the artifact set with the assessment metric set of the assessment set and (2) a second representation of corresponding action sets generated. In particular, for each particular artifact of the set of artifacts, the multi-model superstructure can generate for display on the computing device, a layout indicating the set of assessment results. The layout can include a first representation of the particular artifact (e.g., model output, document, report, data visualization) and a second representation of the corresponding set of actions generated. The second representation can be displayed as a graphical representation, a list and/or a flowchart, showing one or more of the generated actions.

### CONCLUSION

Unless the context clearly requires otherwise, throughout the description and the claims, the words “comprise,” “comprising,” and the like are to be construed in an inclusive sense, as opposed to an exclusive or exhaustive sense—that is to say, in the sense of “including, but not limited to.” As used herein, the terms “connected,” “coupled,” and any variants thereof mean any connection or coupling, either direct or indirect, between two or more elements; the coupling or connection between the elements can be physical, logical, or a combination thereof. Additionally, the words “herein,” “above,” “below,” and words of similar import, when used in this application, refer to this application as a whole and not to any particular portions of this application. Where the context permits, words in the above Detailed Description using the singular or plural number can also include the plural or singular number, respectively. The word “or,” in reference to a list of two or more items, covers all of the following interpretations of the word: any of the items in the list, all of the items in the list, and any combination of the items in the list.

The above Detailed Description of examples of the technology is not intended to be exhaustive or to limit the technology to the precise form disclosed above. While specific examples for the technology are described above for illustrative purposes, various equivalent modifications are possible within the scope of the technology, as those skilled in the relevant art will recognize. For example, while processes or blocks are presented in a given order, alternative implementations can perform routines having operations, or employ systems having blocks, in a different order, and some processes or blocks can be deleted, moved, added, subdivided, combined, and/or modified to provide alternative or sub-combinations. Each of these processes or blocks can be implemented in a variety of different ways. Also, while processes or blocks are at times shown as being performed in series, these processes or blocks can instead be performed or implemented in parallel or can be performed at different times. Further, any specific numbers noted herein are only examples; alternative implementations can employ differing values or ranges.

The teachings of the technology provided herein can be applied to other systems, not necessarily the system described above. The elements and acts of the various examples described above can be combined to provide further implementations of the technology. Some alternative implementations of the technology can include additional elements to those implementations noted above or can include fewer elements.

These and other changes can be made to the technology in light of the above Detailed Description. While the above description describes certain examples of the technology, and describes the best mode contemplated, no matter how detailed the above appears in text, the technology can be practiced in many ways. Details of the system can vary considerably in its specific implementation while still being encompassed by the technology disclosed herein. As noted above, specific terminology used when describing certain features or aspects of the technology should not be taken to imply that the terminology is being redefined herein to be restricted to any specific characteristics, features, or aspects of the technology with which that terminology is associated. In general, the terms used in the following claims should not be construed to limit the technology to the specific examples disclosed in the specification, unless the above Detailed Description section explicitly defines such terms. Accordingly, the actual scope of the technology encompasses not only the disclosed examples but also all equivalent ways of practicing or implementing the technology under the claims.

To reduce the number of claims, certain aspects of the technology are presented below in certain claim forms, but the applicant contemplates the various aspects of the technology in any number of claim forms. For example, while only one aspect of the technology is recited as a computer-readable medium claim, other aspects can likewise be embodied as a computer-readable medium claim, or in other forms, such as being embodied in a means-plus-function claim. Any claims intended to be treated under 35 U.S.C. § 912(f) will begin with the words “means for,” but use of the term “for” in any other context is not intended to invoke treatment under 35 U.S.C. § 912(f). Accordingly, the applicant reserves the right after filing this application to pursue such additional claim forms, either in this application or in a continuing application.

From the foregoing, it will be appreciated that specific implementations of the invention have been described herein for purposes of illustration, but that various modifications can be made without deviating from the scope of the invention. Accordingly, the invention is not limited except as by the appended claims.

We claim:

1. A system for enforcing agent compliance in computing environments using kernel-level eBPF programs, the system comprising:
at least one hardware processor; and
at least one non-transitory memory storing instructions, which, when executed by the at least one hardware processor, cause the system to:
obtain a machine-readable data structure that defines one or more operative boundaries for a target AI agent set;
generate a reference value representing the machine-readable data structure by applying a first transformation operation set on the machine-readable data structure;
load one or more eBPF programs and one or more policy maps into a kernel of a computing environment executing the target AI agent set, wherein the one or more eBPF programs are attached to kernel hook points to intercept operations performed by the target AI agent set;
receive, via a kernel event stream from the one or more eBPF programs, kernel-captured events representing operations performed by the target AI agent set;
generate, via an observer component, a kernel-attested observed value by canonically serializing the kernel-captured events and applying a second transformation operation set on the kernel-captured events;
determine, via a compliance comparator, a verification status by comparing the reference value with the kernel-attested observed value, wherein the verification status is indicative of compliance of the target AI agent set with the one or more operative boundaries; and
responsive to the verification status indicating non-compliance of the target AI agent set with the one or more operative boundaries, load an enforcement program into the kernel of the computing environment to restrict operations of the target AI agent set.

2. The system of claim 1, wherein the first transformation operation set comprises a cryptographic hash function that generates the reference value as a fixed-length, non-invertible digital summary of the machine-readable data structure.

3. The system of claim 1, wherein the kernel hook points comprise one or more of Linux Security Module hooks for file operations, tracepoints for process activities, or XDP and TC hooks for network operations.

4. The system of claim 1, wherein the instructions further cause the system to generate a verification record and transmit the verification record to a ledger storage, wherein the ledger storage comprises a distributed ledger, and wherein the verification record is stored as a transaction on the distributed ledger.

5. The system of claim 1, wherein the instructions further cause the system to, responsive to the verification status indicating non-compliance, trigger a remediation orchestrator to generate an action set comprising one or more of updating the one or more policy maps, blocking operations via LSM hooks, limiting network access via XDP or TC hooks, or quarantining the target AI agent set.

6. The system of claim 5, wherein the instructions further cause the system to:
transmit updated policy information from the remediation orchestrator to a policy distributor; and
load the updated policy information into the one or more policy maps via the policy distributor to enable dynamic enforcement without requiring cooperation from the target AI agent set.

7. One or more non-transitory, computer-readable storage media comprising instructions thereon, wherein the instructions, when executed by at least one data processor of a system, cause the system to:
obtain a machine-readable data structure that defines one or more operative boundaries for a target AI agent set;
generate a reference value representing the machine-readable data structure by applying a first transformation operation set on the machine-readable data structure;
load one or more monitoring programs and one or more policy maps into a monitoring layer of a computing environment executing the target AI agent set, wherein the one or more monitoring programs intercept operations performed by the target AI agent set;
receive, via an event stream from the one or more monitoring programs, a plurality of events representing operations performed by the target AI agent set;
generate an observed value based on the plurality of events;
determine a verification status by comparing the reference value with the observed value, wherein the verification status is indicative of compliance of the target AI agent set with the one or more operative boundaries; and
responsive to the verification status indicating non-compliance, load an enforcement program into one or more processing layers of the computing environment to restrict operations of the target AI agent set.

8. The one or more non-transitory, computer-readable storage media of claim 7, wherein the first transformation operation set comprises a cryptographic hash function that generates the reference value as a fixed-length, non-invertible digital summary of the machine-readable data structure.

9. The one or more non-transitory, computer-readable storage media of claim 7, wherein the one or more monitoring programs are attached to kernel hook points to intercept the operations performed by the target AI agent set, and wherein the kernel hook points comprise one or more of Linux Security Module hooks for file operations, tracepoints for process activities, or XDP and TC hooks for network operations.

10. The one or more non-transitory, computer-readable storage media of claim 7, wherein the instructions further cause the system to generate a verification record and transmit the verification record to a ledger storage, wherein the ledger storage comprises a distributed ledger, and wherein the verification record is stored as a transaction on the distributed ledger.

11. The one or more non-transitory, computer-readable storage media of claim 7, wherein the instructions further cause the system to, responsive to the verification status indicating non-compliance, trigger a remediation orchestrator to generate an action set comprising one or more of updating the one or more policy maps, blocking operations via LSM hooks, limiting network access via XDP or TC hooks, or quarantining the target AI agent set.

12. The one or more non-transitory, computer-readable storage media of claim 11, wherein the instructions further cause the system to:
transmit updated policy information from the remediation orchestrator to a policy distributor; and
load the updated policy information into the one or more policy maps via the policy distributor to enable dynamic enforcement without requiring cooperation from the target AI agent set.

13. The one or more non-transitory, computer-readable storage media of claim 7, wherein generating the observed value comprises canonically serializing the plurality of events and applying a second transformation operation set on the plurality of events via an observer component.

14. A computer-implemented method comprising:
obtaining a machine-readable data structure that defines one or more operative boundaries for a target AI agent set;
generating a reference value representing the machine-readable data structure by applying a first transformation operation set on the machine-readable data structure;
loading one or more monitoring programs and one or more policy maps into a monitoring layer of a computing environment executing the target AI agent set, wherein the one or more monitoring programs intercept operations performed by the target AI agent set;
receiving, via an event stream from the one or more monitoring programs, a plurality of events representing operations performed by the target AI agent set;
generating an observed value based on the plurality of events;
determining a verification status by comparing the reference value with the observed value, wherein the verification status is indicative of compliance of the target AI agent set with the one or more operative boundaries; and
generating a verification record indicating the verification status.

15. The computer-implemented method of claim 14, wherein the first transformation operation set comprises a cryptographic hash function that generates the reference value as a fixed-length, non-invertible digital summary of the machine-readable data structure.

16. The computer-implemented method of claim 14, wherein the one or more monitoring programs are attached to kernel hook points to intercept operations performed by the target AI agent set, and wherein the kernel hook points comprise one or more of Linux Security Module hooks for file operations, tracepoints for process activities, or XDP and TC hooks for network operations.

17. The computer-implemented method of claim 14, further comprising, responsive to the verification status indicating non-compliance, loading an enforcement program into one or more processing layers of the computing environment to restrict operations of the target AI agent set.

18. The computer-implemented method of claim 14, further comprising, responsive to the verification status indicating non-compliance, triggering a remediation orchestrator to generate an action set comprising one or more of updating the one or more policy maps, blocking operations via LSM hooks, limiting network access via XDP or TC hooks, or quarantining the target AI agent set.

19. The computer-implemented method of claim 18, further comprising:
transmitting updated policy information from the remediation orchestrator to a policy distributor; and
loading the updated policy information into the one or more policy maps via the policy distributor to enable dynamic enforcement without requiring cooperation from the target AI agent set.

20. The computer-implemented method of claim 14, wherein generating the observed value comprises canonically serializing the plurality of events and applying a second transformation operation set on the plurality of events via an observer component.
